(19) United States
(12) Patent Application Publication
(10) Pub. No.: US 2007/0286324 A1
(43) Pub. Date: Dec. 13, 2007

(54) Direct generation of electrical and electromagnetic energy from materials containing deuterium

(75) Inventor: Peter L. Hagelstein, Carlisle, CA (US)

Correspondence Address: JONES DAY, 222 EAST 41ST ST, NEW YORK, NY, 10017, US

(73) Assignee: Spindletop Corporation, Portola Valley, CA (US)

(21) Appl. No.: 11/783,691

(22) Filed: Apr. 11, 2007

Related U.S. Application Data
(63) Continuation of application No. 11/137,541, filed on May 26, 2005, now abandoned.
Application No. 11/137,541 is a continuation-in-part of application No. 10/440,426, filed on May 19, 2003.
Application No. 10/440,426 is a continuation of application No. 10/441,891, filed on May 17, 2003, now abandoned.
(60) Provisional application No. 60/449,247, filed on Feb. 14, 2003.
(60) Provisional application No. 60/381,863, filed on May 18, 2002.

(51) Int. Cl. G21D 7/00

(52) U.S. Cl. 376/321

(57) ABSTRACT

A method and apparatus employ stimulating a material to cause reactions in the material, wherein the material comprises deuterium, and wherein the reactions generate vibrational motion of the material, coupling the vibrational motion to a transducer that generates energy from the vibrational motion of the material, and directing the energy to an electrical device.

This application is a continuation of U.S. patent application Ser. No. 11/137,541 filed May 26, 2005, which is a continuation-in-part of U.S. patent application Ser. No. 10/440,426 filed May 19, 2003, which is a continuation of U.S. patent application Ser. No. 10/441,891 filed May 17, 2003, which claims priority to Provisional Application No. 60/449,247 filed on Feb. 14, 2003 and Provisional Application No. 60/381,863 filed on May 18, 2002. This application is also related to International Application No. PCT/US2003/015713 filed May 17, 2003. All of the above-mentioned applications are incorporated herein by reference.

### BACKGROUND

1. Field of the Invention

This invention relates to energy conversion using host materials comprising molecular deuterium (D₂) and/or hydrogen-deuterium (HD) through newly discovered reactions that couple energy directly to high frequency vibrational modes of a solid.

2. Background Information

U.S. patent application Ser. No. 10/440,426 filed May 19, 2003 describes a framework for understanding nuclear reactions occurring in various host materials as well as embodiments for converting energy generated by such nuclear reactions into useful energy. The present application describes further embodiments for the conversion of energy from nuclear reactions in materials comprising molecular deuterium (D₂) and/or hydrogen-deuterium (HD) into useful energy.

### SUMMARY OF THE INVENTION

A method comprises stimulating a material to cause reactions in the material, wherein the material comprises deuterium, and wherein the reactions generate vibrational motion of the material, coupling the vibrational motion to a transducer that generates energy from the vibrational motion of the material; and directing the energy to an electrical device.

An apparatus comprises a material comprising deuterium, an excitation source comprising a device selected from the group consisting of an electromagnetic-radiation source, an input transducer that generates vibrational motion in response to electrical energy, an electrical power source, a particle source, and a heater, wherein the excitation source is arranged to stimulate the material to generate reactions in the material, and wherein the reactions generate vibrational motion of the material; and an output transducer coupled to the material that generates energy from the vibrational motion of the material.

### BRIEF DESCRIPTION OF THE DRAWINGS

FIG. 1 illustrates a molecular transformation in accordance with the present invention.

FIG. 2 illustrates a molecular transformation in accordance with the present invention.

FIG. 3 is a chart of a 1-D analog model in accordance with the present invention.

FIG. 4 is a chart that is illustrative of the coupling strength of a molecular transformation in accordance with the embodiment of the present invention.

FIG. 5 illustrates a molecular transformation related to weak coupling in accordance with the present invention.

FIG. 6 is a chart that illustrates fractional occupation of the different angular momentum states in deuterium as a function of temperature.

FIG. 7 is a chart that illustrates the results of a model in accordance with the present invention.

FIG. 8 is a chart that shows an estimate of energy in the compact state.

FIG. 9 is a chart of Gamow factor associated with a channel as a function of angular momentum of the two-deuteron compact state.

FIG. 10 is a chart that is illustrative of the weak coupling in accordance with the present invention.

FIG. 11 is a chart that is illustrative of moderate coupling in accordance with the present invention.

FIG. 12 is a chart that is illustrative of strong coupling in accordance with the present invention.

FIG. 13 is a chart that illustrates a splitting of energy at a resonant state in accordance with the present invention.

FIG. 14-16 illustrates a reaction process in accordance with the present invention.

FIG. 17a-17e illustrates a reaction process in accordance with the present invention.

FIG. 17g-17h illustrate helium-seeding in accordance with the present invention.

FIG. 17i illustrates deuterium and/or hydrogen loading in accordance with the present invention.

FIG. 17j illustrates sealing of the host lattice in accordance with the present invention.

FIG. 18 illustrates the excess power produce from a reaction process.

FIG. 19a-19e illustrates another reaction process in accordance with an embodiment of the present invention.

FIG. 20 is an electrochemical cell in accordance with the present invention.

FIG. 21 is a dry cell in accordance with the present invention.

FIG. 22 is a flash heating tube in accordance with the present invention.

FIG. 23 is a thermoelectric battery accordance with the present invention.

FIG. 24 is a block diagram illustrating an exemplary embodiment.

FIG. 25 is a block diagram illustrating an exemplary embodiment.

FIG. 26A is a block diagram illustrating an exemplary embodiment.

FIG. 26B is a block diagram illustrating an exemplary embodiment.

The accompanying figures further illustrate exemplary implementations according to the present invention.

### DETAILED DESCRIPTION

### I. Development of Present Invention

In the patent application that we present here, we take advantage of several important advances, and also take advantage of a recent breakthrough in our understanding of the basic physics associated with the new phenomena. We now understand why the accepted vacuum picture does not work for a new class of reactions, and we have developed a generalization of nuclear physics that includes the new and old effects on equal footing. If one takes as a foundation that nuclear reactions that occur in a solid should take into account the solid as a fundamental part of the system under consideration, then one is led instead to conclude that phenomena of the type under discussion can and should occur in nature. Moreover, it now becomes clear what the new effects are, how and why the new effects take place, and in the end—what are the important variables that have to this time remained uncontrolled variables, that can now be reasonably controlled by one skilled in the art without undue experimentation.

The question of excess heat and additional questions associated with other anomalies in metal deuterides have been pursued in the interim by a relatively small community of independent-minded scientists, many of whom prior to this affair had unblemished scientific credentials. A series of international conferences on the topic have been held [the most recent ICCF9 at Tsinghua University in Beijing—sometimes known as the MIT of China—in May, 2002]. According to some estimates, on the order of 3000 papers have been written on the topic in all, most of which have not been published in mainstream scientific journals. A large number of experiments have been reported in this period. Many of these experiments have produced positive results, and an equal or greater number have given negative results. Many researchers in laboratories all over the world have seen the excess heat effect. Fusion reactions at low levels have also been claimed, a great many times. Other effects have been reported as well, including: fast particle emission not consistent with fusion reactions, gamma emission, slow tritium production, helium generation in quantitative correlation with excess energy, and the development of large quantities radioactive isotopes within the host metal lattice [K. Wolf, unpublished. Passell, T. O., Radiation data reported by Wolf at Texas A&M as transmitted by T. Passell, 1995, EPRI. (unpublished, but available on the LENR-CANR website)].

Consequently, it might be argued that there exists a substantial database from which to draw upon when considering anomalies in metal deuterides. On the other hand, some of the results that have been claimed over the years have proven either to be not reproducible or in some cases demonstrably incorrect. In science, a determined effort is made within the scientific community to make sure that what is published, and hence accepted, is correct and can be built upon. In the general area of anomalies in metal deuterides, this has proven in general to be very difficult over the years as so many claims that initially looked promising could not be confirmed. This has ultimately produced a situation in which: the mainstream journals in general are not interested in papers in this area; there exists a consensus generally among members of the community studying the problem that there are real effects, but there is much less agreement in general as to which experiments and which effects are right; there is almost no agreement within the community studying the problem as to what might be responsible for any of the anomalous effects. Individual researchers studying the problem rely in general on what they know to be true from their own work, and trust the results of other researchers only to the degree to which they have become convinced by presentations, papers, or discussions. The community does not agree among itself, it has operated in part outside of mainstream science, and individuals within the community each have their own views about what results are right and what is going on.

The ideas described in this patent application follow from a collaborative effort on the part of a number of scientists who have pursued a research program rather different from that contemplated by others in the field. The focus of this effort has been on the basic problem as to what physical mechanisms are involved. The logic being that if one understands what basic physics is involved, then one has the chance of developing experiments and devices by design, rather than by Edisonian trial and error as has been the case for most of the research in the area.

It was recognized early on that the experimental claims presented initially—excess heat and low-level fusion—are not overly useful for clarifying the physical mechanisms involved. The existence of a low-level fusion effect is indicative that somehow deuterons must be getting together, but is silent as to how such a thing might happen. The existence of an excess energy effect is indicative that some new kind of reaction process is operative, but does not provide much in the way of guidance as to what reaction mechanism or physical mechanisms are involved.

Consequently, where some groups focused on trying to perfect the initial electrochemical experiment of Pons and Fleischmann, we focused instead on trying to identify and understand the associated physical mechanisms. Any proposed physical mechanism has corresponding experimental signatures and systematics. We considered more than 100 possible reaction schemes over the course of our research [P. L. Hagelstein, DARPA Report, April 2003]. Schemes were considered, and rejected for either theoretical reasons or experimental reasons, in some case both. A great many experiments have been considered (and many experiments performed) where we have sought guidance on the general problem of mechanism. We have questioned our colleagues about their experiments, and attempted replication of many of these. We have proposed experiments to others, in order to try to prove or disprove one conjecture or another. After 14 years of this kind of process, we have made much progress on the general problem of mechanism, ultimately leading to the inventions discussed here.

We were aided in this effort by some results that have retrospectively appeared to be very helpful. One such result was the observation of low level fast alpha particles in the 18-21 MeV range from PdD loaded by 500-1000 eV deuterons from an ECR (electron cyclotron resonance) source as reported by a group at NRL [G. P. Chambers, J. E. Eridon, K. S. Grabowski, B. D. Sartwell and D. B. Chrisey, “Charged Particle Spectra of Palladium Thin Films During Low Energy Deuterium Ion Implantation,” J. Fusion Energy, Vol. 9, p. 281 (1990)]. This result cannot be understood in terms of vacuum reaction physics as outlined above. This result suggests to us the possibility of a new kind of site-other-site reaction process, in which the energy from two deuterons at one site is used to eject alpha particles from Pd nuclei at another site. The alpha energies expected from this kind of mechanism are in good agreement with the experimental data. We asked other groups to seek confirmation of this result, due to its special importance in illuminating physical mechanisms. By now, there have been at least two other experiments reported which show this effect—one from the Lebedev Institute in Moscow, and one from the group of G. Miley at UIUC [A. G. Lipson, A. S. Roussetski, C. H. Castano, Kim S-O., G. H. Miley, “In-situ Long-range Alpha Particles and X-ray Detection for Thin-film Pd Cathodes During Electrolysis in Li_{—}2SO_{—}4/H_{—}2O,” presented at the March 2002 APS meeting—paper W21.005].

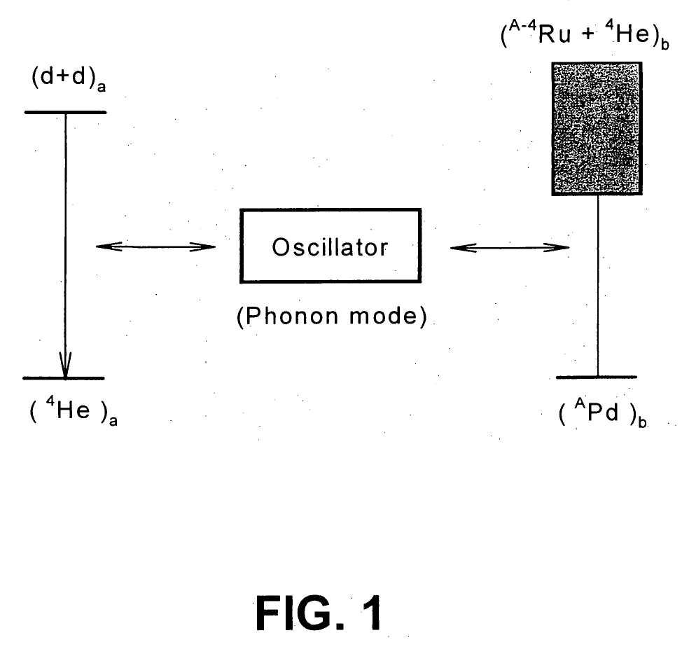

FIG. 1 is a diagram of off-resonant coupling between a two-level system and a transition into a continuum. Compact dd-states with energies near the molecular limit at one site would be capable of an off-resonant coupling to host Pd nuclei at another site that would lead to alpha ejection in the range from 18-21 MeV, as observed by Chambers.

When we finally understood the significance of this result, we began to develop theoretical models that described site-other-site reactions. The basic idea is that reactions that occur in the solid have the possibility of exchanging phonons with the lattice. Reactions at different sites that exchange phonons with a common phonon mode can proceed as a second-order quantum process. The reaction mechanism under discussion might be written as:
(d+d)ₐ+(^{A}Pd)_{b}→(⁴He)ₐ+(^{A-4}Ru+α)_{b}

While the theoretical model for this reaction could account for the alpha particle as a primary ejecta, and gave ejection energies in agreement with experiment, the associated reaction rate computed was orders of magnitude off from experiment. We appeared to have part of a piece of the puzzle, but we did not have the whole piece.

If such a site-other-site reaction can occur at all, then it might sensibly be asked what other reactions of this type might be expected. From theoretical considerations, it became clear that resonant reactions in which a reaction at one site is paired with the inverse reaction at another site should be the predominant process of this kind. This led us to consider reactions of the form
(d+d)ₐ+(⁴He)_{b}←→(⁴He)ₐ+(d+d)_{b}

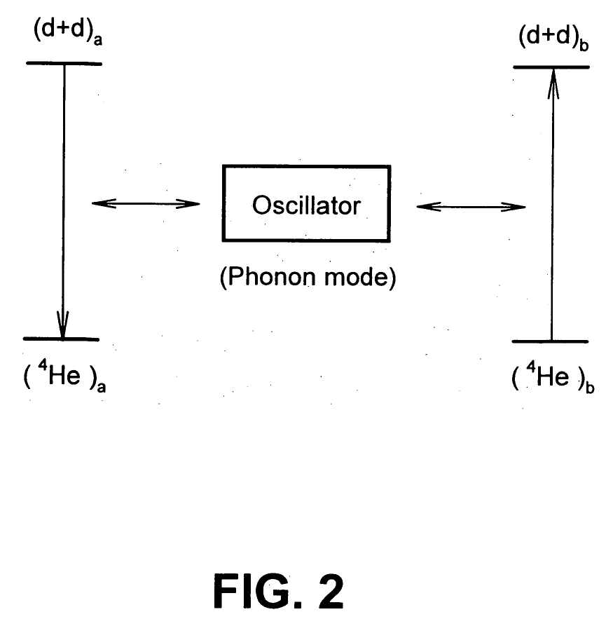

In such a reaction, two deuterons at one site come together to make helium, exchange phonons to match the microscopic selection rule. At another site, a helium nucleus dissociates through phonon exchange, making two deuterons. The reaction overall is conservative, no energy is generated to within an excellent approximation. This is illustrated schematically in FIG. 2. In FIG. 2, a pair of two-level quantum systems coupled through an off-resonant oscillator. Phonon exchange with a common highly excited phonon mode is proposed to allow coupling between nuclear reactions at different sites. An excitation transfer of this type between equivalent systems is termed a “null” reaction.

We pondered this kind of reaction for quite a while, at first considering it as a somewhat whimsical kind of reaction—as it should be dominant in terms of reaction rate, but it did not seem to be observable as it only seemed to produce an effective exchange of constituents at different sites. For this reason we have termed it a “null” reaction. In time, we recognized that two deuterons created from the dissociation of a helium nucleus would have difficulty tunneling apart, due to the presence of the same Coulomb barrier that kept them from tunneling together in the first place. And if they indeed had trouble tunneling apart, perhaps they could be observed by virtue of being together.

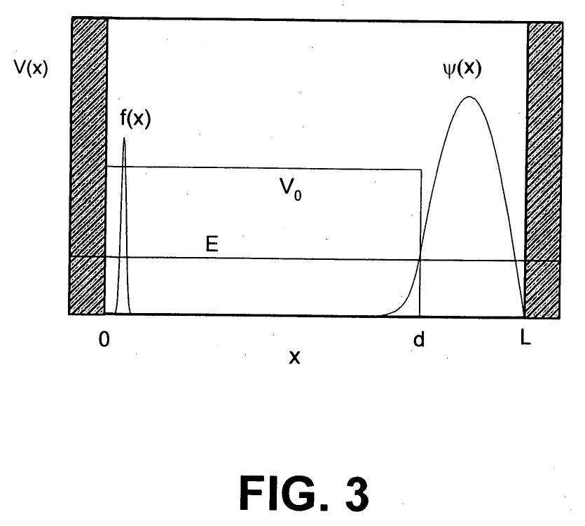

Such an effect can be seen with the aid of a simple one-dimensional analog model. One often develop seeks simplified versions of a complicated many-body model from which the relevant new physics can be seen and studied in isolation from the difficulties associated with the full theory, so that one can understand things simply. In this case, a convenient analog is constructed by replacing the local molecular state with a one-dimensional potential well. The source term due to ⁴He dissociation appears as an exchange potential. The relevant one-dimensional analog model can be written as

$$E ψ ( x ) = [ - \frac{{h}^{2}}{2 μ} \frac{{ⅆ}^{2}}{ⅆ {x}^{2}} + V ( x ) ] ψ ( x ) - Kf ( x ) \int f ( y ) ψ ( y ) ⅆ y$$

where V(x) is the one-dimensional equivalent molecular potential shown below. We have taken ƒ(x) to be a delta function located near the origin. The strength of the null reactions is modeled in the constant K. FIG. 3 illustrative of a1-D analog model. The molecular potential is modeled by a square well with zero potential between d and L, and a constant potential below d. The unperturbed ground state (analog for the molecular ground state) is illustrated as ψ(x). Dissociation of helium leads to two deuterons with a tiny separation. This is accounted for in the function ƒ(x). This analog model problem is easily solved. When the coupling constant K is small, the solutions consist of states that are very close to the bound states of the well that contain a small amount of admixture from a localized state near the origin. The associated intuition is that the deuterons spend part of their time in the molecular state, and part of the time localized. We associate the localized component as being due to contributions from deuterons at close range which are produced from helium dissociation, which tunnel apart.

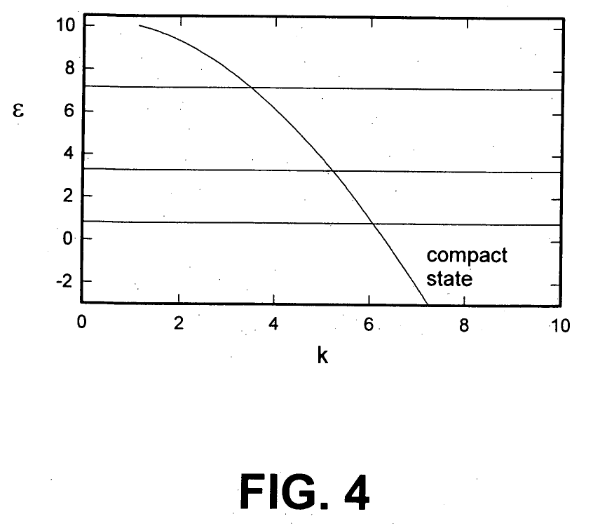

When the coupling constant K is large, then a new compact state forms (see FIG. 4), with an energy that depends on the coupling strength. The corresponding interpretation is that the deuterons that are created at close range try to tunnel apart, but ultimately come back together to make helium (sending the excitation elsewhere) before they can tunnel apart. FIG. 4 illustrates normalized eigenvalues ε as a function of the normalized coupling strength k for the square well analog. When the coupling strength increases to a sufficiently large value, a new state appears, with an energy that depends of the strength of the coupling.

At this point, the significance of an experiment reported by J. Kasagi began to become clear. Kasagi investigated reactions under conditions where an energetic deuteron beam with deuteron energy on the order of 100 keV was incident on a TiD target. The predominant signal was the p+t and n+³He products that would normally be expected from vacuum nuclear physics. In addition, Kasagi saw more energetic reaction products from deuterons hitting ³He nuclei that accumulated in the target—in this case energetic protons and alpha particles. Also in the spectrum were energetic alphas and protons from reactions in which a ³He from a d+d reaction hit another deuteron. All of these reactions are expected. What was not expected were additional signals in the proton and alpha spectrum that had a very broad energy spread. For example, if an incident deuteron hits a ³He nucleus, one expects the energetic protons and alphas to have a spread in energy associated with the momentum of the incident deuteron. This spread is small if the angular spread of the detector is also small. For protons and alphas produced by more energetic ³He nuclei generated in a d+d collision (in which case the ³He is born with about 0.8 MeV of energy), one expects a spread of on the order of 4 MeV above and below the centroid energy in the proton spectrum. Kasagi's measurements showed such a spread for these reactions. But a proton signal with a spread that is much greater is much more difficult to explain. A similar anomalous signal was seen in the alpha channel, where the spread in energy was much wider than could be accounted for by secondary reactions [J. Kasagi, T. Ohtsuki, K. Ishu and M Hiraga, Phys. Soc. Japan Vol. 64, p. 777 (1995)]. To account for his results, Kasagi conjectured that he was somehow seeing the reaction
d+d+d→p+n+α

Such a three-body reaction gives proton and alpha signals with a very large spread in energy, and with end-point energies consistent with those observed by Kasagi. The spectrum predicted from phase space considerations of such a reaction was consistent with his observations. The only problem is how could it be possible that three deuterons could react with one another? No evidence for this kind of reaction (one with three nuclei reacting in the input channel) had been seen in laboratory experiments before.

We interpreted this experiment initially in terms of the site-other-site reaction described above, in which the deuterons produced by the dissociation of helium have trouble tunneling apart. Hence we viewed the Kasagi experiment as providing support for the emerging theoretical picture under discussion.

Much later, it became clear that the dissociation of helium under the conditions under discussion could also produce localized p+t and n+³He states with an energy matched to the molecular deuterium energy—in fact such states are far more likely in this regard than the two deuteron state initially conjectured. However, this does not change the picture fundamentally. The Kasagi experiment is still interpreted as providing support for the notion that helium can be dissociated as part of a second-order or higher-order site-other-site reaction process, and that the dissociated products can have an energy nearly resonant with that of molecular deuterium. Kasagi has replicated this experiment successfully in a different experimental set-up. It has also been replicated by at least three other groups, one of which was at NRL [G. Hubler, private communication, 2002].

We have taken these ideas much further in our theory effort, as documented in recent conference proceedings and reports. We made progress on the initial formulation of the model by generalizing the Resonating Group Method [J. A. Wheeler, Phys. Rev. 52 1107 (1937)], which was used for the vacuum version of the d+d fusion reaction from the 1930s through the 1980s [J. R. Pruett, F. M Beiduk and E. J. Konopinski, Phys. Rev., Vol. 77, p. 628 (1950). H. J. Boersma, Nuclear Physics,. A135, p. 609 (1969)], to include the other nuclei in the lattice at the outset. This generalization is nice in that it includes the vacuum nuclear physics problem as a subset of a larger theory without modification. A similar generalization follows directly for the more powerful R-Matrix method [A. M. Lane and D. Robson, Phys. Rev., Vol. 151, p. 774 (1966). D. Robson and A. M. Lane, Phys. Rev., Vol. 161, p. 982 (1967). A. M. Lane and D. Robson, Phys. Rev., Vol. 185, p. 1403 (1969). R. J. Philpott and J. George, Nucl. Phys., Vol. A233, p. 164 (1974)], although we have not pursued this or other possible generalizations so far in our work.

We have begun to analyze a number of rather fundamental problems associated with the theory. For example, the simplest site-other-site problem is the two-deuteron and helium exchange reaction mentioned above. Our initial analysis indicated that this problem did not produce stable two-deuteron localized states, but that the exchange energy associated with the interaction could be attractive. The conclusion was that two-deuteron localized states could be stabilized under conditions where a larger number of sites and exchange reactions occurred within a common highly excited phonon mode.

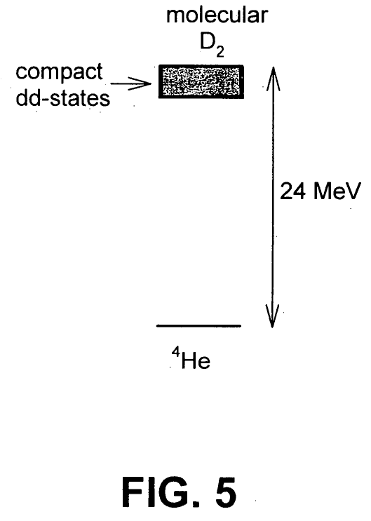

Subsequently, we understood that the two-site problem could give stable localized states in the case of the p+t and n+³He channels, with energies that could be nearly resonant with the molecular deuterium state [P. L. Hagelstein, DARPA Report, 2003]. This problem is currently being analyzed, and it has major implications for our basic understanding of the overall process. FIG. 5 illustrates a “weak” coupling version of the compact state energy distribution. In this case, compact state formation occurs at energies slightly below the molecular D₂ state energy. In the event that coupling occurs to states with less than 20 units of angular momentum, then conventional dd-fusion reactions would be expected as an allowed decay route for these low angular momentum compact states. An accumulation of compact states with energies near the molecular state could also lead to energy transfer to the host lattice nuclei, giving rise to fast ion emission of the type observed by Chambers and by Cecil. We set up a simplified many-site model in order to begin investigating energy exchange between these states and a highly excited phonon mode [P. L. Hagelstein, ICCF9 Conference Proceedings—not yet published; also, the 2002 RLE Report, not yet published.]. The original basic idea is that the exchange reaction discussed above is nearly resonant, except for the exchange of a few phonons that may be different at either site. Hence a single exchange reaction can change the number of phonons present in the lattice. A very large number of such reactions have the potential to produce significant mixing of the nuclear and phononic degrees of freedom. Calculations that we have done indicate that if a relatively small number of localized states and helium nuclei interact with a common highly excited phonon mode, that nearly free energy exchange between the nuclei and the phonon mode becomes possible. We have studied toy models in which the ratio of nuclear energy to phonon energy was allowed to be a parameter that could be varied at will. The coupling of energy in cases where 100, 500, 1000, 2500 phonons respectively were required to match a nuclear energy quantum produced mixed state distributions that were pretty much invariant, suggesting that the coupled nuclear and phonon system is rather efficient at converting nuclear energy to phonon energy.

The model that has resulted from our studies appears to be based on good physics—certainly physics that is more relevant to the problem than the vacuum description presently in use within the nuclear physics community. The many-site version of the model yields a rather rich description of different phenomenon. In the absence of significant phononic excitation, there are no anomalous effects, consistent with a very large number of negative experiments. At weak phononic excitation, such that few phonons are exchanged and little angular momentum is present in the localized states, the model predicts a low-level fusion effect as claimed by Jones.

When higher angular momentum localized states are produced at higher phonon excitation, the model predicts states of the sort seen in the Kasagi experiment, and decay modes with fast alpha ejection, as well as other effects consistent with what has been reported. When enough compact states and helium nuclei interact with a single phonon mode, the model appears to lead to and excess heat effect and associated helium production, again consistent with the relevant experimental observations. This close connection between the model and the different anomalies has been discussed in conference proceedings and reports that we have written.

Ongoing efforts continue to lead to improvements in the models, and we envision that these will lead to useful quantitative design models in the coming year.

We discussed above three fundamental issues raised in 1989 that needed to be resolved in the event that the low level fusion effect and the excess heat effect proved to be real. In light of the theory that we have developed, and also from relevant experimental studies, clear answers are now available.
1. As will be discussed below, an enhancement of the tunneling probability would be induced if there were an accessible compact state in resonance with the molecular state due to coherence effects. While this idealized picture is indicative that there are alternatives to tunneling and Golden Rule reaction physics, in the case of a single site it is not reasonable to expect such a resonance. The current version of the many-site model describes a picture in which molecular states at a large number of sites couple to helium states and compact states, both at a large number of sites. The dynamics of the resulting coupled quantum system are described by interaction matrix elements based on tunneling through the Coulomb barrier, local strong force interactions with phonon exchange, and coherent enhancement factors of the Dicke type. The reaction rate from this kind of model is limited by the relative weakness of the coupling through the Coulomb barrier, and permits the interpretation of an enhanced coherent tunneling mechanism. The associated enhancement in the tunneling probability can be very large—we find enhancements of more than 50 orders of magnitude increase over estimates from tunneling using the Golden Rule.

Evidence for the existence of such an enhancement comes from a very large body of experiments in which anomalies in metal deuterides are seen. Direct evidence in support of the existence of a compact states comes from the Kasagi experiment. The existence of the localized states and very large enhancements of tunneling is supported by the new models that include phonon exchange in nuclear reactions as discussed at length below.
2. New reaction pathways have been identified that involve generalized site-other-site reactions where all individual single-site processes involve phonon exchange with a common highly excited phonon mode. Direct evidence for the existence of such processes come from the experiments showing fast alpha emission. The rate for all such reaction processes can be faster than the conventional d+d vacuum fusion reactions (the p+t and n+³He branches) when high angular momentum is involved. From theory, roughly 20 units of angular momentum are required to essentially completely suppress these channels. Support for this comes from the Kasagi experiment, in which the d+d+d reaction yields three-body final state products (n+p+α) and not two-body final state products (t+³He and d+⁴He)—two-body reaction products would be suppressed if the localized state has large angular momentum by the associated centripetal barrier, whereas radial and angular momentum can be exchanged in the case of a three-body final state. Support for this also comes from the relatively large fraction of deuterons that reside in localized states in the Kasagi experiment (about 10⁻⁵), which could only be the case if the decay of these states by the conventional d+d reaction pathways was essentially completely suppressed. Support for this also comes from theoretical models that we have studied in which phonon exchange is included in nuclear interaction matrix elements.
3. Mixing between the nuclear and phononic degrees of freedom in the many-site models that we have studied indicate that the new reactions can be rather efficient at exchanging nuclear energy for lattice energy. Support for this view comes from direct calculation of models that describe the associated physics. Support for this view comes from experiment in the observations of D. Gozzi and colleagues (Italy) and also by McKubre and coworkers at SRI of energy production correlated with ⁴He generation in experiments showing no significant x-ray emission, gamma emission, radioactivity, and neutron or charged particle emission. Support for this also comes from experiments of K. Wolf in which neutron detectors observed cells that produced significant tritium, and found no neutrons in association with the tritium that was generated. As the tritium generation took place in a metal deuteride, the tritons created would have reacted with deuterons in the metal lattice through d+t reactions at easily detectable quantities had they be created with an energy larger than 8 keV.

The basic picture that emerges from this work then is that many of the anomalous effects claimed in experiments with metal deuterides are real, and that these are a direct consequence of allowing for phonon exchange in the basic formulation of the nuclear models. The difficulties encountered by experimentalists within the field are seen to be associated with uncontrolled important variables in the experiments, as most do not have a clear idea of what conditions they are seeking to create in any given experiment. The rejection of the anomalies by the scientific community is seen as a consequence of the relative success of vacuum nuclear physics over the past 80 years in accounting for a wide variety of nuclear experiments, and the expected reluctance of the scientific community to “give up” such a successful viewpoint in favor of a new and unfamiliar picture.

While the development of a significant quantitative design capability remains an ongoing project of interest in our work, the question of what might constitute an eventual practical device is clearly an important one. We are in a position now to begin to address it.
A. According to the model, energy can be produced as a result of a very large number of site-other-site exchange reactions involving deuterons within the lattice, localized states, and helium. Hence, without going much further, we can state as a requirement that we need deuterium in the metal deuteride to support the d+d branch of the reaction. In the case of the p+d branch of the reaction, we require a mixed hydride and deuteride in the host lattice (which can be a metal or other hydrogen loaded material).
B. A computation of the relative tunneling rates for deuterons at different sites in the metal deuterides leads ultimately to the conclusion that the deuterons are likely not to participate in reactions at all unless they are in molecular states. A retrospective examination of the conditions under which previous successful experiments involving metal deuterides have been carried out indicates that in all cases that they are consistent with a maximizing of the molecular state contribution. For example, the very high loading requirement in the excess heat electrolysis experiments at SRI is interpreted as being consistent with maximizing the molecular deuterium contribution within the metal deuteride by filling all available octahedral sites, such that additional deuterons have an increased probability of double occupancy.
C. Molecular deuterium formation is enhanced by the presence of vacancies. We have noted that many successful experiments have been carried out in metal deuterides that are highly defective, such that the vacancy concentration is maximized. We note that single host lattice metal vacancies are stabilized in highly loaded metal deuterides in the case of PdD and NiD, such that they are thermodynamically preferred. Hence vacancies propagate into the bulk from surfaces and from internal large defects in metal deuterides that are kept loaded for extended periods. The time constant associated with this is on the same order as the time constant that appeared to be required before the onset of the excess heat effect in the early SRI experiments.
D. The model indicates that significant excitation of a phonon mode is required in order for any of the effects described above can occur. While this is an absolute requirement on the part on theory, theory is less clear on which phonon modes need to be excited—which motivates a brief discussion. A metal deuteride such as PdD has acoustical modes from near zero frequency up to a few THz, and optical phonon modes at higher frequencies (from 8-16 THz in PdD). Theory indicates that need to be able to exchange on the order of 20 phonons or more in order to develop the requisite angular momentum to stabilize localized two nucleus states in the case of the d+d reactions (and on the order of 10 phonons for the p+d reaction branch). This underlying requirement is expressed technically in terms of the relative magnitude of an interaction matrix element, but this can be described reasonably well in words. A phonon mode in our view extends over a volume determined by the phonon coherence length associated with the mode frequency or local geometry (which can be as small as 10⁻¹⁵ cm³ for an optical phonon mode, or as large as 1 cm³ for a low acoustical mode) and can be excited to have some number, say N, phonons total. The requirement is that there must be at least on the order of 10 cycles of oscillation in the wavefunction over the size scale of a compact state (on the order of 10 fm), under conditions where there are roughly N cycles of oscillation over the full relative distance of local oscillation of local motion of the reacting nuclei. Hence, in the case of highly excited optical phonon modes, the volume may have 10⁹ atoms, there may be about one phonon per 10 atoms, and the associated relative motion will be on the order of 0.1 Angstroms, leading to on the order of 10⁴ cycles in 1 fm. In the case of acoustical phonons, most of the vibrational energy is in the host metal atoms, so the relative local motion of deuterium or helium is less. In this case, the difficulty is to arrange for the total relative displacement (which can be within 1-2 orders of magnitude of the total displacement) associated with the highly excited acoustical mode to be greater than a few fermis. From experiment we have only a partial picture of the situation. No experiment so far has yielded direct information on what phonon modes are excited or how much, to compare with requirements arising from theory. Indirect evidence is available in a few cases. We proposed years ago that optical phonons (and also very high frequency THz acoustical phonons) would be created by fluxing deuterium through a discontinuity in the deuterium chemical potential, and that the presence of this phononic excitation might be correlated to the appearance of anomalies. Support for this in experiment came initially from excess heat experiments that showed oscillations in the loading, and it was found that the rate of excess power generation was proportional to the magnitude of the deuterium flux through the cathode surface on average. Early experiments by Claytor using bilayers also seemed to be effective. Preparata and Fleischmann pioneered experiments in which an axial deuterium flux was driven in cathodes loaded electrochemically, and these appeared to produce excess heat and other anomalies correlated to the deuterium flux. More recently, experiments reported by Li [X A. Li, presented at ICCF9, Beijing, May 2002, not yet published], by Iwamura [Y. Iwamura, M. Sakano, T. Itoh, Jpn. J Appl. Phys., 41, page 4642 (2002)], and by Miley, appear to give anomalies when deuterium is fluxed through chemical potential discontinuities created by implementing bilayers or multilayers in the metal deuteride. In recent experiments by Letts [D. Letts, “Laser Initiated Heat Release from Electrolytic Systems,” March APS Meeting paper Z33.005] and by Cravens [private communication], a cathode is illuminated by a weak laser in the red, which appears to increase dramatically the excess power. We have conjectured that this is due to excitation of an electron plasmon mode off resonance, which is strongly coupled to the optical phonon mode. The excitation of such a hybrid mode would satisfy the requirements of the model. Reports for fracto-fusion effects in deuterated materials (we are considering in this case the early experiments of Scaramuzzi and of Menlove) indicate that lower energy acoustical modes can also be effective in stimulating the effects under discussion. The power densities associated with phonon generation in electrochemical experiments is thought to be on the general order of Watts/cm².
E. Theory requires that compact states be present in order for the coupling of energy between the nuclear and phononic degrees of freedom. Our initial proposal was that the localized state was made up of a compact state made of two deuterons with a few fermi separation. Recently, we recognized that such states could also be made up of t+p and n+³He pairs, and that these states would have advantages due to the lower energy of the nuclear states. Our initial proposals also relied on these compact states to be nearly resonant with the molecular D₂ state in order to have the strongest coupling with the molecular state. More recently, we recognize that this need not be the case. The latest models suggest that the compact states simply aid in enhancing the tunneling, and that we wish to have there be as many as possible (but fewer than the number of D₂ within the same volume). This translates into a requirement on the ⁴He concentration in the metal in sites that are roughly equivalent to sites where molecular D₂ forms. This requirement is nontrivial, as helium tends to reside in deeper traps associated with larger vacancies that what we contemplate. Support for this view comes from early excess heat experiments at SRI in which Pd cathodes were implanted with ⁴He prior to the experiment, and improved performance was observed. In the current model, the compact states are produced initially as a result of the phononic excitation. We note that a very large compact state concentration is reported in the Kasagi experiments, where on the order of 10⁻⁶-10⁻⁵ of the deuterons are reported to be in compact states. We interpret this as being due in part to an initial rapid formation of compact states from helium, followed by a slower accumulation of them from the molecular states. Hence the requirement for helium is absolute (⁴He in the case of d+d reactions, and ³He in the case of p+d reactions), and in general the more in relevant sites the better—theory would indicate that it is in principle possible to run the reaction backwards under conditions of a highly excited phonon mode involving many more than 10¹¹ atoms where there are more helium atoms present that molecular D₂ states (there exist observations of a net refrigeration effect in electrochemical experiments). A helium density on the general order of 10⁻⁵ of the metal density would seem to be a good concentration to work toward. The current model for excess heat indicates that a relatively low base level of excess heat production can be enhanced significantly through coherent enhancements associated with the presence of molecular states, compact states and helium being present within a common phonon coherence domain. Support for this comes from burst effects that have often been seen in excess heat production, where first no excess heat is observed for a prolonged period, and then an excess heat pulse initiates spontaneously, and finally terminates spontaneously with no obvious alteration of the experiment. This is consistent with optical bursts seen in optical and infrared experiments that explore Dicke superradiance, and we interpret them here in this way. Such effects are maximized initially by the initial presence of helium in relevant sites and in large quantities [heat production in our models leads to an increase of helium in relevant sites as a result of the energy production mechanisms under discussion].
F. Most of our work has focused on the d+d reactions leading to ⁴He, as most of the relevant experimental observations that shed light on physical mechanisms have been done in metal deuterides. However, the basic principles apply in essentially all regards to the p+d system. The tunneling between protons and deuterons is much improved due to the smaller reduced mass. The stability of compact states is improved due to the absence of strong force mediated decay channels. The only requirement in the latest versions of the model is for compact state channels that involve a free neutron (in order to maximize angular momentum input from the lattice), and such channels are available for the p+d system. Hence to implement an energy producing system based on the p+d reactions, one seeks a mixed metal deuteride/hydride with roughly equal concentrations of protons and deuterons in the lattice (which is nontrivial as many metals have separation factors very different from unity—in Pd, this will require an electrolyte that is about 90% heavy water and 10% light water). Inclusion of ³He in the lattice initially is required in place of ⁴He. Molecular state formation in the metal is still required. Phonon excitation as discussed above is required, although due to the improved stability of the compact states, less angular momentum transfer is required, and hence less phononic excitation. This aspect of the model is supported in many experiments reporting observations of excess heat in light water systems, in which the current density (which is inferred to be proportional to the excitation of the phonons) required is much reduced from similar heavy water experiments. Evidence in support of the existence of a p+d reaction comes from observations of Swartz in which the addition of small amounts of deuterium to a light water cell was seen to increase the excess heat output, consistent with the model that indicates a maximum excess heat production at a 50-50 mix.

Numerous experiments support our ideas about the physical mechanisms involved. We have retrospectively looked at a great many experiments for which anomalies of one sort or another are claimed, and in essentially all cases we are able to identify how the physical requirements outlined above come into play. Of great interest in this regard are the closely related electrochemical experiments of the early 1990s of K. Wolf and of the SRI group. When the two groups met at EPRI meetings, they were surprised at how they had evolved toward very similar electrochemical protocols for their different experiments. In this case, K. Wolf electrolyzed Pd cathodes in heavy water in order to make neutrons, while the SRI group electrolyzed Pd cathodes in heavy water to make excess heat. Of interest was the dependence of the different effects on the current density. Wolf required current densities in the general neighborhood of mA/cm² to see neutrons, and got no effect when he drove the system at higher current densities. The SRI group got no excess heat effect at low current densities, but needed to drive the system at higher current densities (typically on the order of 100 mA/cm²) in order to see an excess heat effect. In light of the models that we have described, if we reasonably assume that some fraction of the electrical input power is going into exciting phonon modes in the manner discussed above, then in the Wolf experiment the phononic excitation is relatively weak and the corresponding localized states are relatively unstable, producing dd-fusion products at low levels. In the SRI experiment, the phononic excitation produced at the higher current densities are reasonably presumed to be greater, allowing for much greater phonon exchange and a much greater associated angular momentum in the localized states, which makes them much more stable. In the model, this is required for the system to exchange energy efficiently with the lattice. We note that Takahashi [presented at ICCF9, not yet published] has reported on experiments in which the current is cycled between low levels and high levels, and neutron emission at low levels is observed associated with the low current levels while the excess heat effect is associated with high current levels, consistent with the experiments considered above in this paragraph.

We have outlined in general terms what is essential based on theory, and supported by many experiments, to arrange for anomalies in metal deuterides, and for excess heat in particular. In previous experimental work, the various anomalies come and go with some reasonable level of reproducibility, but the state of the art has not yet produced systems that could be considered either controlled or suitable for commercialization. In seeking a basic understanding of the physical mechanisms, we move toward new systems that work based on design, rather than on trial and error.

In addition to requirements that derive from the underlying theory, we have in addition requirements that derive from other considerations. Some of these are worthwhile to review here.
a) For example, if we wish to convert excess power to electrical energy, we would like for the operating temperature to be elevated. This in turn impacts the design, as aqueous electrochemistry is no longer an attractive approach.
b) Electrochemistry in general is not overly efficient, so we are also interested in designs that do not involve electrochemistry.
c) The creation of excited phonon modes can be done in many ways, and the designs that result from these different ways lead to qualitatively different technologies.
d) For example if we wish to excite THz phonons, we may do so by stimulating the surface of a metal deuteride with a THz radiation source, or by beating infrared or optical lasers together in the presence of a nonlinear surface interaction. Direct surface stimulation can be arranged for by fluxing hydrogen, deuterium, or other elements through chemical potential discontinuities. Semiconductor devices are capable of generating very high frequency vibrations under electrical stimulation.
e) Acoustical stimulation can be induced through the use of microwave and RF sources which interact with surface conductivity of metal deuterides. Fluxing atoms across chemical potentials stimulates higher frequency vibrations that downshift in metal deuterides, as they are highly nonlinear. The generation of acoustical waves electronically is well known, and can be used to drive metal deuterides when placed in mechanical contact.
f) While most experiments on excess heat production have involved Pd, we recognize that Pd is expensive, so that the use of other materials is of interest. Excess heat production in heavy water electrochemical experiments has by now been reported in PtD (Storms) [Storms, E. Excess Power Production from Platinum Cathodes Using the Pons-Fleischmann Effect. in 8th International Conference on Cold Fusion. 2000. Lerici (La Spezia), Italy: Italian Physical Society, Bologna, Italy], TiD (Dash) [Warner, J. and J. Dash. Heat Produced During the Electrolysis of D2 O with Titanium Cathodes. in 8th International Conference on Cold Fusion. 2000. Lerici (La Spezia), Italy: Italian Physical Society, Bologna, Italy. Also see: Warner, J., J. Dash, and S. Frantz. Electrolysis of D2 O With Titanium Cathodes: Enhancement of Excess Heat and Further Evidence of Possible Transmutation. in The Ninth International Conference on Cold Fusion. 2002. Beijing, China: Tsinghua University: unpublished], and NiD (Swartz). Claims have been made for excess heat effects in other metal deuterides at high temperature (Romodanov) [Romodanov, V. A., N. I. Khokhlov, and A. K. Pokrovsky. Registration of Superfluous Heat at Sorbtion-Desorbtion of Hydrogen in Metals. in 8th International Conference on Cold Fusion. 2000. Lerici (La Spezia), Italy: Italian Physical Society, Bologna, Italy], but we are not sure at present how reliable these claims are. Theory does not particularly discriminate between the different metal deuterides in principle, except insofar as the number of deuteron pairs in molecular states is different from one to another.
g) The theoretical models indicates that the coupling between the nuclear degrees of freedom and the phononic degrees of freedom is symmetric in the limit of a very large number of phonons (much greater than 10¹⁰), in which case both heating and cooling effects compete with one another. The population flow can be directed in the quantum flow calculations by reducing the number of phonons initially, as long as the total interaction is not reduced. In practice, this means that a smaller geometrical domain or coherence domain will be advantageous, as the reaction rate for energy production will be higher in this case. In the case of optical phonon modes or THz level acoustical phonon modes should be in the range of 10¹⁰ atoms or less, although at some point if there are too few atoms present the reactions will not be able to proceed. This has not yet been clarified through modeling, but one might expect that particles containing less than about 10⁶ atoms may not be able to complete the energy conversion process. Support for the view that smaller particles are advantageous comes from experimental results of Szpak and of Arata and Zhang [Arata, Y. and Y. C. Zhang, A new energy generated in DS-cathode with ‘Pd-black’. Koon Gakkaishi, 1994. 20 (4): p. 148 (in Japanese). Arata, Y. and Y. C. Zhang, Helium (4He, 3He) within deuterated Pd-black. Proc. Jpn. Acad., Ser. B, 1997. 73: p. 1. Arata, Y. and C. Zhang, Presence of helium (4/2He, 3/2He) confirmed in deuterated Pd-black by the “vi-effect” in a “closed QMS” environment. Proc. Jpn. Acad., Ser. B, 1997. Vol. 73: p. 62.].
h) The energy generated in the models is first transferred to the highly excited phonon modes that exchange phonons during the site-other-site reactions. This can be considered to be a greatly generalized version of a nonlinear stimulated emission kind of effect. Hence we note the possibility of a phonon laser driven by the energy generation mechanisms under discussion. Given the very fast decay of energy in optical phonon modes and THz modes in general, the rate at which energy must be replaced to support a phonon laser effect is very high, and seemingly incommensurate with experiments that have been reported. We note that a system that operated in a phonon laser mode would be very attractive, as it would not need stimulation past that required to initiate the process. Due to the short lifetime of high frequency phonons, a phonon laser approach would require the use of phonon modes below about 1 GHz.
i) If we view the metal deuteride operating as described in system terms, then deuterium is fuel and helium is ash. Consequently, for long-term operation we need to make sure that deuterium continues to be replaced, and helium removed. Both are straightforward in principle. Deuterium exchange with a reservoir, either gaseous or a metal deuteride, are obvious candidates. The removal of helium can be done by an occasional heating cycle in order to bring it to relevant surfaces to desorb, since the solubility of helium in metals is low. Helium may accumulate in voids, and in the long term lead to degradation of the structural intensity.
j) In the case that we adopt a scheme in which electromagnetic radiation is used for surface stimulation, the absorption of the radiation is expected to be poor. Consequently, we would like to make use of schemes that allow for multiple reflections of the radiation in order to absorb it more efficiently. In the case of long wavelength radiation, we would like to employ a resonant cavity.
k) In some cases, the local excess power production has been sufficiently great to melt the metal deuteride. This is viewed as detrimental in systems intended for long-term use in energy production. Stimulation by electromagnetic radiation or by other means under conditions outlined in this patent application is expected to result in such high levels of power generation. To prevent melting, an attractive approach is to use a relatively high local intensity (for example 100 s of W/cm² absorbed energy or greater) that is beneficial in creating large amplitude phonon excitation relative to this system, but to keep the stimulation on for relatively small fraction of the time (i.e. such that the duty cycle is low). Experience with pulsed systems has indicated qualitative changes in Claytor's experiments, where there appeared to be a characteristic time scale on the order of 10 milliseconds. Optical and acoustical measurements of Boss and coworkers indicate the presence of shorter optical and acoustical events that are thought to be associated with short localized episodes of an excess heat production effect [J. Dea, P. A. Mosier-Boss, S. Szpak, “Thermal and Pressure Gradients in the Polarized Pd/D System” presented at the March 2002 APS meeting—Paper W21.010]
l) To maximize the molecular deuterium concentration in the metal, we wish to maximize the loading and maximize the host lattice metal single vacancy concentration. This can be done in many ways. Electron beam irradiation is very effective at creating Frenkel defects, which can be stabilized if the metal is well loaded with hydrogen or deuterium. The maximum vacancy concentration is on the order of 0.1-0.2% in a metal, limited by spontaneous annealing internally at room temperature. Loading with hydrogen or deuterium stabilizes these vacancies, and vacancy concentrations up to 25% have been reported in the literature for NiH and PdH. Ion beam irradiation creates multiple vacancies, and is presently thought to be less effective than electron beam irradiation, although published data in regard to excess energy production is generally not available in either case. The deposition of metal on substrates with mismatched lattice constants will generate defective lattices, and this should be effective in helping to maximize the molecular deuterium concentration in the metal.
m) The use of a hot (above 1500 C or so) tungsten (or various other metals) wire to induce the formation of atomic deuterium in a gas is effective under certain conditions to load a metal deuteride efficiently. The use of this in conjunction with the device technology under discussion will be helpful in maintaining deuterium concentration in metal deuterides at higher temperatures.
n) We are interested in the development of power generation systems that are controlled in the sense that we are able to turn them on, off, and set the operating power level. We note here that it will be useful to implement feedback systems in any practical device in order to control the operating power level. The reaction rate is determined in part by the amount of phonon excitation, and in part by the molecular deuterium concentration—both of which are subject to control. For example, lowering the temperature of a metal deuteride in the range of room temperature to 200 C has the effect of lowering the molecular deuterium concentration in the metal, and should lower the reaction rate. Support for this comes from many electrochemical experiments in which the heat production rate is maximized as the temperature is increased. In a metal deuteride in equilibrium with deuterium gas, the gas pressure can be reduced to lower the concentration of deuterium in the metal deuteride. If a hot wire is used to make atomic deuterium for loading, the wire temperature can be reduced, producing less atomic deuterium, hence loading the metal deuteride less.
o) The size scale of an energy-producing device of the type under discussion can range over many orders of magnitude. For example, we can imagine a single heat-producing device as small as 10⁸ atoms running in phonon laser mode used in conjunction with a small nanotechnology electrical converter and electrical motor. Alternatively, we can think of a device the size of a flashlight battery, which makes heat and converts it to electricity for use in a laptop computer application. Large scale energy production might take advantage of a THz-level free electron laser, which can be an efficient and relatively large power device, to generate power in conjunction with properly prepared metal deuterides for large scale power production.
p) Power levels of the technology under discussion range from zero up to several kilowatt/cm³ levels, based on experimental results claimed by many different groups.
q) Heat production by itself is of interest in many applications, but heat to electricity and heat to mechanical energy is also useful in many applications. Hence we may consider to be of use a system such as discussed above that operates at elevated temperature that converts heat to electricity using a thermoelectric (or other) converter connected to a heat sink at room temperature. Similarly, we can imagine an engine that makes use of direct heating in part of its cycle through deuterium to helium reactions in a metal deuteride as outlined above.
r) The coupling of photonic excitation to the metal deuteride lattice is interesting, in that the momentum of a photon is very small compared to the momentum of most phonon modes in bulk. Low-momentum phonons in PdD occur at very low frequencies (KHz-GHz) in the case of acoustical phonons, and also at the phonon band edges at 5.5 THz (acoustical phonons) and at 8 THz (optical phonons). In all other cases, the efficient coupling of electromagnetic radiation to the phonon modes of interest will be difficult without some mechanism to make up the momentum difference. The obvious ways to do this is include: working with metal deuteride surfaces that are very irregular on a microscopic scale; working with lattices that are highly disordered on the scale of the phonon wavelengths of interest; and working with surfaces that maximize the surface to volume ratio.
s) We note that experiments and theory indicate that there are phenomena other than heat producing reactions that result in helium production as an ash. In a heat producing application, we would like to avoid operating regimes that produce other products. Consequently, it is advantageous to arrange for monitoring for other reaction pathways in order to change the operating conditions or discontinue operation when running outside of the desired operating regime. Specifically, theory at present indicates that heat and helium production occur in the regime of large phononic excitation, and other products can occur if the phononic excitation is less. Hence if low-level fusion products or other products are observed, then the system needs to be tuned so as to increase the level of phononic stimulation.
t) Although we have used the phrase metal deuterides throughout the discussion, we recognize that the model indicates that heat producing reactions of the kind described here are possible under whatever conditions are consistent with the requirements under discussion—significant molecular state D₂ or HD concentration (hopefully above the ppm level), significant ⁴He or ³He concentration (on the order or less of the molecular state concentration), and significant phonon excitation (such that the helium nuclei move locally relative to the surrounding lattice at a level of about 100 fm or greater), for a timescale at least long enough for the state distributions to spread (thought to be on the order of ten milliseconds in some experiments) and hopefully for long enough for a Dicke supperarradiance burst to evolve (which has in most experiments so far been on the order of minutes to days—a time which should be able to be shortened with improved designs). We recognize that there exist hydrogen containing materials that are not metals in which these conditions can be satisfied, and experimental reports of the observation of anomalies in such materials. These include deuterated ceramic proton conductors, for example. Deuterium loaded molten metals may be a possibility, which by the model should be able to be used as long as molecular deuterium and helium can be maintained, and phononic stimulation applied. Water or other liquids that are supersaturated with ⁴He and with molecular D₂ (or with ³He and molecular HD) and stimulated phononically appear to fall within the range of materials that may be acceptable. Not much is known about reactions in such materials at present.

In what follows in this section we discuss the basic theory behind the inventions described in other sections of the patent application. We recognize that in the course of our work leading to the present application, we have made a rather fundamental advance in our understanding of some very fundamental aspects of how nuclear reactions in a lattice interact with the lattice. In what follows, we will sketch out briefly in a technical discussion the basic principles, models, results and conclusions, as we presently understand them.

We have studied a large number of approaches to the problem of anomalies in metal deuterides over the past 14 years. Most of these approaches did not prove to be fruitful, as might have been expected since the problem is difficult and there is little in the literature that is either helpful or relevant to provide guidance to theory on the problem.

Although it was understood early on that the problem of energy exchange between nuclei and the lattice was critical, it was not really understood until relatively recently how energy exchange might occur in ways that are relevant to experiment. It has only been in the past five years or so that a viable theoretical approach has emerged. From our studies of the new models that result from this basic approach, we have come to the conclusion that these models have predictive capability for experiments on anomalies in metal deuterides.

A requirement that we have imposed from the beginning is that the underlying theoretical formulation was finally arrived at is one that would have to be consistent with the laws of quantum mechanics and with existing nuclear theory. This greatly restricts the approaches possible, and it perhaps might have been possible to foresee the new formulation much earlier if we had had more insight. In the end, the basic formulation that is required is one that generalizes the assumption of a vacuum picture for nuclear reactions, and replaces it by a compelling picture in which the nuclear reactions that occur in the lattice include the lattice as an essential part of the quantum system under discussion.

Once we have adopted the new picture, we require that all subsequent conclusions and predictions follow from the use of pretty much standard theoretical techniques and concepts. Our experience so far with the new formulation indicates that this approach is indeed fruitful, as the predictions of the new model, inasmuch as they differ from the results of vacuum physics, appear to correspond pretty well with the results of experiments that have been reported over the years on anomalies in metal deuterides.

Once we have agreed upon the premise of the new model, it is clear how to proceed. We wish to extend the description of nuclear reactions, historically formulated under the assumption that a vacuum description is adequate, now to include the lattice at the outset. While there exist a few different formulations from which to work, it seems most useful to generalize the formulation that has received the most attention in the relevant literature on the dd-fusion problem. In this case, a perusal of the literature indicates that most papers have made use (either explicitly or implicitly) of the Resonating Group Method of Wheeler [J. A. Wheeler, Phys. Rev. 52 1107 (1937)]. In what follows, we consider briefly the generalization of this method to include the lattice.

In all cases, we seek approximate solutions to the time-independent Schrodinger equation
EΨ=ĤΨ
where E is the energy eigenvalue for the total system, Ĥ is the Hamiltonian that includes a relevant description of the quantum system under discussion, and Ψ is the associated wavefunction. The Resonating Group Method as applied to the vacuum version of the problem presumes an approximate wavefunction Ψ, (where the subscript t here is for “trial” wavefunction as is common when using a variational method) of the general form

$${Ψ}_{t} = {\sum }_{j} {Φ}_{j} {F}_{j}$$

where the summation over j includes all of the different reaction channels, both input and exit channels. In each channel, the nuclei present are described by fixed nuclear wavefunctions Φⱼ that are associated with channel j. The separation between the nuclear center of mass positions within a given channel j is described by the channel separation factor Fⱼ.

Having fixed the nuclear wavefunctions in this approach, the only freedom available in the variational wavefunction Ψₜ that might be optimized is in the choice of the separation factors Fⱼ. These channel separation factors can be optimized by requiring that the residual R given by

$$R [ \{ {F}_{j} \} ] = {\vert \frac{〈 {Ψ}_{t} \vert \hat{H} - E \vert {Ψ}_{t} 〉}{〈 {Ψ}_{t} \vert {Ψ}_{t} 〉} \vert}^{2}$$

be minimized. For fixed nuclear wavefunctions Φⱼ, the optimization of the residual leads to coupled-channel equations that are characteristic of the Resonating Group Method

$$E {F}_{j} = 〈 {Φ}_{j} \vert \hat{H} \vert {Φ}_{j} 〉 {F}_{j} + {\sum }_{k} 〈 {Φ}_{k} \vert ( \hat{H} - E ) \vert {Φ}_{k} {F}_{k} 〉$$

Results consistent with this are given in Wheeler (1937). Coupled-channel equations of this form are either used explicitly or implicitly in association with the dd-fusion problem by most authors from the 1930s through the 1990s. Relevant examples in the literature include J. R. Pruett, F. M. Beiduk and E. J. Konopinski, Phys. Rev., Vol. 77, p. 628 (1950) and H. J. Boersma, Nucl. Phys., Vol. A135, p. 609 (1969).

The primary weakness of the Resonating Group Method with regard to the vacuum formulation of the problem is that the nuclear wavefunctions are not allowed to be optimized. For example, one expects that these wavefunctions will be polarized when they are in close proximity, which cannot be described within this formulation. Further modifications of the nuclear wavefunctions are possible when they are interacting strongly under conditions where the overlap is large. These effects can be described within formulations that are stronger than the Resonating Group Method, such as the R-matrix method [A. M. Lane and D. Robson, Phys. Rev., Vol. 151, p. 774 (1966). D. Robson and A. M Lane, Phys. Rev., Vol. 161, p. 982 (1967). A. M. Lane and D. Robson, Phys. Rev., Vol. 185, p. 1403 (1969). R. J. Philpott and J, George, Nucl. Phys., Vol. A233, p. 164 (1974).]

Or the time-dependent Hartree-Fock method. It is possible to generalize the R-matrix method to include lattice effects, but we have not pursued such a project yet at this stage of our research. The reason for this is that all of the different formulations are pretty complicated technically, and we wish to work with the simplest possible formulations that contain the physics of interest before moving on to more complicated formulations.

To generalize the Resonating Group Method to include lattice effects, we require that the channel separation factors Fⱼ be generalized to include other nuclei in the lattice. For example, in the case of the dd-fusion reaction, the Fⱼ would include a description of the relative motion of the two deuterons in a function of the form Fⱼ(R₂−R₁) where R₁ and R₂ are the center of mass coordinates associated with the two deuterons. At large separation in the initial channel, this function might be taken to be of the form e^{iKD(R}^{₂}^{-R}^{₁}⁾.

When reactions occur in a solid, there are other particles in the vicinity of the reacting nuclei, and we wish to include them as part of generalized channel separation factors. This is readily accomplished through a generalization that we might denote mathematically as
Fⱼ→Ψⱼ
The new lattice channel separation factors Ψⱼ now includes the separation factor of the nuclei that were in the vacuum formulation, as well as all of the nuclei and electrons in the vicinity of the reacting nuclei that might be relevant. In work that we have pursued to date, the contribution of the electrons is included through the effective potential between the nuclear coordinates within the Born-Oppenheimer approximation. But in general, we intend for the generalization here to represent the physics associated with whatever is relevant in the surrounding solid, under the presumption that whatever analysis follows would restrict attention to that which is most important. This discussion leads immediately to the generalization of the Resonating Group Method, which we can describe mathematically through equations very similar to those discussed briefly above. We take for a trial wavefunction a summation of the form

$${Ψ}_{t} = {\sum }_{j} {Φ}_{j} {Ψ}_{j}$$

The trial wavefunction Ψₜ is now made up of the fixed nuclear wavefunctions Φⱼ that are involved in the different reaction channels of the specific nuclear reaction under discussion, in the same sense as was used in the Resonating Group Method. The new lattice channel separation factors Ψⱼ now include the nuclear separation of the reacting nuclei on the same footing with a description of all of the relevant center of mass coordinates of neighboring nuclei (and electrons if so required in a particular model).

In our discussion of this generalization of the Resonating Group Method in previous publications, we have referred to the new method as the Lattice Resonating Group Method. We have noted previously that the R-Matrix method can equivalently be so generalized.

The new formulation that we have described here is interesting for many reasons. Of great interest is that it includes the old vacuum formulation for nuclear reactions as a subset of a more general theory of nuclear reactions. The new approach is consistent with the large body of accepted experimental and theoretical results obtained previously and accepted by the nuclear physics community. The primary new effect that is a consequence of this generalization is the prediction of phonon exchange associated with nuclear reactions. For example, a fast deuteron incident on a metal deuteride target that reacts with a deuteron in the lattice has a finite probability of phonon exchange as a consequence of the nuclear reaction. This is not taken into account in a vacuum description of the reaction, and we may rightly fault the vacuum description for this deficiency.

Of course, for all first-order reaction processes, the absorption or emission of a few phonons is unlikely to be noticed under most conditions. The associated energy exchange is on the order of tens of millivolts, and the reaction energy is of the order of megavolts. The corresponding impact on the reaction rate or on the final state nuclear kinetic energies is quite small, as expected. This strongly supports the validity of the vacuum description for such reactions.

However, there are new effects that are predicted by the new theory that have been overlooked completely in the vacuum formulation, and which are of interest to us in what follows. Phonon exchange has the potential to contribute to the microscopic angular momentum, resulting in a modification of the microscopic selection rules. Phonon exchange of reactions at different sites with a common highly excited phonon mode can lead to quantum coupling between such reactions, and this opens the possibility of new kinds of second-order and higher-order reaction processes. These new processes appear to be reflected in experimental studies of anomalies in metal deuterides, and are of particular interest to us.

Within the new formulation of the Lattice Resonating Group Method, we now allow for the possibility of phonon exchange in a nuclear reaction, and we must examine in more detail how phonon exchange comes about. In the simplest possible picture, the center of mass coordinates of nuclei must be considered to be phonon operators. We may, for example, write for a nuclear center of mass operator \hat{R}ⱼ an expansion in terms of phonon amplitude operators \hat{q}

$${\hat{R}}_{j} = {\sum }_{m} {u}_{j , m} {\hat{q}}_{m}$$

where the summation is over phonon modes m, and the vectors u_{j,m} describe the displacement of the center of mass of nucleus j due to excitation of phonon mode m. It follows that the strong force interaction and Coulomb interaction between nucleons can be interpreted as a highly nonlinear phonon operator when the nucleons are associated with different nuclei. This gives a natural route to the inclusion of phonon exchange in nuclear reactions within a lattice.

Technical issues arise when the nuclear interaction is understood as including phononic contributions under conditions where one of the phonon modes is very highly excited. The motivation for considering this situation is that when the event that the phonon interaction is nonlinear, the second-order interaction between nuclei at different sites becomes algebraic—and hence long range on the nuclear scale. The reason for this is that in a typical quantum calculation of second-order processes where a large number of states are involved, the different states tend to destructively interfere with one another. Off-resonant second-order processes that involve single phonon exchange couple to all phonon modes on more or less an equal footing, leading to severe interference effects that limit the range of interaction. However, in the case of a nonlinear interaction, the coupling to a highly excited mode leads to preferential coupling with that mode, and the strong interference effects normally encountered for linear interactions does not damp the interaction. For this reason, all site-other-site interactions must involve a nonlinear interaction with at least one very highly excited phonon mode.

Unfortunately, this kind of problem leads immediately to technical difficulties. These technical difficulties are discussed in: P. L. Hagelstein, Philosophical Magazine B 79 149 (1999). The highly excited phonon mode is delocalized, and is naturally described in terms of the phonon mode amplitude \hat{q}, or an equivalent phonon operator. The nuclear interaction is of short range, and is therefore best described in terms of position operators \hat{R}ⱼ. The technical difficulty arises if we try to expand the nuclear interaction in terms of phonon modes, in which case we develop an expansion that must include very high orders of a very large number of phonon modes. Alternatively, if we try to model the dynamics of the highly excited phonon mode through position operators, our description would naturally require the inclusion of position operators for all of the nuclei involved in the dynamics of the delocalized phonon mode. Neither approach alone appears to be either attractive or particularly useful.

We proposed the use of a hybrid formulation for this kind of problem. The basic idea is to begin with an expansion of the position operator in terms of phonon mode operators, separating out the contribution of the mode that is highly excited

$${\hat{R}}_{j} = {u}_{j , m} {\hat{q}}_{m} + {\sum }_{{m}^{′} \neq m} {u}_{j , {m}^{′}} {\hat{q}}_{{m}^{′}}$$

We then define a residual position operator \overline{\hat{R}}ⱼ that includes the contributions of all other phonon modes

$${\hat{\overline{R}}}_{j} = {\sum }_{{m}^{′} \neq m} {u}_{j , {m}^{′}} {\hat{q}}_{{m}^{′}}$$

This produces a hybrid formulation of the form
\hat{R}ⱼ=u_{j,m}\hat{q}ₘ+ \overline{\hat{R}}ⱼ
where m is understood to refer to the highly excited phonon mode.

The residual position operator \overline{\hat{R}}ⱼ is very nearly the same as the position operator \hat{R}ⱼ. In the event that the separated phonon mode were either unexcited or thermally excited, the difference in operators would be trivial locally. We can make use of this separation between the local and nonlocal degrees of freedom in order to analyze the coupled lattice and nuclear models that arise from the Lattice Resonating Group Method.

We will shortly consider the calculation of phonon exchange in association with nuclear reactions between deuterons in metal deuterides. Prior to this discussion, we require the consideration of a number of practical points that pertain to our discussion. For example, since the tunneling probability between deuterons at neighboring octahedral sites is very low, we are interesting initially in the case of molecular states within the metal deuteride. This reduces the complexity of the associated theoretical problems that we analyze later on. We are interested in the problem of screening between deuterons in a metal deuteride. We conclude from an analysis of the screening problem that the use of the molecular deuterium model in this regard is appropriate (this is the case for titanium deuteride—there is evidence from deuteron beam experiments at low energy that the screening in palladium deuteride and some other metal deuterides is enhanced relative to the molecular case). Finally, we are interested in the distribution of rotational states in the metal deuteride, which is likely to be close to that of the molecular problem.

Early on in 1989 when the Jones effect was first under discussion, there were many manuscripts put forth that discussed the problem of double site occupation in TiD and PdD. The basic issue involved is that the tunneling probability and associated fusion rate for molecular D₂ had been explored, with a very low result for both quantities. As tunneling in TiD was expected to be about the same as for the D₂ molecule, it appeared that the Jones effect could be ruled out based on such theoretical considerations. Subsequent measurements of dd-fusion cross section for low energy (keV) deuterons incident on TiD targets gave deviations from the free space fusion cross section for bare ions that were consistent with screening at a level commensurate with the molecular D₂ problem.

There was further discussion in 1989 that deuterons occupied primarily octahedral sites in PdD and tetrahedral sites in TiD, and that these deuterons were on average further apart than in molecular D₂, and hence would have a smaller associated tunneling probability. These questions were of interest to us over the years, as many speculative papers appeared suggesting that the physics might be otherwise. In addition, when we began focusing on schemes based on dd-fusion reactions, these questions began to become important for our work. We were interested in the basic question as to what conditions give rise to the largest tunneling rate in PdD. The basic issue in question is that to achieve tunneling at the molecular D₂ level, it would seem that a molecular version of the D₂ molecule would need to be present within the metal deuteride. In the case of double occupancy of a site, perhaps the associated D₂ wavefunction could be approximated by a molecular wavefunction, modified in some way to account for the potential of the surrounding host lattice atoms. Given that the probability for double occupancy in bulk PdD is very low, the associated question arose as to what is the tunneling probability associated with deuterons in neighboring sites. In response to this, we developed two-deuteron variational wavefunctions for the problem of two deuterons in a metal deuteride given by

$$E Ψ ( {r}_{ 1} , {r}_{ 2} ) = [ \begin{matrix}- \frac{ {ℏ}^{ 2} {∇}_{1}^{ 2}}{ 2 M} - \frac{ {ℏ}^{ 2} {∇}_{2}^{ 2}}{ 2 M} + {V}_{ mol} ( {r}_{ 2} - {r}_{ 1} ) + \\ {V}_{ lat} ( {r}_{ 1} ) + {V}_{ lat} ( {r}_{ 2} )\end{matrix} ] Ψ ( {r}_{ 1} , {r}_{ 2} )$$

We studied this problem using wavefunctions of the general form
Ψ(r₁,r₂)=Φₐ(r₁)Φ_{b}(r₂)g(r₂−r₁)
as well as with more sophisticated trial wavefunctions. As perhaps might have been anticipated, we found that the tunneling probability associated with deuterons at neighboring sites was astronomically low. The potential barrier associated with realistic potential models is sufficiently high and wide that it introduced tens of orders of magnitude reduction in the tunneling rate over that of the molecular problem. This was true for O-O, O-T, and T-T occupation. We considered separately the cases in which a deuteron at one site tunneled to a neighboring site, and where deuterons from both site tunneled in order to meet in the region between sites. We also studied cases in which two deuterons were situated at the same site, in both octahedral and tetrahedral sites. We found in these cases that the wavefunction was approximately molecular, and that the overlap probability was maximized relative to all other cases.

The basic conclusion is that any reactions involving two deuterons in metal deuterides must involve the molecular D₂ state within the metal. A retrospective analysis of the different conditions under which anomalies have been reported suggests that in all cases the highest level of anomalies are reported in metal deuterides in which the molecular D₂ content is maximized. For example, in electrochemical experiments at SRI, the loading is maximized such that the deuterium concentration exceeds the Pd density near the surface—conditions that would maximize double occupation of a site. Double occupancy is also maximized in the presence of host metal lattice vacancies, and many successful experiments have been reported in materials that would be expected to have very high defect densities. In some cases, experiments operate at elevated temperature with relatively low loading, with positive results. In such cases, the elevated temperature combined with lattices containing large concentrations of defects would maximize double site occupation. We note in addition that host metal lattice vacancies are thermodynamically favored in highly loaded PdD and NiD (Fukai used this feature to create metal hydrides with one out of four host metal lattice atoms missing), such that they will diffuse inward from surfaces at slow rates. We conjectured that this mechanism might have been responsible for a long time constant associated with the excess heat effect in the early SRI experiments.

Over the years, numerous authors have suggested that the Jones experiment could be accounted for through an enhancement of electronic screening effects in titanium deuteride. For example, it is known that in semiconductors and in special classes of materials, electrons behave as if they have a mass greater than the free electron mass. An increase in the electron mass, according to the argument, would produce an enhanced screening effect, which might increase the fusion rate. This kind of argument is not correct, as the screening required must occur under conditions when the two deuterons are within less than an Angstrom. The electron band theories that lead to an apparent modification of the electron mass apply for electrons delocalized over many sites, and are not applicable for this kind of screening.

Ichimaru published in Reviews of Modern Physics a computation of screening between deuterons in PdD and TiD based on relatively sophisticated models that are used in astrophysics. Based on his calculations, he concluded that the tunneling probability is increased by on the order of 50 orders of magnitude from the results of the molecular problem. If true, this would be a very important contribution, and might help to shed light on the problem of anomalies in metal deuterides generally.

In Ichimaru's model, the effect that contributes the largest amount to the screening is a model for the static dielectric constant used within the effective Coulomb interaction. We were unfamiliar with the use of a dielectric response other than the vacuum dielectric response in the case of deuterons close together within the lattice.

To investigate this, we developed a version of a linear response model for the electrostatic interaction between two deuterons in metal deuterides. The result can be expressed in the form

$$\begin{matrix}\hat{H} = \frac{{\vert {P}_{1} \vert}^{2}}{2 {M}_{1}} + \frac{{\vert {P}_{2} \vert}^{2}}{2 {M}_{2}} + \frac{{q}_{1} {q}_{2}}{\vert {R}_{1} - {R}_{2} \vert} + {E}_{e} ( \vert {R}_{1} - {R}_{2} \vert ) + {V}_{lat} ( {R}_{1} ) + \\ {V}_{lat} ( {R}_{2} ) + {\sum }_{m} 〈 {\frac{{q}_{1} e}{\vert {R}_{1} - {r}_{m} \vert} [ E - {H}_{0} ]}^{- 1 } \frac{{q}_{2} e}{\vert {R}_{2} - {r}_{m} \vert} 〉 + \\ {\sum }_{m} 〈 {\frac{{q}_{2} e}{\vert {R}_{2} - {r}_{m} \vert} [ E - {H}_{0} ]}^{- 1 } \frac{{q}_{1} e}{\vert {R}_{1} - {r}_{m} \vert} 〉\end{matrix}$$

The dielectric response comes about naturally in infinite-order Brillouin-Wigner theory. We were interested in whether this response resulted in a modification of the Coulomb interaction at short range. At long range (under conditions where many atoms and electrons are between the two deuterons), this kind of model reproduces the dielectric response used by Ichimaru.

From an analysis of this model, we concluded that the screening effect at short range that follows from this model produces a polarization potential of the form
Vₚₒₗ=V₀+ΔR•M•ΔR
where ΔR=R₂−R₁. The dielectric response from the electrons localized at other atoms yields only a weak screening locally between the deuterons. Based on this, we conclude that the dielectric response at short range should be the vacuum dielectric response. We disagree with the results of Ichimaru in this regard.

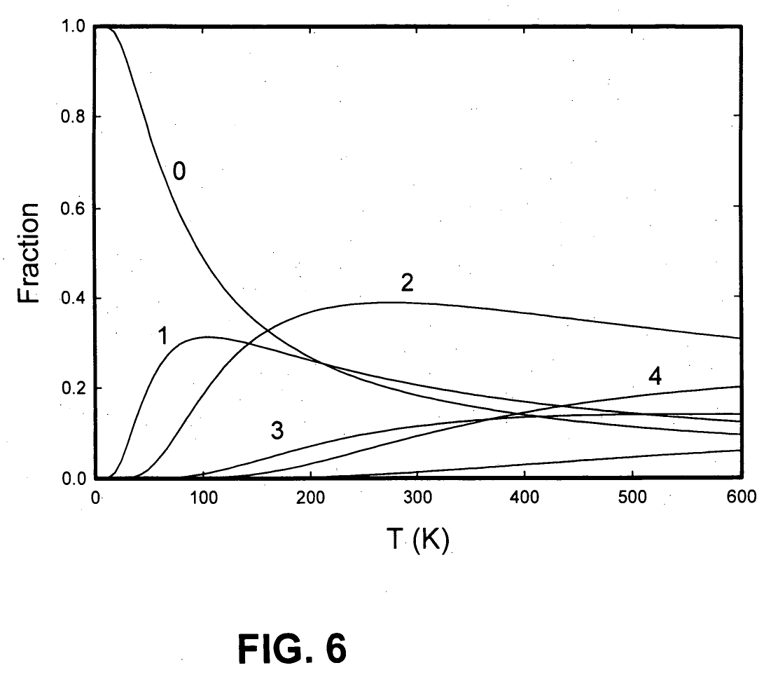

The tunneling between deuterons that are in molecular states within the metal deuteride is dependent on the vibrational and rotational excitation. As the vibrational excitation energy is significantly greater than k_{B}T, our interest in this regard is on the excitation of the angular momentum states. Plotted below in Figure Th-l are shown the fractional populations of the different rotational states of molecular deuterium from a calculation that we have done [for a discussion of this kind of calculation, see P. L. Hagelstein, S. D. Senturia and T. P. Orlando, Introduction to Applied Quantum and Statistical Mechanics, to be published shortly by Wiley and Sons]. One sees that the distribution is limited to states of relatively low excitation as would be expected from the moment of inertia of molecular deuterium. FIG. 6 illustrates a fractional occupation of the different angular momentum (l) states in molecular deuterium as a function of temperature.

In many experiments on anomalies in metal deuterides, it is arranged so that a deuterium flux is present within the metal deuteride. It might reasonably be asked as to whether such a flux can modify the distribution of angular states as estimated for molecular deuterium as calculated above.

To examine this possibility, we require an estimate for what deuteron velocity might be relevant in order to contribute angular momentum, as well as an estimate for what the corresponding deuteron flux might be when some fraction of the deuterons have such a velocity. We begin by examining the velocity. In a semi classical model, we might estimate the velocity needed from equating the classical angular momentum to a quantum unit of angular momentum. The classical angular momentum is
L=r×p

Assuming that the velocity and momentum are perpendicular leads to the semi-classical constraint
r(M ν)=l
where M is the relative mass, r is the separation and ν is the velocity. In this case, we assume l units of angular momentum. Evaluation of this indicates a need for velocities on the order of several hundred cm/sec per unit of angular momentum.

The deuterium flux is perhaps most meaningfully characterized in terms of the associated current density J, which can be estimated by:
J=qNv

If we assume that all of the deuterons in a nearly completely loaded metal deuteride participate, we conclude that the current density required is on the order of 6400ν in units of Amps/cm², which is an extremely high current density that is orders of magnitude greater than current densities thought to be present in experiments within the field. If one presumes that only a small number of deuterons are mobile, then the calculation is improved by the fraction assumed to be mobile—nevertheless, the resulting numbers are in the tens of thousands of Amps/cm² equivalent of deuterium flux, which is outside the range of average currents in the experiments. We conclude that the presence of a deuterium flux at accessible levels does not alter the angular momentum distribution significantly.

Having described the premise of the new formulation, and having considered some of the practical issues associated with deuterium in metal deuterides, we now need to consider the issue of phonon exchange in nuclear reactions. In the prototypical model under discussion, we assume that there is a single very highly excited phonon mode present in the metal deuteride that interacts with the nuclei in the metal deuteride. For energy production, we are interested in reactions between two deuterons, and more generally between all of the mass 4 states that are accessible. If we wished to expand our discussion to the problem of fast alpha emission, we would also need to consider the interaction of phonons with alpha particles in the host metal nuclei. To expand further to the case of induced radioactivity as reported by Wolf, we would include phonon interactions in association to reactions mediated by the weak interaction. For simplicity, in what follows we will focus on phonon interactions in selected transition associated with the mass 4 states, recognizing that the approach applies generally to a much larger class of reactions.

Some consideration of nuclear models is appropriate in this discussion. We are considering a nuclear description in which protons and neutrons are taken as fundamental particles (the details of the internal quark structure is not essential in the physics under discussion here). Nucleons interact with one another primarily through the strong force at close range, and through the Coulomb interaction at longer range (since the strong force is short range). The interactions of interest to us are well described through a parameterization of the strong force interaction appropriate to the low energy regime. In this regard, we expect that a description based on a Hamada-Johnston type of nuclear interaction model would be appropriate.

In our work so far, we have explored phonon interactions using simpler models. Part of our effort has been devoted to improving the models so that we are able to analyze phonon exchange directly with realistic nuclear potentials (such as the Hamada-Johnston potential)—our first results of this kind are expected within the coming year. The calculations that we have done so far are based on Gaussian wavefunctions and scalar Gaussian potential models for the strong force. Such calculations so far confirm the important aspects of the theory under discussion, and give results that we would expect to be correct qualitatively.

Many important features of atomic and nuclear processes derive from the associated selection rules, and there are some associated issues that we need to address here. We assume that the dominant interactions involved in the processes under discussion are due to strong force interactions, under conditions where the difference of center of mass coordinates are made up of a phononic contribution (due to the highly excited phonon mode) and a residual contribution (due to all the other modes). The strong force interaction in the absence of phonon exchange conserves isospin, spin and spatial symmetry of the nuclear wavefunctions. Isospin conservation is retained when the highly excited phonon mode is included explicitly in the calculation, but spin and spatial symmetry is not. Spatial symmetry of the nuclear wavefunctions can be changed in association with a change in the symmetry of the phonon wavefunction in the amplitude space (q configuration space). Spin can be changed due to the presence of LS interaction terms in the strong force interaction under conditions where the spatial operators include phononic contributions.

Consequently, in the mass 4 problem, if we are interested in reactions leading to ⁴He, we are restricted to nuclear channels with zero total isospin. As deuterons have isospin T=0, and ⁴He has isospin T=0, the isospin selection rule has an impact on the accessible two-body t+p and n+³He channels, as well as whatever excited helium states that one might consider including. The spin channels are in general unrestricted, and the channels with different spatial symmetry are restricted only in the requirement that the total nuclear local nuclear 4-particle fermionic wavefunctions must be antisymmetric under particle exchange.

We recognize that phonon exchange can contribute angular momentum to the microscopic nuclear system, so that we anticipate phonon-induced modifications of the vacuum selection rules. For example, two deuterons can fuse to make ⁴He in vacuum with the emission of a gamma in an electric quadrupole electromagnetic transition. In the lattice, the exchange of an even number of phonons greater than zero can make satisfy the selection rules with no need for a gamma. The situation is qualitatively similar as in the case of phonon emission associated with electronic transitions of atomic impurities in a lattice. An atomic transition that in vacuum can proceed through radioactive decay with a dipole allowed transition can instead decay through a dipole allowed phonon emission process.

The general theory under discussion is a completely standard quantum mechanical treatment of a coupled quantum system (in this case a coupled phonon and nuclear system), and hence the coupling between the phononic and nuclear degrees of freedom comes about directly from a calculation of the interaction matrix element. The degree to which we are able to make quantitative predictions and qualitative statements about the physics under discussion is in proportional to our ability to estimate such interaction matrix elements.

In our work so far, we have focused on the calculation of interaction matrix elements for the special case of phonon-induced transitions between two deuteron states and the ⁴He ground state. These calculations were performed in support of our efforts at evaluating a model based on transitions between the molecular D₂ state, two-deuteron compact states and the ⁴He state. We will shortly describe the details of this calculation, but before doing so we must note that since these calculations were done our understanding has improved. Consequently, we intend here to use the result from this calculation instead as an approximation for the interaction associated with a different reaction process.

Keeping this in mind, we then consider the evaluation of the interaction [symbol]
Φ_{dd}øₙYₗₘ|Ĥ−E|ø_{He}ø_{n′} [symbol]
which first appeared in our work in the analysis of the two-site problem associated with the null reaction
(d+d)ₐ+(⁴He)_{b} [symbol] (⁴He)ₐ+(d+d)_{b}

In the two-site problem, we assumed an initial wavefunction that included the different angular momentum channels of the two deuterons states (in a scalar approximation with no spin or isospin) and a highly excited phonon mode

$$\begin{matrix}Ψ = {\sum }_{n} {A}_{n} \vert {Φ}_{He}^{a} {Φ}_{He}^{b} {ϕ}_{n} 〉 + {\sum }_{nlm} \vert {Φ}_{dd}^{a} {Φ}_{He}^{b} {ϕ}_{n} {Y}_{l m}^{a} 〉 \frac{{P}_{nlm}^{a} ( r )}{r} + \\ {\sum }_{nlm} \vert {Φ}_{He}^{a} {Φ}_{dd}^{b} {ϕ}_{n} {Y}_{l m}^{b} 〉 \frac{{P}_{nlm}^{b} ( s )}{s} + {\sum }_{n} {\sum }_{l m} {\sum }_{{l}^{′} {m}^{′}} \vert {Φ}_{dd}^{a} {Φ}_{dd}^{b} {ϕ}_{n} {Y}_{l m}^{a} {Y}_{{l}^{′} {m}^{′}}^{b} 〉 \\ \frac{{P}_{{nlml}^{′} {m}^{′}}^{ab} ( r , s )}{rs}\end{matrix}$$

This model is discussed further in P. L. Hagelstein, “A unified model for anomalies in metal deuterides,” ICCF9 Conference Proceedings, Beijing, May 2002, edited by X. Z. Li (in press). To estimate the nuclear interaction including phonon exchange, we adopted simple models for the nuclear states of the form

$$\begin{matrix}{Φ}_{d} = {N}_{2} {ⅇ}^{- {β}_{2} {\vert {r}_{1} - {r}_{2} \vert}^{2}} \\ {Φ}_{He} = {N}_{4} {ⅇ}^{- {β}_{4} {\vert {r}_{1} - {r}_{2} \vert}^{2}} {ⅇ}^{- {β}_{4} {\vert {r}_{1} - {r}_{3} \vert}^{2}} {ⅇ}^{- {β}_{4} {\vert {r}_{1} - {r}_{4} \vert}^{2}} {ⅇ}^{- {β}_{4} {\vert {r}_{2} - {r}_{3} \vert}^{2}} \\ {ⅇ}^{- {β}_{4} {\vert {r}_{2} - {r}_{4} \vert}^{2}} {ⅇ}^{- {β}_{4} {\vert {r}_{3} - {r}_{4} \vert}^{2}}\end{matrix}$$

The use of these kinds of states in the early nuclear literature in the 1930s was common. The 4-particle wavefunction is sometimes called a Feenberg wavefunction.

The overlap integral between a deuteron pair and a helium nucleus depends on the relative distance between the deuteron center of mass coordinates. If we naively replace H-E by an attractive scalar Wigner interaction, then we obtain

$$\begin{matrix}〈 {Φ}_{ dd} \vert \hat{H} - E \vert {ϕ}_{ He} 〉 = - {V}_{0} {N}_{2}^{2} {N}_{4} \int {ⅆ}^{3} {x}_{21} \int {ⅆ}^{3} {x}_{43} {ⅇ}^{- {β}_{2} {\vert {x}_{21} \vert}^{2}} \\ {ⅇ}^{- {β}_{2} {\vert {x}_{43} \vert}^{2}} [ {ⅇ}^{- α {\vert {r}_{1} - {r}_{3} \vert}^{2}} + {ⅇ}^{- α {\vert {r}_{1} - {r}_{4} \vert}^{2}} + \\ {ⅇ}^{- α {\vert {r}_{2} - {r}_{3} \vert}^{2}} + {ⅇ}^{- α {\vert {r}_{2} - {r}_{4} \vert}^{2}} ] {ⅇ}^{- {β}_{4} {\vert {x}_{21} \vert}^{2}} {ⅇ}^{- {β}_{4} {\vert {r}_{1} - {r}_{3} \vert}^{2}} \\ {ⅇ}^{- {β}_{4} {\vert {r}_{1} - {r}_{4} \vert}^{2}} {ⅇ}^{- {β}_{4} {\vert {r}_{2} - {r}_{3} \vert}^{2}} {ⅇ}^{- {β}_{4} {\vert {r}_{2} - {r}_{4} \vert}^{2}} {ⅇ}^{- {β}_{4} {\vert {x}_{43} \vert}^{2}}\end{matrix}$$

Where x₂₁=r2−r₁ and X₄₃=r₄−r₃. The distance between the two-deuteron center of mass coordinates is a function of the amplitude of the highly excited phonon mode

$$\frac{1}{2} ( {r}_{3} + {r}_{4} ) - \frac{1}{2} ( {r}_{1} + {r}_{2} ) = \overline{r} + Δ u \hat{q}$$

Here r̅ is the residual radial separation coordinate, and Δu\hat{q} describes the relative motion due to the highly excited phonon mode. The basic picture that underlies this discussion is one in which two deuterons occupy a single site, either due to high loading, high temperature, or due to the presence of vacancies within the metal deuteride. Occasionally, the deuterons tunnel close together. While close together, the deuterons are still part of the lattice, and constitute a component of the phonon modes of the lattice. When they are close together, the very strong nuclear and Coulomb interactions dominate over the interactions with relatively distant atoms that may be a few Angstroms away. However, the deuterons will still exhibit a response in the presence of strong phononic excitation, although a weak one, which must be computed using a linearization scheme that takes into account the very strong interactions the deuterons undergo while close together. The resulting relative motion that is accounted from the Δu\hat{q} term is expected to be on the order of fermis.
After much algebra and the use of the WKB approximation, we obtain for an interaction

$$\begin{matrix}〈 {Φ}_{ dd} {ϕ}_{ n} {Y}_{ l m} \vert \hat{H} - E \vert {ϕ}_{ He} {ϕ}_{ {n}^{ ′}} 〉 = - 4 {V}_{0} [ \frac{{8}^{ \frac{1}{ 4}} {( 2 {β}_{ 2} )}^{ \frac{3}{ 2}} {( 4 {β}_{ 4} )}^{ \frac{9}{ 4}}}{\begin{matrix}{{π}^{\frac{1}{4}} ( {β}_{2} + 2 {β}_{4} )}^{\frac{3}{2}} \\ {( {β}_{2} + 2 {β}_{4} + \frac{α}{2} )}^{\frac{3}{2}}\end{matrix}} ] \\ {ⅇ}^{- K {\vert \overline{r} \vert}^{2}} \sqrt{2 l + 1 {δ}_{m , 0}}\end{matrix}$$

$$\times \frac{1}{π} {\int }_{- \frac{π}{2}}^{\frac{π}{2}} {ⅇ}^{- K {\vert Δ u \vert}^{2} {q}_{ max}^{ 2} {sin}^{ 2} ξ} {i}_{l} ( 2 K \overline{r} \vert Δ u \vert {q}_{max} sin ξ ) cos ( Δ n ξ ) ⅆ ξ$$

where Δn is the number of phonons exchanged, and where

$$K ( α , {β}_{2} , {β}_{4} ) = \frac{8 {β}_{4}^{2} + 4 {β}_{2} {β}_{4} + 4 {β}_{4} α + {β}_{2} α}{{β}_{2} + 2 {β}_{4} + \frac{α}{2}}$$

$${i}_{n} ( z ) = \sqrt{\frac{π}{2 z}} {I}_{n + \frac{1}{2}} ( z )$$

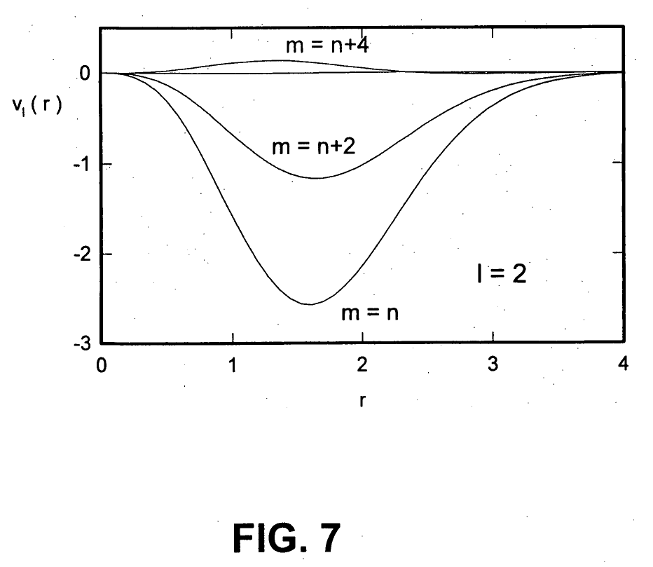

Our calculations so far indicate that a maximum local relative motion |Δu|qₘₐₓ on the order of half a fermi is sufficient to generate a significant two-phonon exchange interaction. Relative motion on the order of several fermis can result in the exchange of on the order of 10 phonons within this kind of model. Results for this model are illustrated below in FIG. 7 (taken from the MIT 2002 RLE Annual Report to be published in late June). FIG. 7 illustrates the results for the interaction in MeV, taking l=2 and assuming that the phonon interaction is characterized by a distance parameter Δu qₘₐₓ=1 fm . The matrix element in this simple model is finite for zero phonon exchange. This is due to a lack of orthogonality in the nuclear states; we expect no Δn=0 transitions. For the specific model that we investigated, we took the values
V₀=36.0 MeV
α=0.2657 fm⁻²
β₄=0.07942 fm⁻²

The calculation of the nuclear interaction including phonon exchange as outlined above would be a reasonable approximation in the event that the local relative motion of the two deuterons is linear. When we documented this model, we noted that the contribution to the relative motion of the two deuterons due to the highly excited phonon mode (Δu q) would have to be obtained through a separate calculation involving the linearization of the potential between the two deuterons. We recognized subsequently that this problem is more interesting than would be implied by the computation outlined above.

Two deuterons interacting with one another through the Coulomb interaction experience very strong radially directed forces when close together. Consequently, a linearization of the associated classical problem shows that there is almost no radial motion (since there is such a large gradient in the radial Coulomb potential), but instead the motion should be angular. A weakness of the model as presented for the two-deuteron problem is then in the use of a linear model for relative phonon-induced motion instead of an angular model. The phonon exchange that would be expected from a model improved in this way is less than for the linear model used. We have not yet developed such a model, but we would expect such a model also to give a significant phonon exchange effect.

More recent work has pointed to the importance of the p+t and n+³ He channels as candidates for the comprising the compact states of the model (and that appear in the Kasagi experiment). A consideration of the p+t channels indicates that the local relative motion associated with a highly excited phonon mode would also be angular as discussed above for the two-deuteron channel. However, the n+³He channels are different. Since the neutron has no charge, there is no Coulomb interaction, and a linear model for relative motion is far more relevant. In this case there will still be primarily angular motion for small separation, but overall the linear trajectory should be a much better approximation. The details of the computation will differ, since the triton wavefunction is more localized. Nevertheless, we expect the associated interaction potentials

$$〈 {Φ}_{{n}^{3} He} {ϕ}_{n} {Y}_{l m} \vert \hat{H} - E \vert {ϕ}_{He} {ϕ}_{{n}^{′}} 〉 and 〈 {Φ}_{{n}^{3} He} {ϕ}_{n} {Y}_{l m} \vert \hat{H} - E \vert {ϕ}_{dd} {ϕ}_{{n}^{′}} {Y}_{{l}^{′} {m}^{′}} 〉$$

to be similar in terms of how the phonon exchange works. In the first case, the phonon interaction in the case of n+³He and ⁴He states can be understood simply. Associated with the strong excitation of the highly excited phonon mode, a ⁴He nucleus will “move” locally in accordance to
\hat{R}ⱼ[⁴He]=uⱼ[⁴He]\hat{q}+ \overline{\hat{R}}

The ³He of the n+³He channel will see a similar solid state environment, and its dynamics are described by
\hat{R}ⱼ[³He]=uⱼ[³He]\hat{q}+ \overline{\hat{R}}

The displacement vectors uⱼ are naturally different since the mass is different in the two cases. Hence the differential displacement Δu in this case in the approximation of a linear trajectory is due to the difference between the amplitude of vibration associated with the different species. In this case, one would expect the uⱼ vectors to occur in the ratio of the square root of the inverse masses. Within this model, one calculates that sufficient phonon exchange occurs when the maximum total amplitude of vibration due to the highly excited phonon mode is on the order of 50-100 fm, as the maximum relative displacement in this case is less than this by (1−\sqrt{3}/2)=0.134.

More sophisticated models for the relative trajectory of the two nuclei would likely lead to a lesser fraction of the total amplitude of motion to be expressed as relative motion at close range, but at present it is thought that the basic argument is correct, but that the total range should perhaps be two orders of magnitude greater than 5-10 fermi presently thought to be the scale of a compact state, instead of one order of magnitude as in this case of a linear trajectory.

We studied a scalar Gaussian model for the two-site problem for a version of the null reaction
(d+d)ₐ+(⁴He)_{b} [symbol] (⁴He)ₐ+(d+d)_{b}
as mentioned above. The question at issue in the analysis was whether this model leads to a localized two-deuteron state with an energy below that of the molecular state. Our analysis of this problem at the time indicated that the exchange interaction was in fact attractive for some of the states, but not sufficiently attractive to stabilize a two-deuteron compact state.

The basic argument is worth discussing. A two-deuteron compact state would have a nuclear energy associated with the Φⱼ basis states that are the same as for the molecular D₂ state. In addition, there are contributions associated with the strong force interaction between the deuterons, the Coulomb interaction, the radial kinetic energy associated with localization, and the centripetal energy. Within the model under discussion, there is also an exchange energy associated with the null reaction. The total two-deuteron compact state energy is then

$$〈 \hat{h} 〉 = {E}_{dd} + 〈 {V}_{nuc} 〉 + 〈 - \frac{{ℏ}^{2}}{2 μ} \frac{{d}^{2}}{{dr}^{2}} 〉 + 〈 \frac{{ℏ}^{2} l ( l + 1 )}{2 μ {r}^{2}} 〉 + 〈 \frac{{ⅇ}^{2}}{r} 〉 + 〈 {V}_{exch} 〉$$

If we assume that the compact state involves nuclei separated enough that the nuclear “optical” potential can be neglected, then it must be arranged so that the Coulomb, radial kinetic and centripetal energies are balanced by the exchange energy. If we adopt a Gaussian and power law model for the compact state wavefunction of the form
Pₗ=r^{l+1}e^{-γr}^{²}
then we find for the three positive energy terms the result

$$〈 - \frac{{ℏ}^{2}}{2 μ} \frac{{d}^{2}}{{dr}^{2}} 〉 + 〈 \frac{{ℏ}^{2} l ( l + 1 )}{2 μ {r}^{2}} 〉 + 〈 \frac{{ⅇ}^{2}}{r} 〉 = \sqrt{2 γ} {ⅇ}^{2} \frac{Γ ( l + 1 )}{Γ ( l + \frac{3}{2} )} + \frac{{ℏ}^{2} γ}{2 μ} ( 2 l + 3 )$$

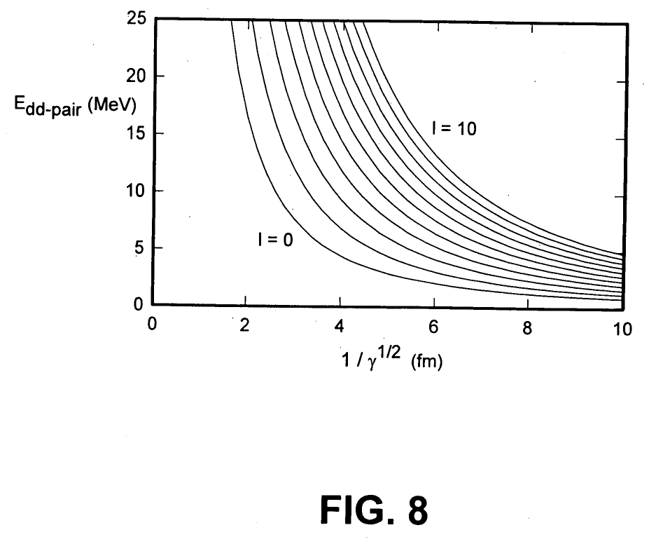

FIG. 8 illustrates the energy of a compact state due to the kinetic, centripetal and Coulomb contributions. The energy is in MeV. The axis is a measure of the pair separation 1/\sqrt{γ} in fermi. The basic problem in the formation of such a stable localized state is that the exchange energy required is very substantial. In the two-site version of the problem, the exchange potential was simply not large enough to stabilize the compact state. It was thought that an extended version of the problem that involved more sites would stabilize the two-deuteron compact state. The exchange energy can be negative for the two site problem—for the three-site problem it is larger since there are now two sites to exchange with rather than just one. And so forth. We estimated that roughly 10 sites interacting with a single highly excited phonon mode would be needed to stabilize the two-deuteron compact state through this mechanism, assuming that the phonon excitation is sufficient to develop usefully large interaction terms as discussed above. In the most recent version of the model under consideration, we have generalized the notion of what constitutes a compact state. In particular, there is no reason that two deuterons should not be able to produce p+t and n+³He compact states within the basic framework of the discussion. Hence a null reaction of the form
(p+t)ₐ+(⁴He)_{b} [symbol] (⁴He)ₐ+(p+t)_{b}
involving compact states at the two sites is quite interesting. In this case the compact state energy is

$$〈 \hat{h} 〉 = {E}_{pl} + 〈 {V}_{muc} 〉 + 〈 - \frac{{ℏ}^{2}}{2 μ} \frac{{d}^{2}}{{dr}^{2}} 〉 + 〈 \frac{{ℏ}^{2} l ( l + 1 )}{2 μ {r}^{2}} 〉 + 〈 \frac{{ⅇ}^{2}}{r} 〉 + 〈 {V}_{exch} 〉$$

which is about 4 MeV lower than in the case of two-deuteron compact states as discussed above. It is much easier for this kind of state to be stabilized.

Similar considerations apply in the case of an n+³ He compact state, although the nuclear energy difference is a bit less.

One advantage of the n+³ He compact state is that the mechanism for phonon exchange outlined above is expected to be more effective in the event that one of the constituents in neutral, as a neutron does not participate in the lattice phonon mode structure. Our current speculation is that such states may be the dominant compact state for this reason. This conjecture remains to be proven, but seems to be reasonable at present.

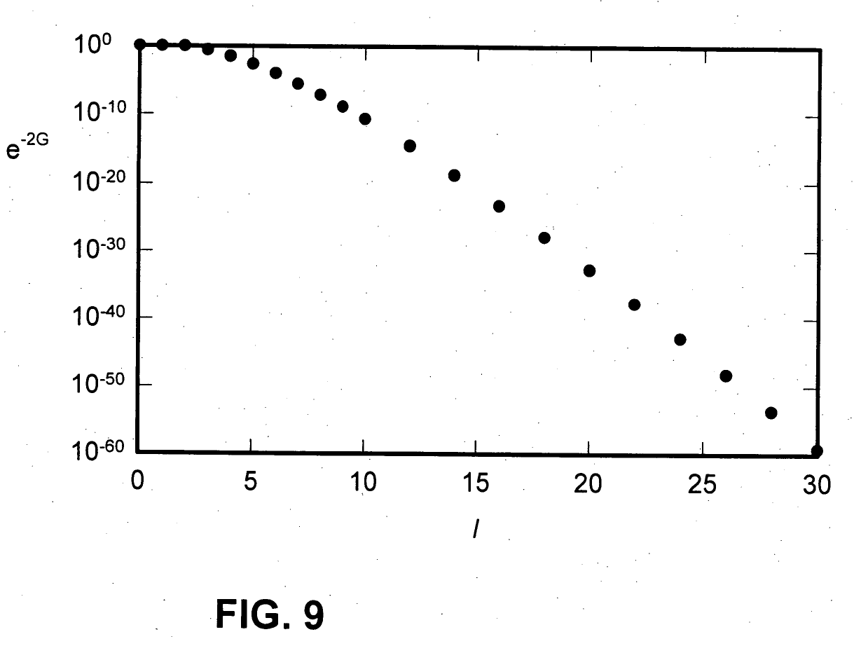

The discussion of these states as possibly being stable if there energy lies below the molecular D₂ state energy requires some comment. It is clear that all such localized states with an energy greater than the p+t rest energy are unstable against conventional fusion reactions that produce p+t as reaction products. The idea here is that phonon exchange in the models under discussion is very efficient in the limit that (Δu qₘₐₓ) is on the order of 10 fm or larger, so that the phonon-induced reactions under discussion can couple to high angular momentum states. We have estimated the reduction of the tunneling in the presence of angular momentum in the case of n+³ He decay at the d+d rest energy. The results are illustrated in FIG. 9. FIG. 9 illustrates a Gamow factor associated with the n+³He channel as a function of angular momentum of the two-deuteron compact state. We see that when on the order of 20 units of angular momentum are exchanged that the conventional vacuum dd-fusion reactions are suppressed due to the large associated centripetal barrier.

As a consequence, the models under discussion will be very stable when such large angular momentum transfer occurs, and this provides the theoretical basis for our requirement on significant phonon excitation. We need to transfer 20 or more units of angular momentum, or else there is little possibility of arranging for sufficiently stable compact states to exchange energy with the lattice. The ideas presented above apply in principle to the p+d reaction as well. In this case, the null reaction becomes
(p+d)ₐ+(³He)_{b} [symbol] (³He)ₐ+(p+d)_{b}

One candidate for the compact state in this case is a p+d state. In light of the discussion above, we are motivated to consider other possible compact states in which a neutron is free, so that the phonon exchange might be maximized. The mechanism described above that involves a free neutron would produce initially a compact 2He+n configuration that would be expected to couple to p+p+n configurations. These possibilities have been proposed in the course of our work, but as yet we have not attempted models that are specific to this problem.

Assuming that the basic mechanisms discussed above and below carry over to this reaction, then we are in a position to make some comments about the theory that is implied. The p+d reaction in vacuum produces ³He through an electromagnetic decay, and there are no kinetic reaction pathways. High angular momentum in this case stabilizes the compact state, as higher multipole radiation is then required to produce the singlet ³He ground state. However less angular momentum would seem to be required to achieve stable compact states than in the case of the d+d reaction. For example, here we are probably set with on the order of 10-12 units of angular momentum, whereas we would like 20 or more for the d+d reactions. Support for this idea comes from experiment in the lower current densities historically required for heat production in light water cells, which we interpret here as being based on the p+d reaction.

The lighter reduced mass translates into a faster reaction rate, all else being equal, as the tunneling probability for the proton and deuteron is increased by orders of magnitude. This will become important shortly.

The only potential disadvantage of the p+d reaction is that the reaction energy is about 5.5 MeV, instead of 23.85 MeV for the d+d reaction. One makes better use of deuterium in this kind of reaction.

Our studies of the two-site problem so far have shed light on many important issues. It is useful to summarize the results in light of the most recent modeling efforts. The two-site problem shows clearly the presence of exchange terms that derive directly from the Lattice Resonating Group Method (coupled-channel radial equations are given explicitly in P. L. Hagelstein, “A unified model for anomalies in metal deuterides,” ICCF9 Conference Proceedings, Beijing, May 2002, edited by X. Z. Li (in press). Moreover, we analyzed using simple scalar Gaussian models the interaction including phonon exchange in the presence of a highly excited phonon mode. The analysis of the resulting states showed clearly exchange effects that could be attractive.

Subsequent to the initial work on the problem, it has become clear that the two-site problem contains more as well. In the event that the angular momentum exchange is sufficiently large as to stabilize the states through the centripetal barrier as discussed above, then we might consider the compact states to be stable at different energies than we considered initially. For example, we would consider a high angular momentum state to be stable for many practical purposes if the state energy were a few MeV above the two-deuteron energy as long as all possible decay modes were sufficiently suppressed. The two-site problem in this limit then does describe stable compact states in a nontrivial limit. This is interesting, and advances the discussion in comparison to what we have written so far on the problem.

Nevertheless, we are interested in energy production, and within the framework of present understanding, the two-site model does not lead to heat production. We are therefore motivated to extend the discussion to the many-site version of the problem.

There are a number of technical issues that we face in the many-site problem. The first issue is that the complexity quickly increases as the number of sites increases. Consequently, we must explore the use of approximate methods and models that are somewhat idealized. The second issue is whether energy can be exchanged effectively between the nuclei and the lattice. Our models so far indicate that there exists a mechanism which accomplishes this, and we will address this below. Finally, there is the question of the associated reaction rate, which is where we will conclude our discussion.

We have developed models that address different aspects of the many-site problem. The increase in the stabilizing exchange energy as a function of the number of sites can be established directly through explicit construction of approximate solutions to the associated coupled-channel equations. This is documented in a recent (unpublished) final report for DARPA, and will be written up for publication in the coming year. We have developed in addition a many-site model that assumes that the phonon interaction is uniform at a large number of sites, and that the projection into the different compact states is also uniform at the different sites. Massive energy exchange between the nuclei and the highly excited phonon mode has been demonstrated with this model.

At present we are in the process of developing a new class of more sophisticated models that will address the problem of reaction rate. From our understanding of other models, it seems reasonable to attempt to extract an overall reaction rate estimate from this kind of model, as we will discuss shortly.

We first consider many-site models that assume spatial uniformity. The mechanics of the construction of the many-site coupled channel equations are straightforward, however, the problem seems to be qualitatively richer as we discuss below. The many-site coupled-channel equations are of the basic form

$${EP}_{M}^{β} = {H}_{β} {P}_{M}^{β} + {\sum }_{α , k} {v}_{k} {P}_{M - 1}^{α} + {\sum }_{γ , k} < {v}_{k} \vert {P}_{ M + 1}^{ γ} >$$

where P_{M}^{β} is a many-site channel separation factor with configuration β and with index M defined by

$$M = \frac{{N}_{dd} - {N}_{He}}{2}$$

There are a very large number of channels, and it quickly becomes impractical to attempt a direction solution of them. In our previous work, we made use of infinite-order Brillouin-Wigner perturbation theory in order to get some insight as to possible nature of the solutions. Here, we simply note that it appears that such an approach is simply not up to the problem when the coupling becomes strong enough to be interesting in terms of accounting for the experimental results. Instead, we must make use of alternate approximations.

Of fundamental concern is the question of whether there exist localized solutions to the many-site version of the coupled-channel equations. It seems a priori unlikely that an answer would be forthcoming without a brute force computation on the coupled-channel equations. Our efforts to date on this problem have so far not produced insight. For the purposes of the present discussion, we might adopt as an ansatz the assumption that we can define useful localized states that may or may not be stable, and proceed with the calculation in order to ascertain the goodness of the ansatz with solutions in hand. This has proven to be a productive approach.

We simplify matters further in order to allow us to make progress on the development of this very hard problem by assuming that all sites are identical, and furthermore, that the establishment of a localized state at each of these sites will involve the same local superposition of orbitals within the different angular momentum channels. These simplifications lead ultimately to a an approximate time-independent eigenvalue equation based on a Hamiltonian of the form

$$\hat{H} = Δ E ( {\hat{Σ}}_{z} + S ) + ℏω ( n + \frac{1}{2} ) + 〈 \hat{h} 〉 ( {\hat{Σ}}_{z} + S ) + {\sum }_{{n}^{′}} ( {\hat{Σ}}_{+} + {\hat{Σ}}_{-} ) {V}_{{nn}^{′}} {\hat{δ}}_{{nn}^{′}}$$

In this Hamiltonian the \hat{Σ} operators are pseudospin operators that are developed as a superposition over Pauli matrices at the different sites

$$\hat{Σ} = {\sum }_{i} {\hat{σ}}_{i}$$

The parameter S is the Dicke number for the system

$$S = \frac{{N}_{dd} + {N}_{He}}{2}$$

The localization energy for a single site is [symbol] ĥ [symbol] , and the V_{nn′} terms are integrals of the interaction potentials and localized orbitals summed over the different angular momentum channels. The \hat{δ}_{nn′} operator changes the number of phonons in the highly excited phonon mode.

We have encountered such a Hamiltonian previously, before we had considered the possibility of localized two-deuteron states, as perhaps applying to a many-body version of the problem in which molecular states would make phonon-mediated transitions to helium states. In that case, the hope was that the number of sites involved would be sufficiently large that the Dicke enhancement could offset the Gamow factors. Here, we apply the Hamiltonian now to the situation where compact states are making transitions, in which case there is no Gamow factor, and the coupling is very strong. In our previous work, we studied this kind of model in order to understand under what conditions such a model might lead to extended states that were sufficiently broad in n so as to allow coherence between the states with different number of fusion events and vastly different phonon number such that approximate energy conservation occurred. We were astonished at how this model stubbornly insisted on producing localized states in which the number of phonons exchanged was on the order of the associated dimensionless coupling constant. This being said, we are aware that the eigenfunctions of this Hamiltonian are generally not overly interesting in regards to relating to the physical problem in question, without further input to the problem.

The basic problem with the model Dicke Hamiltonian lies in its high degree of symmetry when n and S are large, and M is small. In order to develop delocalized solutions, the symmetry needs to be broken somehow. Either we require coupling coefficients that depend strongly on n or M, or else we need some kind of additional potential that is highly nonlinear in one or both of these quantum numbers.

There is another effect which is much more important, and which has a very strong dependence on M. This includes loss terms. For example, when two deuterons fuse in the many-site problem, the off-resonant energy ΔE (24 MeV) is more than enough to fuel recoil between localized deuterons and many other highly energetic decay modes. The presence of such decay modes completely destroys the underlying symmetry of the problem, and produces significant delocalization of the wavefunction in n and M space.

Unfortunately, the inclusion of decay channels into a Hamiltonian is not particularly straightforward. Such problems in other disciplines are often handled using density matrices. We wish not to adopt such a formulation here, as the associated complications would likely make further progress more difficult due to the added complexity of the approach. Instead, we prefer to think about the problem as a probability flow problem, as we will outline below. This discussion will appear shortly in P. L. Hagelstein, “A unified model for anomalies in metal deuterides,” ICCF9 Conference Proceedings, Beijing, May 2002, edited by X. Z. Li (in press).

In order to derive the relevant flow problem, we consider a Hamiltonian of the form
H=H₀+V

We imagine that the problem divides up into three sets of basis states, source states, sink states, and states intermediate between the two. For example, we might consider deuteron pairs locally in molecular states to be part of the source states. States that contain energetic reaction products that result from recoil processes or other reactions are sink states. Intermediate states are those including helium nuclei or two-deuteron compact states in the sites of interest. We may divide the associated Hilbert space into three sectors that correspond to source basis states, sink basis states, and intermediate basis states. After all, loss can be thought of as simply transitions from a sector of Hilbert space that one is interested in, to other sectors. We can accomplish this splitting of the different sectors by taking advantage of Feshbach projection operators

$${P}_{i} = {\sum }_{j} \vert {Φ}_{j} \text{><} {Φ}_{j} \vert$$

where the summation j is over the basis states in sector i. The time independent Schrodinger equation for this Hamiltonian is
EΨ=H₀Ψ+VΨ
To split this equation into sector-dependent equations, we assume that the eigenfunctions contains components in the three different sectors
Ψ=Ψ₁Ψ₂+Ψ₃
The time-independent Schrodinger equation is then divided into sector-dependent equations given by
EΨ₁=H₁Ψ₁+V₁₂Ψ₂
EΨ₂=H₂Ψ₂+V₂₁Ψ₁+V₂₃Ψ₃
EΨ₃=H₃Ψ₃+V₃₂Ψ₂
We identify Ψ₁ with the source sector, Ψ₂ with the intermediate states, and Ψ₃ with the sink states. In writing these equations, we presume that there is no direct coupling between source and sink states. The sink states can be eliminated as in infinite-order Brillouin-Wigner theory
Ψ₃=[E−H₃]⁻¹V₃₂Ψ₂
The intermediate sector equation then becomes
EΨ₂=H₂Ψ₂+V₂₁Ψ₁+V₂₃[E−H₃]⁻¹V₃₂Ψ₂
The interaction between the intermediate sector and the sink sector appears in this equation in the same way as in infinite-order Brillouin-Wigner theory. When the resolvant operator has a pole in a continuum at energy E, then the inverse operator develops an imaginary component that describes decay. We see in this equation a description of the intermediate sector, driven by the source sector, and decaying to the sink sector. We can solve formally for the intermediate sector component of the wavefunction to obtain
Ψ₂=[E−H₂−V₂₃[E−H₃]⁻¹V₃₂]⁻¹V₂Ψ₁
This accomplishes the development of a probability amplitude flow equation, complete with source and with sink. Although the underlying formulation is rigorously Hermitian throughout, the inverse operator describing the intermediate sector evolution is non-Hermitian with respect to the intermediate sector. We have included loss into a Schrodinger formulation in a useful way. We define the operator K₂ to be the intermediate sector Hamiltonian augmented with loss terms that are non-Hermitian with respect to the sector 2 basis states
K₂=H₂+V₂₃[E−H₃]⁻¹V₃₂
The intermediate state solution written in terms of this operator becomes
Ψ₂=[E−K₂]⁻¹V₂₁Ψ₁
This is interesting, as K₂ has eigenfunctions that are delocalized due to the presence of loss terms that are very nonlinear in M.

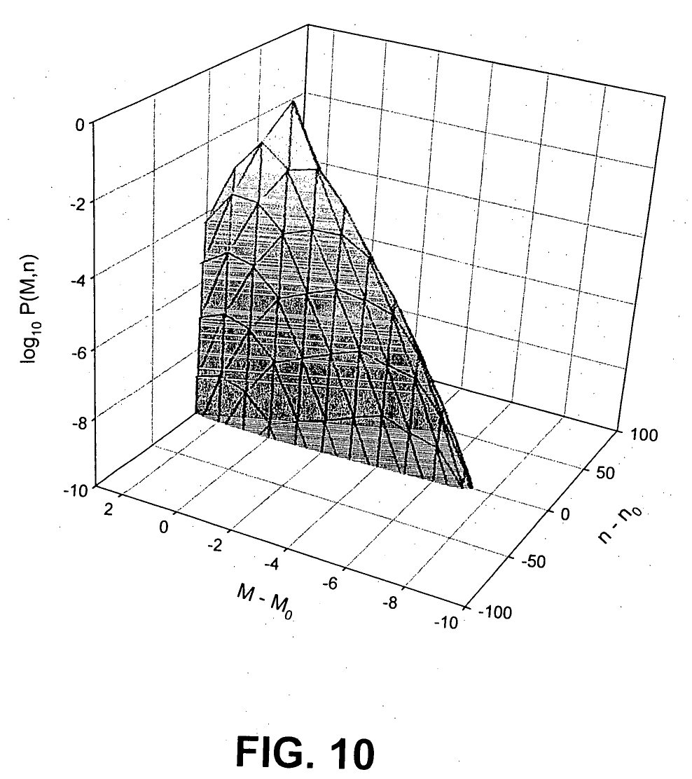

We have put together a computer code to analyze the intermediate state solutions along the lines outlined above. Let us consider a few examples in order to illustrate some of the systematics. In FIG. 10, we show the logarithm of the probability distribution under conditions where the source is localized at (M₀, n₀), and the coupling is weak. In this case, the initial condition corresponds to 3 helium atoms and 10 deuteron pairs. We see that the associated probability density is closely centered around the source, that the distribution is localized in phonon number, and that there is a spread in M that is perhaps larger than one might expect. In the direction of negative M−M₀, which corresponds to more helium nuclei present, the states are very unstable, and the probability distribution decays moderately. The balance between the coupling strength and the decay rate determines the slope. In the other direction, we quickly reach the boundary at which all of the helium nuclei have dissociated, where there is a wall. These states are stable, as they are in serious energy deficit. Such a distribution corresponds to a low or modest level of conventional dd-fusion events, as well as some events in which the fusion energy is transferred to other decay modes within the lattice. FIG. 10 illustrates a Probability distribution in the vicinity of the source in the case of weak coupling. In FIG. 10, we illustrate the same situation, except that the phonon oscillation amplitude is larger, and the interaction strength for phonon exchange is greater. We see that the stronger coupling leads to a much larger spread in n, which is a hallmark of this kind of model. The spread in M is very significant as well, more so than in the previous example. This spread would like to be even larger, however, in both the positive and negative directions, the distribution hits walls as the number of helium nuclei and deuteron pairs is limited. We see that there is some avoidance of high loss regions of the configuration space, but that this is not a dominant effect in this problem.

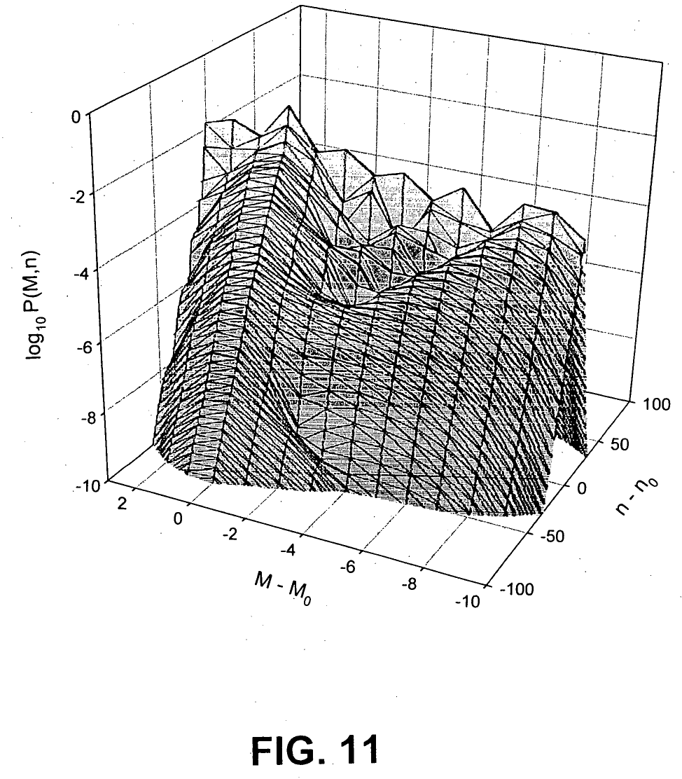

In FIG. 11, we present the logarithm of the probability distribution in the case where there are more helium nuclei present, and the losses are lower (corresponding to the development of higher angular momentum states). We see that the spread in phonon number is now much greater. We see another effect that is of great interest as well. We see that the probability distribution is strongly skewed into the region in which M−M₀ is positive, avoiding the region in which M−M₀ is negative. The avoided region is where deuterons have fused to helium, and where the system has more energy than the local basis state energy, and hence where many decay processes are allowed. The probability distribution is seen to be favoring low-loss regimes, and hence minimizing the overall loss. This is very interesting, and appears to be a fundamental characteristic of this quantum system.

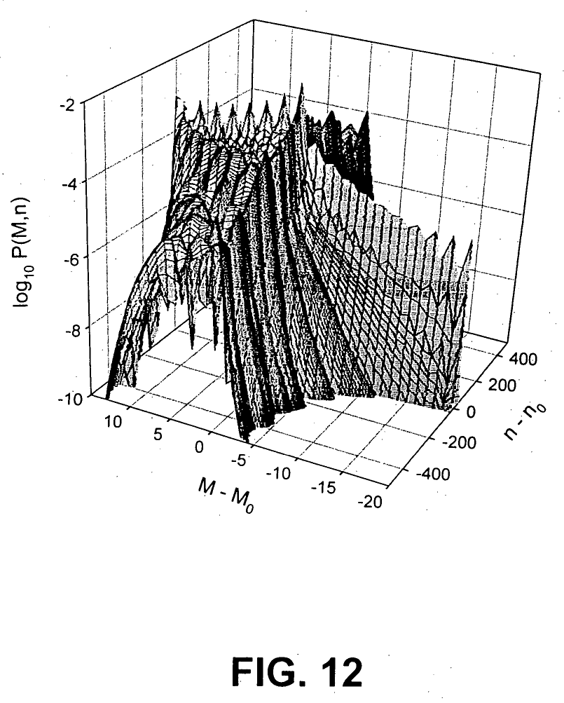

FIG. 12 illustrates a Probability distribution in the vicinity of the source in the case of strong coupling. Only a restricted range in n−n₀ has been included in the plot. The spread of the distribution in phonon number increases as the strength of the coupling, and decreases under conditions in which the loss is large. It is possible to develop some intuition from these results as to how this problem works. The part of the Hamiltonian that describes fusion and dissociation transitions in this context serves as a kind of kinetic energy operator for the problem. The solutions appear to be outwardly oscillatory away from the source. As long as the probability amplitude avoids lossy regions, then there appears to be a flow from the source into the positive M−M₀ corridor, confined on one side by a wall, and on the other side by an impedance mismatch associated with a high loss region. This flow is increased by a stronger coupling between the states, and inhibited only by the boundary loss. Our calculations so far have indicated that the transport of probability amplitude through the corridor can easily extend for more than a thousand quantum numbers in n−n₀. Altogether this is indicative of a rather efficient mechanism for coupling excitation and energy between the nuclear and phonon degrees of freedom.

The many-site version of the problem is very rich, as we see from the discussion above. We have achieved some measure of success in understanding the physical content of the new models through direct solution of the quantum flow problem associated with the relevant Dicke Hamiltonian augmented with loss. The symmetry associated with the basic Dicke Hamiltonian prevents efficient coupling between the nuclear and phononic degrees of freedom of interest to us. But as demonstrated above, the inclusion of loss in the model allows for this symmetry to be broken, and we find that massive coupling of energy between the nuclear and phononic degrees of freedom results from this kind of model.

Our models have so far not focused on the issue of the reaction rate that might be expected. This is to some degree the last issue to be addressed in regard to our theoretical efforts. The ideas and models that we will describe are presently areas of research that we are investigating. Consequently, our discussion is by necessity somewhat less complete than the work documented above.

The ability of compact state nuclei to exchange energy with the lattice we take as established through the arguments given above in this discussion. The relevant question then is how does one arrange for deuterons (or protons and deuterons) to get from molecular states to the compact states? This issue is of course addressed formally within the Lattice Resonating Group Method and the associated coupled-channel equations, and any analysis of the problem derives from a consideration of the solutions of the equations.

However, we are in search of intuition as to what the models say as to how this happens. We have recently identified a misconception in this area that is worthy of discussion here. Our intuition in the last few years has been that we can modify the probability distribution associated with the molecular state at small radius through the exchange interaction described above. Although we have verified that this is true, it unfortunately does not appear to be sufficient. To understand a complicated many-body problem, one usually likes to have a simple analog model, which contains the relevant physics, so that one can understand things simply. In this case, a convenient analog is constructed by replacing the local molecular state with a one-dimensional potential well. The source term due to ⁴He dissociation can be approximated as an exchange potential, leading to

$$E ψ ( x ) = [ - \frac{{ℏ}^{2}}{2 μ} \frac{{ⅆ}^{2}}{ⅆ {x}^{2}} + V ( x ) ] ψ ( x ) - Kf ( x ) \int f ( y ) ψ ( y ) ⅆ y$$

where V(x) is the one-dimensional equivalent molecular potential

$$V ( x ) = \{ \begin{matrix}∞ & for & x \leq 0 \\ {V}_{0} & for & 0 \leq x \leq d \\ 0 & for & d \leq x \leq L \\ ∞ & for & x > L\end{matrix}$$

We have taken ƒ(x) to be a delta function located near the origin. The strength of the null reactions is modeled in the constant K. This is illustrated above in Figure Th-c. This analog model problem is easily solved [see Figure Th-d]. When the coupling constant K is small, the solutions consist of states that are very close to the bound states of the well that contain a small amount of admixture from a localized state near the origin. The associated intuition is that the deuterons spend part of their time in the molecular state, and part of the time localized. We associate the localized component as being due to contributions from deuterons at close range that are produced from helium dissociation, which tunnel apart. We note that this basic argument applies whether the exchange occurs with two deuteron states, or with localized p+t or n+³He states.

We used this box model to estimate the level splitting that would be obtained under conditions of precise resonance between the compact state and the equivalent of the molecular state. The basic idea is that at resonance, the compact state and the ground state of the well mix maximally, producing two states—one that is a superposition of the two states in phase, and one that is a superposition of the two states out of phase. The associated dynamics for a two-state problem then is governed by the energy splitting between the two states. If the system is prepared initially in the bound state of the well, it will oscillate between the compact state and the delocalized state. The rate of oscillation then is determined by the energy level splitting.

We computed the level splitting exactly analytically, as documented in the DARPA final report. The result is complicated, but in essence it is of the form
Δε˜ν₀e^{-G}
where e^{-G} is the Gamow factor associated with tunneling, and ν₀ is the strength of the potential at short range. This kind of resonance allows for a vast improvement in the tunneling rate over what would be expected from a Golden Rule calculation (assuming that the potential near the origin was involved in an incoherent process) of

$$γ = \frac{2 π}{ℏ} {( {v}_{0} )}^{2} {ⅇ}^{- 2 G} ρ$$

The difference between e^{-G} and e^{-2G} can be enormous in the event of a thick and high potential barrier.

We have examined a similar calculation in the case of the radial molecular potential for D₂. In this case we studied the radial Schrodinger equation

$$E P ( r ) = [ - \frac{{ℏ}^{2}}{2 μ} \frac{{ⅆ}^{2}}{ⅆ {r}^{2}} + V ( r ) ] P ( r ) + K δ ( r - {r}_{0} ) {\int }_{0}^{∞} δ ( s - {r}_{0} ) P ( s ) ⅆ s$$

using for the potential V(r) the empirical potential of Frost and Musulin. We computed solutions under conditions of resonance between the localized state and the molecular ground state in order to understand the associated energy splitting, and hence the dynamics under resonance. We carried out computations for different placements of r₀, in each case optimizing the resonance condition. Numerical computations of this kind are limited by the numerical precision, however, the scaling is clear from the results illustrated in Figure Th-10. The results are not surprising in light of the analytic results for the equivalent box model. The results are consistent with an energy splitting on the order of
Δε—ν₀e^{-G}
where ν₀ is on the order of the Coulomb potential at the location of the exchange potential.

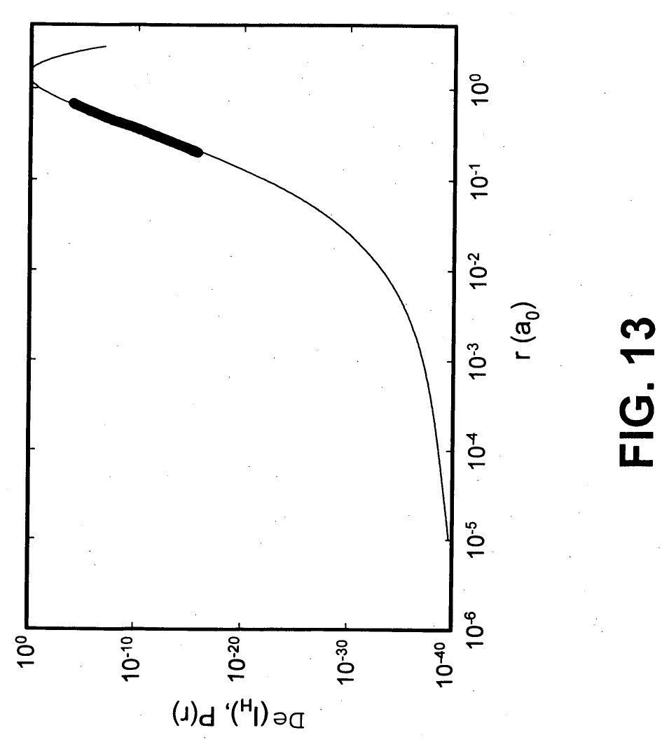

FIG. 13 illustrates the splitting of the energies at resonance for a localized state matched to the ground state energy in units of I_{H}=13.6 eV. Values of the cutoff location are given in units of the Bohr radius a₀=0.529 Angstroms.

The energy splitting is seen to be on the order of (10⁵)(10⁻³⁷)=10⁻³² eV. This is both good news and bad news. The good news is that the associated frequency is on the order of O(10⁻¹⁷) sect⁻¹, which is orders of magnitude faster than any possible incoherent version of the tunneling process. The bad news is that the number of practical problems associated with this kind of resonant state mechanism is enormous. For example, we would require that the two states be in resonance to within an energy on the order of the splitting, which is problematic. To achieve the fastest Rabi oscillation rate, one would have to wait a very long time, as the probability in the target state is quadratic in time. And if somehow all of these problems could be surmounted, one requires a correspondingly long dephasing time to implement a coherent transition of this type. The discussion above makes clear certain aspects of the problem that are of interest to us in the discussion that follows. The first is that coherent processes can achieve a dramatic enhancement in reaction rate over incoherent processes, especially when the difference between e^{-G} and e^{-2G} is many orders of magnitude. Within the context of the present discussion, it is clear that no incoherent mechanism could possibly lead to reaction rates that are within tens of orders of magnitude of those claimed in experiment. Hence whatever mechanism is to be discussed, it must involve coherent transitions of one sort or another, as there is no possibility for any other approach.

This motivates our consideration of what kind of models and what kind of physics to focus on in many-site models derived from the Lattice Resonating Group Method. Our discussion of many-site models above was based on the use of a Dicke algebra, as this is familiar in the modeling of coherent effects associated with two-level systems. However, in addressing the problem of transitions of deuterons from molecular states to compact states, an underlying two-level model is not going to do the job. Instead, we require more sophisticated models based on the three-level generalization of the Dicke algebra. The mathematics associated with this generalization has recently been considered as part of an ongoing PhD thesis research effort of I. Chaudhary at MIT, and it has been verified that the generalization of the Dicke states in this case (which are the states of highest symmetry) leads to many-particle matrix elements that are identical to those in the Dicke algebra for equivalent definitions of upper and lower state occupation. It is expected that this will be a result available in the literature, but as yet no reference has been identified.

This implies that we are able to apply our analytical skills and our intuition to more sophisticated many-site models, and begin to understand their properties. The simplest model of this class is one in which we assume an initial population of deuterons in molecular states, an initial population of helium atoms, and no initial occupation of compact states. The simplest possible model of this kind will assume only a single molecular state, a single compact state, and a single helium final state in association with each site, and uniform interaction with the highly excited phonon mode. The Hamiltonian for this kind of model in the absence of loss terms can be written as

$$\hat{H} = {E}_{He} {\sum }_{j} {( \begin{matrix}0 & 0 & 0 \\ 0 & 0 & 0 \\ 0 & 0 & 1\end{matrix} )}_{j} + {E}_{com} {\sum }_{j} {( \begin{matrix}0 & 0 & 0 \\ 0 & 1 & 0 \\ 0 & 0 & 0\end{matrix} )}_{j} + {E}_{mol} {\sum }_{j} {( \begin{matrix}1 & 0 & 0 \\ 0 & 0 & 0 \\ 0 & 0 & 0\end{matrix} )}_{j} + {ℏω}_{0} ( n + \frac{1}{2} ) + {ⅇ}^{- G} {\sum }_{{jnn}^{′}} {( \begin{matrix}0 & 1 & 0 \\ 1 & 0 & 0 \\ 0 & 0 & 0\end{matrix} )}_{j} {U}_{{nn}^{′}} {\hat{δ}}_{{nn}^{′}} + {\sum }_{{jnn}^{′}} {( \begin{matrix}0 & 0 & 0 \\ 0 & 0 & 1 \\ 0 & 1 & 0\end{matrix} )}_{j} {V}_{{nn}^{′}} {\hat{δ}}_{{nn}^{′}}$$

In this model, there are three states with energies E_{He} (ground state helium), E_{com} (compact state), and Eₘₒₗ (molecular state). The highly excited phonon mode is taken as before to be a simple harmonic oscillator. Transitions from molecular states to the compact states are modeled with an interaction inhibited by the tunneling factor e^{-G}, but otherwise involve phonon exchange according to the phonon interaction models discussed above. Transitions between the compact states and the helium states are modeled as we did previously.

This model implements a coupling scheme that would result from preferential phonon exchange in the case of compact states involving a free neutron, and is consistent with our best understanding at the momentum of the phonon exchange mechanism under discussion.

As written, the Hamiltonian for the three-level model is unlikely to lead to much of interest, since there is a very high degree of symmetry present in the coupling between the different states associated with the three-dimensional configuration space when the number of sites, nuclei and phonons is large. This is the same conclusion that we reached in the case of the Dicke model discussed previously.

Based on our experience with the many-site two-level model, we know that we need to include loss in order to arrange for useful exchange of phononic and nuclear energy. As the new three-level model is the same for these interactions we expect the behavior of the model to be the same as well. The decay terms will be very fast for states that have less energy than the relevant eigenvalue energy, which means that the loss will be very nonlinear in the associated Dicke number between the helium states and the compact states. This breaks the symmetry, and we will see probability distributions that are extended in n and M₁₂ (the Dicke number associated with the helium and compact state levels) when the phonon exchange is large enough to stabilize the compact states, and when the number of compact states and helium states are on the order of 10 or greater within a phonon coherence domain.

The dynamics of this more sophisticated model in this regard are reasonably clear. When molecular states make transitions to compact states within the model, the compact states will be able to rapidly convert nuclear energy to phononic energy, corresponding to a rather efficient conversion process. As described above, the difficulty is in arranging for these transitions in the first place, since the tunneling factor inhibits such transitions.

Another effect is present in this model that we did not pay attention to in our previous discussion. The coupling between the molecular states and the compact states within this model now has a Dicke enhancement factor present if there is both occupation of the molecular states as well as occupation of the compact states. Consequently, the occupation of the compact states is important before the first molecular state to compact state transition occurs.

The implication of this is that the coupling of the molecular states within the model to the compact states depends on the occupation of the compact states. Hence a model with zero initial occupation of compact states will have a slow initial transfer of population from the molecular states to the compact states. However, the model will show a rapid initial establishment of population due to transitions involving helium, as the helium to compact state transitions are very fast. Hence the presence of helium initially is predicted to draw population from the molecular states by establishing compact state occupation.

This feature of the model is ultimately at the heart of our requirement for the initial presence of ⁴He in the metal deuteride (or equivalently, ³He in the mixed metal deuteride and hydride).

There is of course an alternate coupling possible from the model outlined above. We could have specified instead transitions between the molecular state and the helium state, leading to a model Hamiltonian of the form

$$\hat{H} = {E}_{He} {\sum }_{j}^{} {( \begin{matrix}0 & 0 & 0 \\ 0 & 0 & 0 \\ 0 & 0 & 1\end{matrix} )}_{j} + {E}_{com} {\sum }_{{j}_{.}}^{} {( \begin{matrix}0 & 0 & 0 \\ 0 & 1 & 0 \\ 0 & 0 & 0\end{matrix} )}_{j} + {E}_{mol} {\sum }_{{j}_{.}}^{} {( \begin{matrix}1 & 0 & 0 \\ 0 & 0 & 0 \\ 0 & 0 & 0\end{matrix} )}_{j} + \\ {ℏω}_{0} ( n + \frac{1}{2} ) + {ⅇ}^{- G} {\sum }_{{jnn}^{′}}^{} {( \begin{matrix}0 & 0 & 1 \\ 0 & 0 & 0 \\ 1 & 0 & 0\end{matrix} )}_{j} {U}_{{nn}^{′}} {\hat{δ}}_{{nn}^{′}} + {\sum }_{{jnn}^{′}}^{} {( \begin{matrix}0 & 0 & 0 \\ 0 & 0 & 1 \\ 0 & 1 & 0\end{matrix} )}_{j} {V}_{{nn}^{′}} {\hat{δ}}_{{nn}^{′}}$$

In this model, Dicke enhancement factors would be present initially due to the presence of both molecular state deuterium and ground state helium. More complicated models including both kinds of transitions are possible, and further research will clarify which are most relevant to experiment.

We note that the use of initial helium seeding of the metal deuteride is beneficial in all of the different models of this class. We note that occurrence of Dicke factors within these models requires phase coherence. While the fast transitions between the helium and compact states will help in this regard, we will not have uniform phase in the molecular state occupation. Hence the Dicke factors will be less than what one might hope for based on state occupation alone. This problem has not yet been analyzed.

We can begin to contemplate the development of reaction rate estimates from these models. The intuition is that the fast transitions between the helium states and the compact states will rapidly establish a distributed probability distribution in phonon number and the Dicke number associated with these states. We can think of this as a “stiff” distribution in two of the three dimensions that is “pushed” by the sharp nonlinearity of the loss terms. Consequently, the rate limiting effects associated with the dynamics of the probability distribution are those associated with transitions in the third dimension—specifically, those associated with the transitions from the molecular states to the compact states (or equivalently, to the helium states depending on which model is adopted). The matrix elements associated with these transitions in the model are
U_{nn′}e^{-G}˜N_{Dicke}U₀e^{-G}
where the Dicke factor N_{Dicke} is on the order of the square root of the produce of the number of compact states present and the number of in-phase molecular state deuterons present within the coherence domain of the highly excited phonon mode.

The dynamics associated with this coupling is determined by the associated dephasing of the quantum states of the system. If the rate of dephasing of these states is faster than the frequency determined by the coupling matrix element divided by [symbol] , then the rate will be determined by the Golden Rule, which basically means that no observable transitions will occur. If the dephasing is on the order of or slower than this rate, then the transitions will proceed at the rate associated with the spread of probability amplitude in the associated configuration space, which is on the order of
Γ˜N_{Dicke}U₀e^{-G}
For the molecular problem, we would estimate
U₀e^{-G}˜10⁻³²eV
and possibly a larger number for PdD based on the low-energy dd-fusion cross section measurements. This corresponds to on the order of on the order of 1-10³ reactions per second per cubic centimeter for a Dicke factor of unity, depending on how large the molecular state fraction is assumed to be. A Dicke factor in the range of 10⁸-10¹² is thought to be well within the range of what is possible from these kinds of models, leading to total reaction rate estimates in line with observations. We note that the occurrence of large Dicke factors would be associated with random bursts of anomalous products, in qualitative agreement with the large majority of observations. We note that variations in levels of products have been observed at the level of roughly three orders of magnitude in the case of heat production (limited by detector capabilities), and on the order of six orders of magnitude in association with tritium and fast particle production. If we interpret these observations in terms of Dicke bursts, the associated Dicke numbers seen to date are as large as 10⁶, consistent with models of the type described here.

The basic conjecture here is that if we assume that the models under discussion work largely in the coherent limit as described here, then the quantitative results of the models appear to be qualitatively in agreement with a great many observations of anomalies in metal deuterides. If the relevant dephasing is fast and Golden Rule rates apply, then this model gives rates that are sufficiently slow as to be unobservable. We have devoted some work to the problem of dephasing in this quantum system. The basic observation is that the compact states are pretty tough to interact with (especially the spin zero states, which do not even have a magnetic interaction) other than through the couplings described here which are very fast. Once a coherence has been established, it seems that there are good reasons that it might be maintained, even with the destruction of individual molecular states and even with diffusion effects included. The basic argument is that on average, there remains very nearly the same total number of molecular state deuterons in a mesoscopic or macroscopic volume of metal deuteride. Moreover, if phase interruptions occur, there are on average always a similar number of other molecular state species that have the requisite phase relation with the compact states and helium states, since we assume that only a subset of the molecular states are involved at any given time. Future work will shed light on this conjecture.

The premise of the initial formulation, which posits that nuclear reactions in a lattice should include the lattice at the outset, is a very solid physical statement. Over the years, we have attempted to study systematically the models that arise as a consequence of this initial physical statement. In the course of the work, we have been able to explore many aspects of the models, and to understand aspects of many of the physics issues that the new models raise. We have found that many features of a great many experiments can be understood in terms of the model, and that there has begun to be established a predictive capability in association with the model. The model has only improved over the last five years with each improvement of the associated physics, modeling or sophistication. This was not true of a very large number of previous models, and this has convinced us that much of it is correct in detail. As we have outlined, there are uncertainties within the different parts of the model that we expect to be resolved in time.

Nevertheless, the predictions of the model as to what is required for the development of excess heat in metal deuterides and in mixed metal deuterides and hydrides is pretty clear. Molecular state D₂ within the metal lattice is required (or HD in the case of the p+d reactions), the more the better. Strong excitation of at least one phonon mode that produces motion of interstitial helium at the level of on the order of 100 fm or greater appears to follow from the phonon exchange calculations in order to produce stable compact states. Helium is required in order to increase the reaction rate (⁴He for the d+d reactions and ³He for the p+d reactions). There needs to be on the order of at least 10 compact state and helium species present within a phonon coherence domain in order to exchange energy efficiently between the nuclear and phononic degrees of freedom. Devices that satisfy these constraints are predicted within this model to produce energy. The inventions described in this patent then follow from the requirements of the model, and in large part are supported by a wide range of experimental observations that pertain to one piece or another of the physics under consideration.

### DESCRIPTION OF EMBODIMENTS

The accompanying figures best illustrate the details of the apparatus, system, and method for implementing the present invention. Like reference numbers and designations in these figures refer to like elements.

In an embodiment the above process is implemented to create a vacancy-enhanced metal lattice structure. More specifically, there is an introduction of hydrogen. Metal hydrides have long been sought as vehicles to contain hydrogen for storage and shipment. The advantages of storing hydrogen in a metal lattice rather than using high pressures and or low temperatures to compress (in the limit, to liquefy) hydrogen gas are: improved volumetric storage efficiency, increased safety, potentially lower costs, the convenience of working with small or intermediate sized devices. Metal hydrides also are sources of intrinsically pure hydrogen and in many applications gas stored in this way can be used without further purification.

High purity hydrogen is increasingly being used in a range of chemical processes from semiconductor fabrication to the preparation of fine metal powders. Increasing attention also is being focused on hydrogen fuel cells and hydrogen internal combustion engines as means to reduce the rate of carbon dioxide emission accompanying power generation both stationary electrical and motive. Both technologies (fuel cell and hydrogen internal combustion) are undergoing rapid development to meet this need. Both developments are far in advance of what is needed for concomitant hydrogen storage.

Recognizing this need, various industries and governmental agencies are working rapidly to: identify a pathway to establish an industrial hydrogen infrastructure; establish scientific programs to develop new materials and means for hydrogen storage; develop a hydrogen feedstock strategy.

A great deal of effort has been devoted to the production of suitable metallic alloys for the storage of hydrogen. These systems are usually relatively expensive multi-component alloys. In addition to the issue of cost, these alloys have relatively low gravimetric storage capacities, typically 1-2 wt. %, and suffer mechanical damage on repeated cycling, which destroys the system integrity. More recently, the hydrogen storage properties of a number of carbon materials have been investigated. Although impressive storage capacities have been claimed in some cases, these values were obtained only at high pressure (in excess of 100 atm.). In addition, elevated temperatures are required for hydrogen desorption.

In selecting a material suitable for hydrogen storage several issues are paramount: high volumetric and/or gravimetric hydrogen storage ability (capacity); the facility to store and release hydrogen at rates compatible with or in excess of the demand cycle (dynamics); the ability to withstand large numbers of cycles and high rates of cycling without important degradation of material (durability); the ability to absorb and release hydrogen on demand, with relatively small changes in temperature and/or pressure conditions in the vicinity of the desired operation point; low cost; low toxicity; intrinsically high safety margins.

These constraints effectively rule out all known metals and alloys in the phases in which they normally are found. An alternative approach is suggested from the work of Fukai in which extremely high pressures and temperatures were used to produce a high vacancy phase of Mo, Ni, Pd and other fcc (face centered cubic) metals, in which the vacancies were stabilized by the presence of absorbed hydrogen at very high chemical potential. The experiment conducted by Fukai as noted above is incorporated herein by reference. Fukai Y. and N. Okama, Formation of superabundant vacancies in Pd hydride under high pressures. Phys. Rev. Lett., 1994, Vol. 73, p. 1640.

The important properties of the “Fukai” phase are:
1) High hydrogen storage capacity (in excess of atomic ratio 1:1 with the host lattice) because of the existence of a high vacancy content.
2) Thermodynamic stabilization of the high vacancy and high hydrogen content as these act together to form a new, thermodynamically more stable phase.
3) Enhanced mobility of hydrogen in the defect-rich lattice phase.

These advantages make possible the conversion of relatively cheap, safe, non-toxic metals (such as Ni) that are kinetically poor hydrogen storage materials in their normal phase, into highly dynamic, high efficiency hydrogen storage materials. However, the means employed by Fukai to accomplish this end is not practical in commercial application since it requires the use of high temperatures for periods extended sufficiently for metal vacancy diffusion (many hours or days) at pressures of hydrogen attainable only at two or three highly specialized facilities in the world.

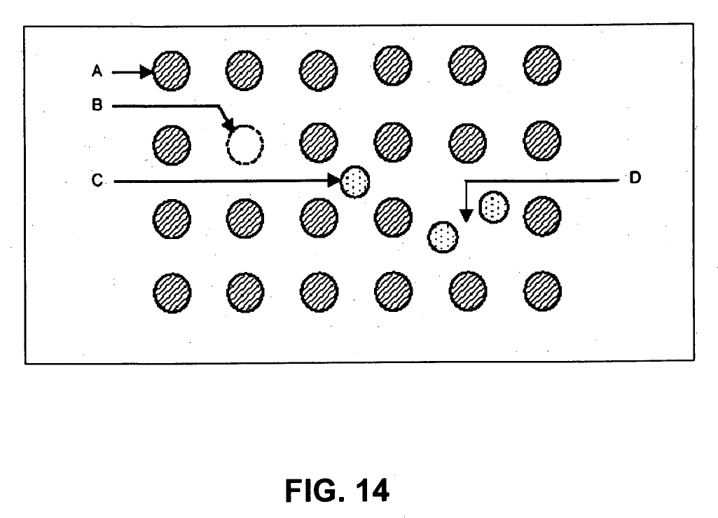

This embodiment of the invention can be used to produce a vacancy-stabilized metal hydride phase suitable for use as a hydrogen storage element FIGS. 14-16 illustrate in more detail this embodiment of the present invention. More specifically, FIG. 14 illustrates a vacancy stabilized, enhanced hydrogen storage material. A represents a metal atom arranged in a regular lattice structure and B represents a vacancy (missing metal atom and/or atoms) induced in the regular lattice structure. C is the hydrogen atom that hydrogen atom occupying the interstitial space D between metal atoms in the regular lattice structure.

It is contemplated by the invention that more than one hydrogen atom C can accumulate within the vacancies B. The presence of the hydrogen C stabilizes the vacancy and produces an enhanced hydrogen storage material.

FIG. 15 illustrates hydrogen loading of the bulk metal A. In FIG. 15 the metal A includes a regular array of metal atoms. Hydrogen atoms C are induced to enter the bulk metal A from an external hydrogen source F. Once the metal has been loaded, the metal is irradiated. FIG. 16 illustrates the irradiation of the metal after it has been loaded. FIG. 16 illustrates the irradiation of the metal after it has been loaded. In FIG. 16, the bulk metal A is irradiated with an irradiation beam I. The irradiation beam I is made up of particles (e.g. electrons) of sufficient energy to create vacancies B in the bulk metal. Time or temperature can also be used to achieve the desired result of creating a vacancy enhanced host lattice structure. Hydrogen atoms C loaded into bulk the metal A enter the vacancies B and stabilize them.

This method works for both hydrogen and deuterium. For chemical energy applications hydrogen would be preferred; for nuclear energy applications deuterium or a mixture of deuterium and hydrogen would be preferred. Electron beam irradiation of metals leads to the formation of vacancies as lattice metal atoms are imparted energy and momentum to move from their normally ordered sites. In the absence of hydrogen the limiting concentration of vacancies formed this way is only on the order of 0.1% to 0.2% as such vacancies tend to “heal” from a state of high lattice energy. In the absence of vacancies, however, hydrogen has little mobility in most metal lattices. Noted exceptions are Fe and Pd at room temperature, and Nb, Ta, V, etc. at temperatures in excess of 200° C. For these metals, in the regimes of temperature specified, direct formation of vacancy enhanced, high hydrogen phases can be achieved by pre-loading the metals with hydrogen and then subsequent electron beam irradiation. In general it is necessary to treat metals alternately or simultaneously to hydrogen and electron beam exposures in order to produce significant volumes of vacancy enhanced high hydrogen storage metals.

The temperature and pressure of hydrogen treatments must be calculated metal-by-metal from the known coefficients of hydrogen diffusion in these metals. Electron beam irradiation at relatively high flux is required for periods of minutes or hours in initial materials treatment to produce the desired phase. The irradiation dosage should be of order 10¹⁷/cm² or higher, using electron energies in the range 0.1-5 MeV. Higher energies should be avoided so as not to induce radioactivity in the metal. A concentration of 0.25% up to 25% of vacancies in a host lattice structure can be achieved.

Vacancy stabilized enhanced hydrogen storage materials can be used with advantage over existing metal, carbon and compressed hydrogen storage methods in all applications where hydrogen presently is used or produced:
1) Chemical industry—e.g., organic hydrogenation/de-hydrogenation, chemical reductions, metal cleaning, production of fine metal powders, corrosion control, semiconductor processing.
2) Electric power generation—e.g., stationary and utility power generation via hydrogen internal combustion engines or fuel cells, motive power (either electric hybrid or internal combustion) in automobiles, fleet vehicles, locomotives or ships.
3) Portable power—e.g., used in conjunction with small fuel cells for portable computers, instrumentation, displays, communication devices, power tools.

There are also several important points that should be noted with regard to the advantages of this embodiment of the present invention:
1) The presence of vacancies in a metal enhances the hydrogen storage capability and the hydrogen storage and release rates.
2) The presence of hydrogen stabilizes the vacancy content at levels far greater than normally occurs.
3) By tailoring the thermodynamics of the structure we can create phases that can be activated to absorb and release H₂ by small changes in physical condition around the desired operating point.
4) The pre-existence of stabilized vacancies can effectively stabilize the composite metal structure against further materials degradation.
5) Using this method we can turn cheap, convenient, familiar, safe materials that presently are thermodynamically or kinetically limited in their ability to store hydrogen into hydrogen storage materials with properties superior to known materials.

The methods of fabrication are the same as can be used to form the heat producing elements in the nuclear applications, without the need for: helium seeding, surface sealing, phonon stimulation. Also, H₂ can be used instead of D₂.

In another embodiment of the present invention, adding helium to a vacancy enhanced hydrogen and/or deuterium storage material produces another novel material with additional utility. More specifically, a helium-seeded, vacancy enhanced, hydrogen and/or deuterium loaded lattice is critical to the embodiment of the energy release method described in the patent.

Helium can be introduced into the lattice before, after or during the hydrogen loading and vacancy creation steps, but practical considerations suggest that it is easiest and most effective to load helium into the lattice before hydrogen loading and vacancy creation. Helium can be loaded into the lattice via several methods, including:
1. Making the host lattice material in the presence of a helium atmosphere
2. Helium diffusion at elevated temperatures (as discussed in the patent)
3. Helium ion implantation (as discussed in the patent)

Given that there is 5.5 ppm (parts per million) helium in the atmosphere, an atomic density of 10⁻¹⁰ to 10⁻⁸ helium atoms occur naturally in most metals. When most metals are made the concentration of helium is not controlled and will exist in trace amounts. Thus, the advantage of the present invention is that the helium concentration in the host lattice structure is controlled. The result is material that has an atomic density of helium 10⁻⁷ or higher; but preferably on the order of 10⁻⁵. (To be clear, an atomic density of 10⁻⁵ means that there is 1 helium atom for every 100,000 atoms of the host lattice)

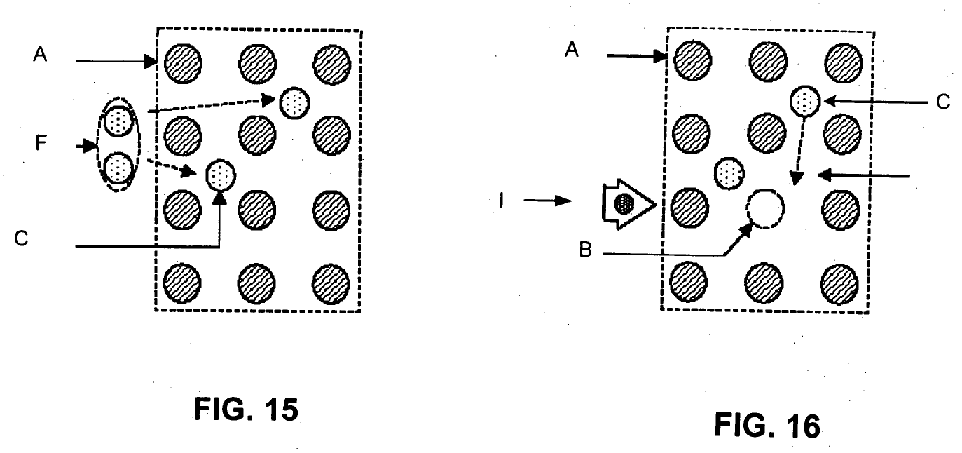

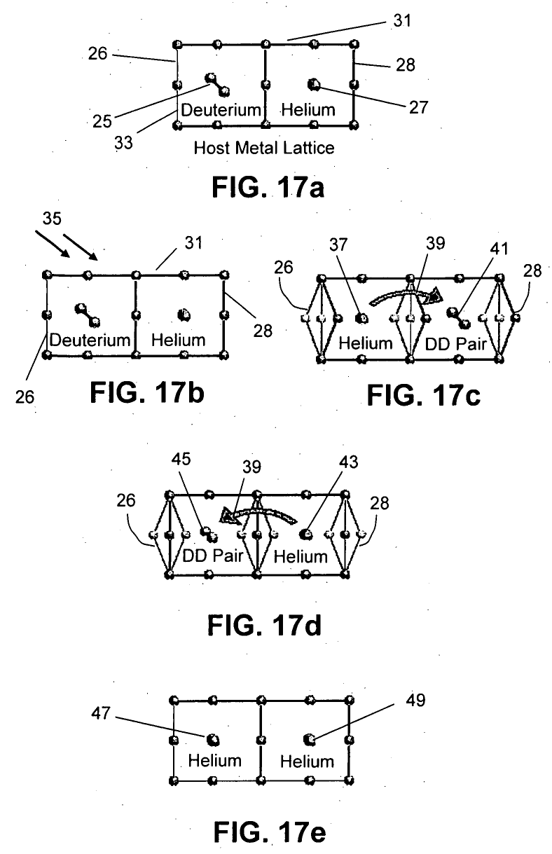

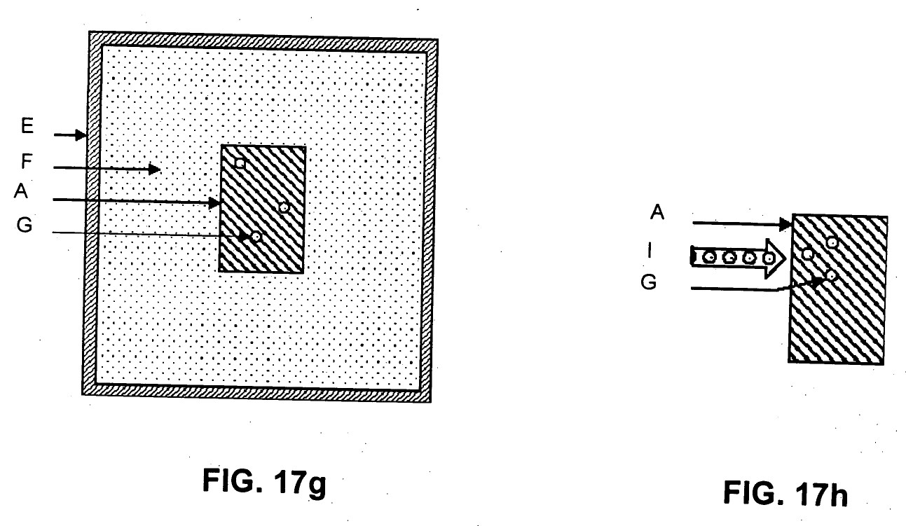

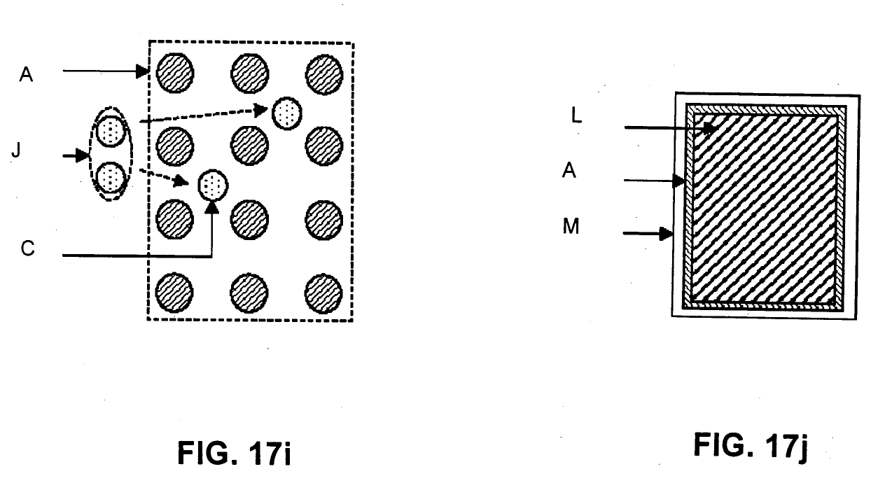

FIG. 17a-17e illustrates energy being created in a metal deuteride in accordance with an embodiment of the present invention. In FIG. 17a, deuterium (D₂) 25 and helium (⁴He) 27 are loaded into the interstitial sites 26, 28 in the atomic lattice of the host metal structure 31. Vacancies 33 in the atomic lattice provide sufficient room for molecular deuterium to form.

It is contemplated by the invention that the host metal structure includes the use of metals such as, but not limited to, Pd, Ni, Pt, Rh, Ru, Ti, Nb, V, Ta, W, Hf, Zr, Mo, U, Sc, Mn, Co, Zn, Y, Zr, Cd, Ag, Sn and other alloy and composite materials.

By way of example if Pd is used, the Pd is of high purity (but not the highest) in the range of 99.5%-99.9% with a diameter of 50-125 μm and a length of 3-30 cm.

Helium-4 (⁴He) is introduced into the Pd lattice to atomic ratio one part in 10⁵. The levels of ⁴He normally found in Pd are approximately 10¹⁰ atoms per cm³ (˜1 atom in 10¹³ or 8 orders of magnitude less than the preferred value). Examples of obtaining the desired concentration of ⁴He into the Pd contemplated by the invention are as follows:
1) High temperature diffusion—FIG. 17g illustrates a pressure vessel E capable of maintaining a helium atmosphere F at and elevated temperature. Diffusion of helium in fcc metals is an activated process with activation energy ˜0.5-1.0 eV. For Pd sufficient diffusion can be achieved in the range 500-950° C. depending on wire microstructure and dimension. F illustrates the helium atmosphere (helium-4 for D+D, Helium-3 for H+D reactions). A represents the bulk metal. Helium atoms G diffuse into the bulk metal. Helium preloading can be attained by exposing the wire to helium gas at elevated temperature in a pressure vessel. The condition of pressure, temperature and time must be adjusted for each metal lot and diameter; and
2) Helium ion implantation—A known quantity of ⁴He atoms can be implanted at known depth below the Pd surface by varying the ion current, time and energy of an ionized helium beam. FIG. 17h, illustrates the helium pre-seeding, helium ion implantation. In FIG. 17h . the bulk metal A is being ionized by the beam I. As a result the helium atoms G are implanted into the bulk metal.

The average loading of deuterium in Pd is ≧0.85. FIG. 17i illustrates the loading of bulk metal A. In FIG. 17i, deuterium, hydrogen or a mixed source J is introduced and then the deuterium and/or hydrogen C atoms are induced to enter the bulk metal A. Deuterium and/or hydrogen loading can be achieved to high levels via known electrochemical techniques. The preferred means to obtain such loading is by electrochemical reduction of heavy water (D₂O) or deuterated alcohol (e.g. CD₃OD, CH₃OD, C₂D₅OD, C₂H₅OD) at a Pd wire cathode. Electrochemical loading of the deuterium into the Pd can be accomplished as follows:
1) Using electrolysis at near ambient temperatures in an electrolyte that includes the use of strontium sulfate (SrSO₄) dissolved in high purity D₂O (resistivity >10 MΩ cm) to concentration 10⁻⁵ M. It may be necessary to vary the cathodic current density in the range 10≦i≦250mA cm⁻² in order to achieve a maximum D/Pd loading determined as a minimum in the resistance of the PdD structure measured in the axial direction; and
2) The use of deuterated alcohol is substituted for D₂O in procedure 1. Alcohol electrolytes offer two advantages: a) they are more easily purified (e.g. by distillation) and contain lower concentrations of cations deleterious to loading; and b) because of their lower freezing point, electrolysis temperatures can be reduced which thermodynamically favors attainment of the high loading state. At lower temperatures and substantially lower electrolyte conductivities, the kinetic of the loading process and accessible range of cathodic current densities, are much less in alcohol electrolytes than in aqueous. As for “1”, however, current densities must be adjusted while monitoring the loading in order to achieve the maximum loading state.

To attain the needed high chemical potential of deuterium it is necessary to take more than usual care in the avoidance of impurities derived from the electrolyte, the anode, the cell walls, or the ancillary hardware used in the electrochemical loading process. Materials found suitable and compatible with the attainment of needed levels of loading are Pt, Teflon®, quartz, Pyrex® and the like. Each of these materials must be scrupulously cleaned before use. Because avoidance of impurities cannot be assured, the electrolyte purity inevitably degrades with time of electrolysis. Loading is thus constrained by two opposite rate processes: 1) radial diffusion of D atoms into the Pd lattice from a state of high electrochemical potential at the electrochemically active surface; 2) and contamination of that surface by discharge of species dissolved or suspended in the electrolyte. As an important consequence, the condition of maximum loading is transient. Thus, it is contemplated by the invention that there is monitoring of the D/Pd loading in order to judge the appropriate transition time between this process step, and the next. An example of monitoring the loading is by using four terminal resistance measurement.

Contamination of the Pd surface that is deleterious to loading also is inevitable during fabrication, shipping, pretreatment and mounting in the electrochemical cell. Contamination is eliminated before undertaking the electrochemical loading by surface cleaning and pretreatment. An example of decontaminating the Pd surface is passing current at high current density axially along the wire. The current density should be calculated or adjusted to be sufficient to raise the temperature of the Pd wire to dull red heat (600-800° C.). Only a few seconds of this treatment and no repetition are necessary to completely remove deleterious species from the Pd electro-active surface and effect a favorable recrystallization of the bulk.

It is contemplated by the invention that immediately upon attainment of the desired maximum loading condition, the system must be stabilized by blocking egress of D atoms from the PdD surface. Examples of methods of sealing the PdD surface contemplated by the invention are as follows:
1) Forming a surface of amalgam on the PdD surface by adding 10⁻⁵M mercurous sulfate (Hg₂SO₄) to the electrolyte. FIG. 17j illustrates the sealing of host lattice structure L. In FIG. 17j, the loaded metal deuteride and/or metal hydride is coated with a thin layer (e.g. mercury) A designed to prevent the recombination of deuterium atoms at the surface of the metal deuteride; this prevents the egress of the deuterium. Optionally, a coating of a different material M (e.g. silver) better suited for handling long-term storage of the metal deuteride can be used. Examples of other materials used for sealing include Pb, Cd, Sn, Bi, Sb and at least one of anions of sulfite, sulfate, nitrate, chloride and perchlorate. Using the sealing surface, mercury ions are rapidly reduced to atoms on the cathode surface, effectively poisoning D−D atom recombination and thus preventing D atoms leaving the Pd host as D₂ molecules. This step is most effectively accomplished by monitoring the PdD axial resistance to ensure that the resistivity does not rise (signaling loss of D) following cessation of the impressed cathodic current.
2) Transferring the electrode directly into liquid nitrogen. The diffusion coefficient of D in PdD is reduced sufficiently at 77K to effect a kinetic stability to the structure for periods of hours or days depending on electrode radial dimension.

It is also contemplated by the invention that the number of vacancies available in the metal host can be enhanced. For example, enhancing the vacancies in a PdD host metal can be accomplished by subjecting the metal to radiation damage thus imparting kinetic energy and motion to lattice Pd atoms. In principle, any radiation of sufficient intensity may be used for this purpose, for example, an electron beam irradiation. In order to preserve the deuterium atomic loading during shipment and while samples undergo electron beam irradiation loaded wires should be maintained at liquid nitrogen temperatures (77K) or below.

In FIG. 17b, an optical phonon field 35 is applied to the host lattice structure 31. The optical phonon field 35 operates to couple reactants at the different sites 26, 28 and initiating a resonant reaction to occur in the host lattice structure 31.

The phonon field is applied to the host lattice 31 by use of a stimulation source. The host lattice structure 31 can be stimulated to demonstrate effects of heat generation via nuclear reaction (D+D) and production of helium (⁴He). Stimulation involves exciting appropriate modes of lattice phonon vibrations. A number of methods are available to provide such stimulation to the host lattice structure. For example, stimulation to the host lattice structure can be achieved by fluxing of lattice deuterium atoms across steep gradients of chemical potential (the electrochemical mode); fluxing of electrons at high current density (the “Coehn” effect); intense acoustic stimulation (“sono-fusion”); lattice fracture (“fracto-fusion”); or superficial laser stimulation (“laser-fusion”). It is contemplated by the invention that the stimulation of the host lattice structure can also be effectively stimulated by the following: 1) surface stimulation with a red laser diode in the range of wavelength with surface power intensity >3 W cm⁻²; 2) beating laser; 3) surface stimulation with lasers in the Terahertz frequency range; 4) axial current stimulation using both direct and alternating currents (dc and ac) and current pulses, at current densities greater than 10⁵ A cm⁻².

In FIG. 17c, at one site 26, molecular deuterium 25 fuses into another helium 37 thereby releasing energy 39 into the lattice structure 31. At the other site 28, the helium 27 dissociate to form a deuteron pair 41 of lower energy within the site 28. Some of the energy release from the molecular transformations is lost to the metal lattice 31 and appears as heat energy.

In FIG. 17d, the cycle discussed in FIG. 9a-9c repeats itself. The deuterium pair 41 created in one site 28, reverts back to helium 43 thereby injecting energy 39 into the host lattice structure 31. This addition of energy 39 causes the helium atom 37 in the other site 26 to dissociate into a deuterium pair 45 of lower energy. Again some of the energy created as a result of the molecular transformations is lost to the metal lattice 31 and appears as heat.

FIG. 17e illustrates that after many oscillations of the process discussed above in FIGS. 17a-17d, the system returns to rest. At rest, the original deuterium molecule 25 has been converted into a helium atom 47. Similarly, the original helium atom 27 has been converted into a helium atom 49. There is a 23.8 MeV of energy has been absorbed by the host lattice structure 10.

The demonstration of the effect is a measurement of a temperature rise in the prepared metal host. For example a measurement of the temperature rise in a Pd metal host structure. Such measurements can be made in a number of ways, either calorimetrically (measuring the system total heat flux) or simply by monitoring the local temperature rise. Although demonstration of the effect is more easily made by observing a local temperature rise in response to the stimulus, other examples of demonstrating the effect of the energy process contemplated by the invention are as follows:
1) Contactless optical imaging of the metal host temperature as it responds to the chosen means of stimulation. Temperature resolution better than 0.1 ° C. is readily available in thermal imaging systems and can provide easy and reliable demonstration of the effect.
2) Surface contact thermometry using low mass (low heat capacity) micro thermistors or thermocouples;
3) Axial Resistance Measurements. Once the temperature coefficient of resistance of the host metal structure is known with certainty, measurement of a resistance rise in the total wire length or monitored section can be used indirectly to indicate a rise in average temperature. This method of temperature monitoring is probably best employed in conjunction with methods “1” or “2” as it is an indirect but averaging measurement. After demonstration of the heat effect wire samples should be removed, sectioned, and subjected to analysis for ³He and ⁴He in the metal phase. A high sensitivity and high resolution mass spectrometer can be used for this purpose. Any indication that ⁴He levels have increased or that the ³He/⁴He ratio has changed from it's natural value can be used to demonstrate that a nuclear process has occurred in the lattice.

### Testing And Results Using Pd

The following is an example of an experiment used to confirm the effectiveness of the reaction process noted above. Project Cobalt Experiment 3A was done to execute an experimental program designed around the “best practices” of making and using the invention. Project Cobalt determined that the ideal program would involve the optimization of multiple parameters as given below:
Composition of the metal substrate;
Rate, temperature, and power of the electrolytic loading of deuterium in the metal substrate (load cycle);
Rate, temperature, and power of the electrolytic stimulation of the loaded metal deuteride (run cycle);
Composition of the metal co-deposited during stimulation of the loaded MeD;
Use of additional stimuli including:
   Electrical co-deposition;
   Laser impingement on the metal deuteride;
   Stationary magnetic field;
   Alternated electrolytic current.
      Experiment 3A had the following configuration:
Thin foil Palladium (Pd) cathode, ˜1 cm² (total area, front+back);
Loaded for 15 days+10 hours under the following conditions:
   Held in an uncontrolled ˜12° C. environment;
   Electrolyzed at a constant 50 mA in a 1M LiOD+D₂O solution;
   Placed in a 750 Gauss stationary magnetic field;
Run for 13 days+9 hours under the following conditions:
   Held in a controlled 40° C. environment;
   Electrolyzed at a constant 6.9 Watts;
   Placed in a 750 Gauss stationary magnetic field 180° out of phase with the loading cycle;
Thin foil Gold (Au) secondary anode, ˜0.5 cm²;
Additional stimuli had the following configurations:
   90.1 mA (˜30mW) Laser power, with frequency from 677 nm to 683 nm;

±200 mW alternated current.

TABLE 1
Schedule of Additional Stimuli

| Stimulation | Day 1 | Days 2-3 | Days 4-6 | Days 7-9 | Days 10-13 |
|---|---|---|---|---|---|
| Laser | | 6 hrs on | 6 hrs on | 6 hrs on | |
| Impingement | | 6 hrs off | 6 hrs off | 6 hrs off | |
| | | Freq sweep | Freq sweep | Freq sweep | |
| Metal Co- | | | 10 min on | 720 min on | |
| deposition | | | 350 min off | 720 min off | |
| | | | | 50% duty cycle | |
| Alternated | | | | | 720 min on |
| Current | | | | | 720 min off |
| | | | | | 50% duty cycle |

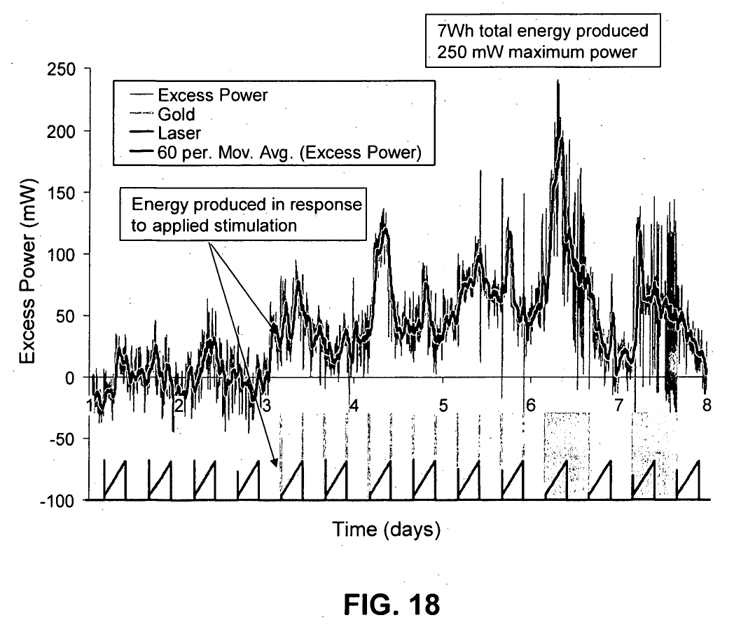

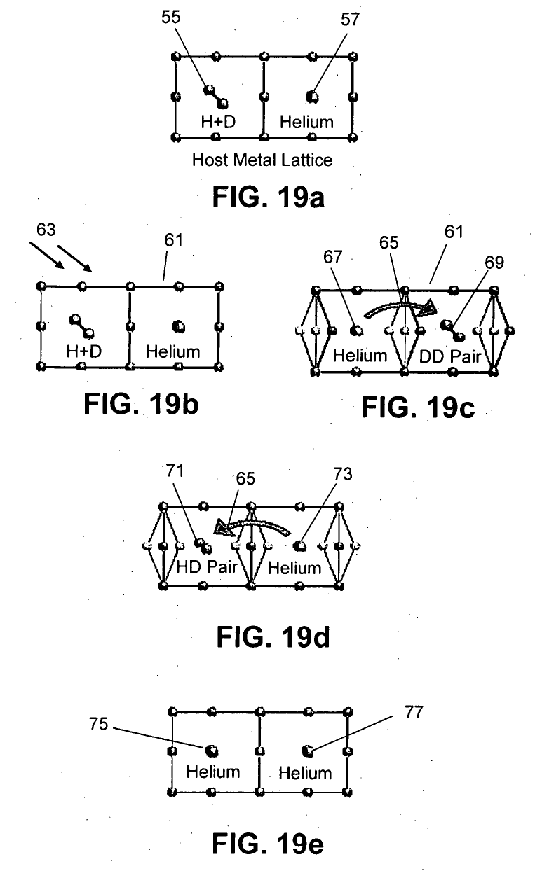

The conclusions of the results were that the experiment with Pd yielded between 50 mW and 240 mW of excess power starting on day 4 (Nov. 29, 2002) and continuing through day 9 (Dec. 4, 2002) in correlation with the metal co-deposition and laser stimulation. Given that the volume of the cathode was 0.00875 cc, the maximum power density was approximately 28 W/cc. This output compares favorably with uranium fission, which produces approximately 50 W/cc. The total amount of excess energy produced, calculated by integrating the instantaneous excess power, yielded 7Wh. The experiment was terminated when the electrical characteristics of the cell exceeded an arbitrarily determined control threshold. FIG. 18, is chart that more clearly illustrates the excess power that resulted from the above experiment, as discussed above. FIGS. 19a-19e illustrate another reaction processes in accordance with the present invention. The reaction process in FIGS. 19a-19e are essentially identical to the reaction processes in FIGS. 17a-17e except for the introduction of hydrogen. Only the differences between these two processes will be discussed in detail. In FIG. 19a, Hydrogen and Deuterium (HD) 55 and helium (³He) 57 are loaded into the interstitial sites in the atomic lattice of the host metal 61. Vacancies in the atomic lattice provide sufficient room for H+D molecules to form. In FIG. 19b an optical phonon field 63 is applied, coupling reactants at different sites and initiating the resonant reaction. In FIG. 19c at one site, the molecular deuterium fuses into helium 67, releasing energy 65 into the lattice. At another site, helium dissociates into a closely born hydrogen-deuterium pair (HD pair) 69. Some energy is lost to the metal lattice and appears as heat. In FIG. 19d, the cycle repeats itself. The HD pair reverts to helium 73, injecting energy 65 into the lattice, which causes a helium atom to dissociate into an HD pair 71 of lower energy at another site. Again, some energy is lost to the metal lattice and appears as heat. Finally, in FIG. 19e after many oscillations, the system returns to rest. The original hydrogen-deuterium molecule 55 has been converted into a helium-3 atom 75. The 5.5 MeV energy difference between these particles has been absorbed by the host metal lattice.

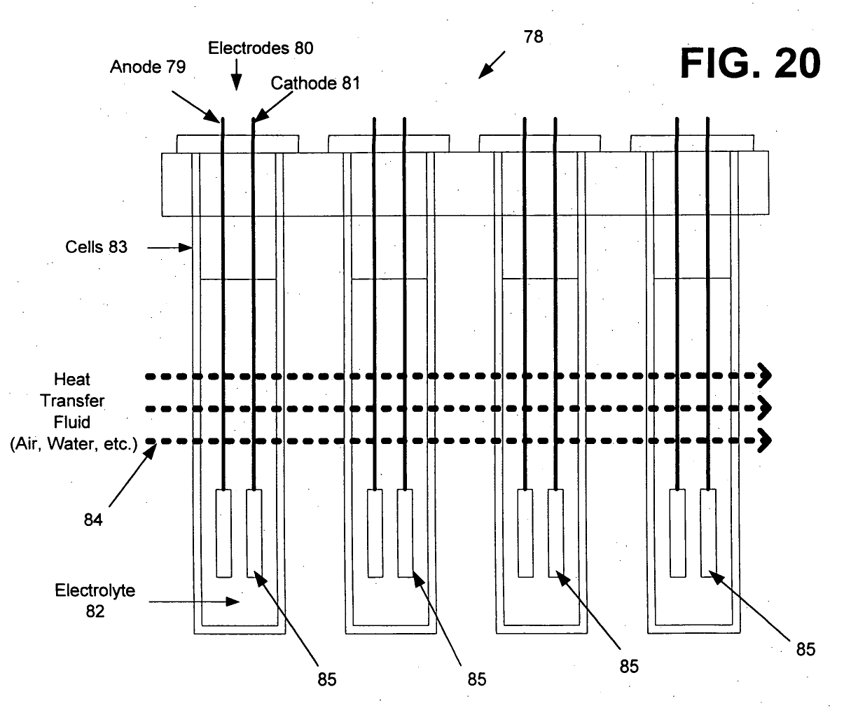

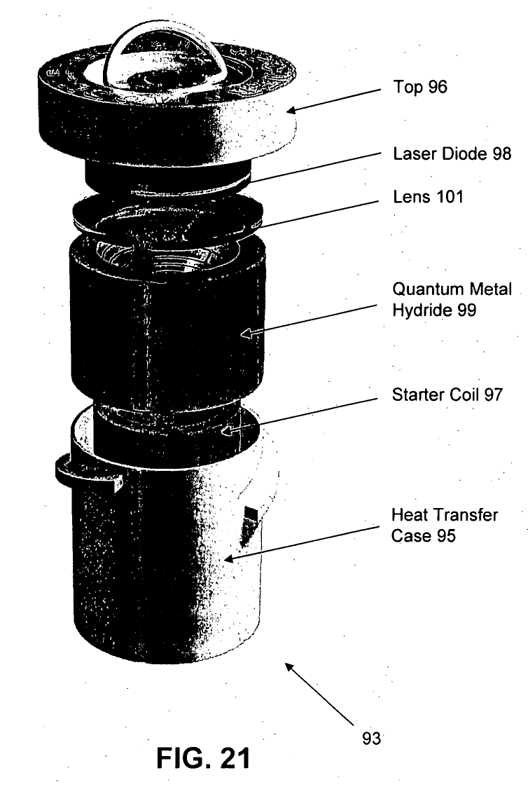

FIGS. 20-23 illustrates practical application of the processes noted in FIGS. 17 & 19 in accordance with the present invention that incorporates the use of metal deuteride in an electrochemical cell-based heating element. In FIG. 20, the electrochemical cell-based heating element 78 is shown. The element 78, includes several cells 83 that can operate individually or in conjunction. The cells 83 take the form of “fingers.” Each cell 83 of the electrochemical cell-based heating element 78 has electrodes 80 that extend the length of each cell 83 and are immersed in an electrolyte 82. The cells 83 can be designed to run above or below the boiling point of water. The electrolyte 82 in conjunction with the anode 79 and cathode 81 stimulate the molecular transformation of the metal deuteride used in the construction of each cell 83. It is contemplated by the invention that the metal deuteride 85 is used in the cathode 81 portion of the electrodes 80 for each cell 83. Thus, upon heating, the molecular transformations described in FIGS. 17a-17e and 19a-19e occur in the metal deuteride 85 of each cell body 83 of the heating element 78, which heats the cell body 83. The heat energy that is created from the molecular transformation is extracted from the cells 83 by immersing the cells 83 into a heat transfer fluid 84. The heat from the each cell 83 is then transferred to the fluid 84. It is contemplated by the invention the electrochemical embodiment could be used in various industrial, commercial and residential heating that require anywhere from 50° C.-150° C. applications. For example, applications could include, but are not limited to, water heating, desalinization (e.g., distillation), industrial processes, and refrigeration (e.g., heat pumps). FIG. 21, illustrates an embodiment of the invention that incorporates the metal deuteride in a dry cell. FIG. 21, the dry cell 93 can be operated individually of in conjunction will other dry cells. FIG. 21, shows an expanded version of the dry cell 93, but in a fully assembled configuration the dry cell 93 takes the form of a “plug” i.e., when the top 96 is fastened to the heat transfer case 95. The starter coil 97 is an electric heating element used to bring the dry cell to correct operating temperature. Power to the starter coil 97 is removed when the correct operating temperature for the dry cell 93 is reached. The dry cell 93 is solid state, and uses electromagnetic radiation (e.g., visible or infrared, terahertz source or the like) to generate optical phonons in the quantum metal hydride. For example, in FIG. 21, the laser diode 98 in conjunction with the lens 101 provide the stimulation to the quantum metal hydride 99 of the dry cell 93. The stimulation of the metal hydride causes molecular transformations in the quantum metal hydride 99, as described in FIGS. 17a-17e & 19a-19e. The heat energy that results from the molecular transformations is absorbed by the heat transfer case 95. The heat is extracted from the heat transfer case by immersing the plug in a heat transfer medium such as liquid or gas. It is contemplated by the invention the dry cell could be used in various distributed power generation applications that require anywhere from 150° C.-250° C. For example, applications could include, but are not limited to, a steam engine (e.g., Watt engine) or a Stirling engine.

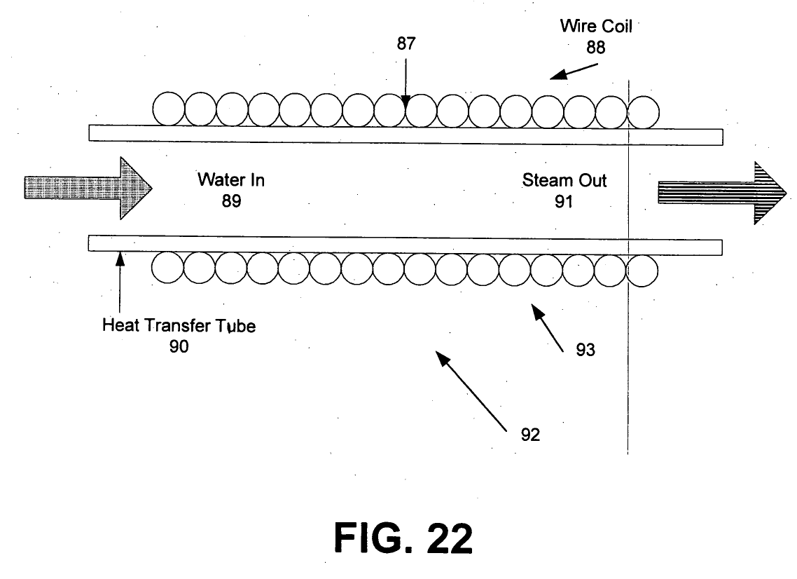

FIG. 22, illustrates an embodiment of the invention that incorporates the metal deuteride in a flash heating tube. In FIG. 22, the flash heating tube 92 is used to produce high quality steam. More specifically, a wire coil 88 consisting of a loaded metal deuteride, is stimulated by applied current that is passed through the coil 88. The current can be AC or DC, as long as the current is sufficient to cause the required molecular transformations to occur in the metal deuteride 87 described in FIGS. 17a-17e and 19a-19e. The heat energy that is created as a result of the molecular transformations is absorbed by the heat transfer tube 90. Water 89 is passed through one end of the heat transfer tube 90. As the water 89 travels through the heated tube 90, the water temperature rises until the water 89 flashes to steam 91 at the other end of the tube 90. It is contemplated by the invention the flash heating tube embodiment could be used in various centralized power generation applications that require temperatures of 250° C.-500° C. For example, applications could include, but are not limited to, conventional electric utility applications (e.g., alternative to fossil fuel, gas or nuclear power sources).

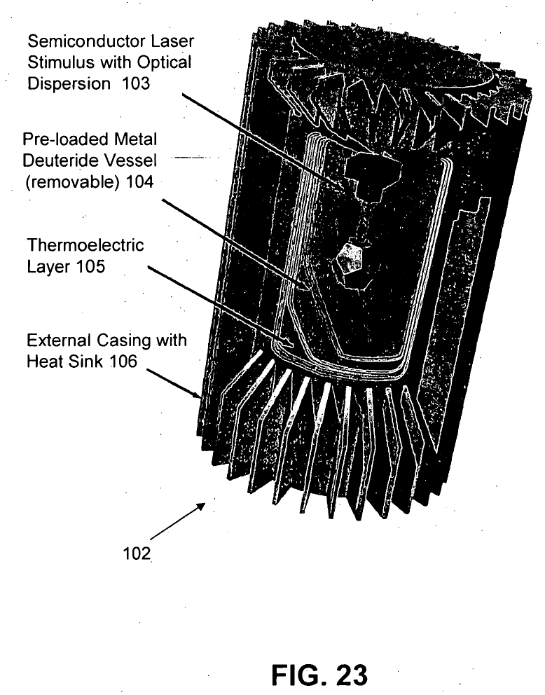

FIG. 23, illustrates an embodiment of the invention that incorporates the metal deuteride in a thermoelectric battery. In FIG. 23, the thermoelectric battery 102 is a solid-state device that generates electricity directly from the heat produced. The thermoelectric battery 102 unit includes two layers: 1) a loaded metal deuteride layer and a thermal-to-electric layer. For example, in FIG. 23 the metal deuteride layer 104 is loaded into an internal metal vessel. The thermoelectric layer 105 encompasses the vessel. The stimulation source is a semiconductor laser stimulus 103 with optical dispersion such as, but not limited to, a laser diode or direct terahertz source. The stimulation source 103 energizes the inside layer (i.e. the metal deuteride layer) to create the optical phonons necessary for the reaction described in FIGS. 17a-17e & 19a-19e. Electricity is produced by maintaining a temperature differential between the inside vessel and the external casing 105. (e.g., cooling fins, or immersion in a coolant will likely improve the efficiency of the device.) This device could generate a constant stream of electricity for a very long time, revolutionizing the way energy is produced and used and is the ultimate product vision. Because of the tremendous energy density of the process described, this device can be very useful even if the efficiency of the thermal-to-electric conversion is low. It also contemplated that the thermoelectric battery embodiment could be used in energy applications requiring temperatures of 500° C.-1000° C. Examples of the applications include, but are not limited to, direct conversion of hear to electricity through traditional or novel semiconductor technology; batteries that enable long lasting and massive distribution of energy (e.g., self powered devices); and applications ranging from portable electronics devices to transportation

### Further Exemplary Embodiments With Materials Comprising Molecular Deuterium And Molecular Hydrogen-Deuterium

As explained elsewhere herein, increasing the amount of molecular deuterium (referred to herein as “D₂”) or molecular hydrogen-deuterium (referred to herein as “HD”) in host materials can be beneficial for promoting nuclear reactions within the host. For example, if two deuterons are to interact, such as described elsewhere herein, the interaction probability can be higher when the deuterons are in a molecular D₂ state as compared to when they occupy neighboring sites in a metal deuteride. Similarly, if hydrogen and deuterium are to interact, such as described elsewhere herein, the interaction probability can be higher when the hydrogen and deuterium are in a molecular HD state. Further exemplary embodiments utilizing materials that facilitate the presence of D₂ and HD will now be described.

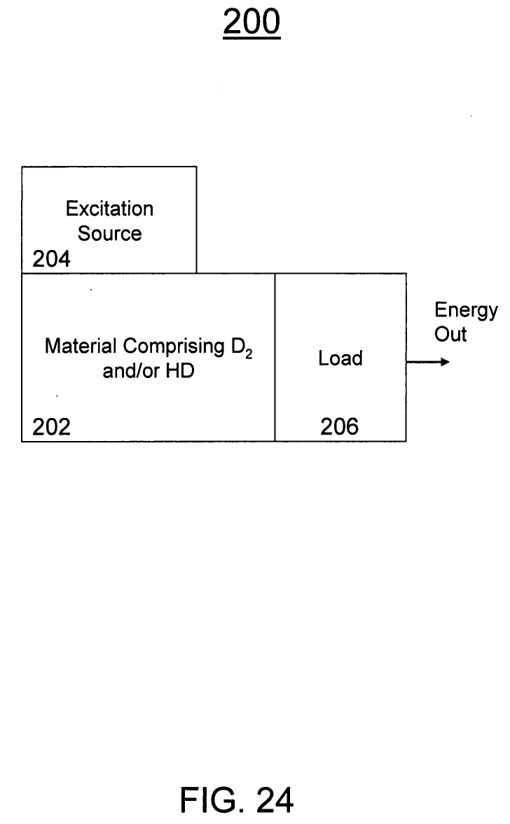

According to an exemplary embodiment, an apparatus 200 shown in block diagram form in FIG. 24 comprises a material 202 that comprises molecular deuterium (D₂) and/or hydrogen-deuterium (HD), and reactions are stimulated in this material 202. In this regard, the presence of both D₂ and HD in the material 202 is contemplated, but it is also possible be appreciated that primarily either D₂ or HD may be present in the material 202, e.g., if the material is processed and maintained at sufficiently low temperature to thwart transformations between D₂, HD and H₂. The presence of H₂ in the material is also generally likely and is not precluded. The apparatus 200 also comprises an excitation source 204 arranged to stimulate the material 202 to generate reactions in the material 202, and a load 206 arranged to remove energy generated by the reactions from the material 202. The apparatus can be configured in practice in a variety of ways, such as shown, for example, in the above-described electrochemical cell example of FIG. 20, the dry cell example of FIG. 21, the flash heating tube example of FIG. 22, and the thermoelectric battery example of FIG. 23. In view of those examples, it will be appreciated that the excitation source 204 and the load 206 may or may not be in direct physical contact with the material 202. Also, materials 85, 99, 88, and 104 referred to in FIGS. 20, 21, 22, and 23, respectively, can correspond to material 202 shown in FIG. 24.

The excitation source 204 can be, for example, an electromagnetic-radiation source for irradiating with electromagnetic radiation (e.g., a laser source or other optical source), a transducer (e.g., a piezoelectric device or quartz crystal with suitable electrodes such that application of an appropriate current causes a mechanical displacement such as vibrational motion, or any suitable transducer not limited to electrically driven transducers that can impart mechanical displacement to the material), an electrical power source (e.g., DC or AC source for applying electrical current to the material), a particle source (e.g., for irradiating the material with particles such as electrons or ions), or a heater (e.g., a resistive heater or a radiative heater), or any other suitable excitation source for supplying energy to the material such as described elsewhere herein. Combinations of the excitation sources such as those described above, can also be used. It can also be beneficial to apply such stimulation in a modulated fashion (e.g., periodic or non-periodic dynamic fashion) as it is believed that modulations of such stimulation can facilitate coupling to acoustic phonons in the material 202, thereby facilitating generation of the nuclear reactions. For example, periodic modulations can be on the order of the range of frequencies of such acoustic phonons. As with other embodiments disclosed herein, stimulation can also occur by the fluxing of hydrogen or deuterium atoms or molecules across a concentration gradient. A concentration gradient can be established, for example, by suitably controlling the chemical environment of the material 202.

The load 206 can be, for example, a heat exchanger, e.g., one or more cells such as cells 83 which transfer heat to a heat transfer fluids as shown in the electrochemical cell example of FIG. 20, a heat transfer tube such as heat transfer tube 90 shown in the flash heating tube example of FIG. 22, or a heat transfer case such as heat transfer case 95 shown in the thermoelectric battery example shown in FIG. 23, or a combination thereof. The load 206 can also be, for example, a thermoelectric device, e.g., a thermoelectric layer such as thermoelectric layer 105 shown in the thermoelectric battery example of FIG. 23, a thermionic device, or a thermal diode, or a transducer that generates electrical energy from mechanical displacement such as vibrational motion, for example. The load 206 can also be, for example, an absorber that can absorb thermal radiation emitted by the material 202 in a heating application or, for example, a photovoltaic (e.g., photodiode) that generates electricity in response to absorbed thermal radiation. Also, considering that energy can be released from the material 202 in the form of particle emission (e.g., electrons) in some instances, the load 206 can also be any suitable high-impedance, low-current electrical load. It will be appreciated that the mechanical configurations of the materials 85, 99, 88 and 104 shown in FIGS. 20-23 can be modified in suitable manners to accommodate the mechanical properties of the particular material being used. For example, if the material comprising D₂ and/or HD is a semiconductor, it is not necessary to configure the material 88 shown in FIG. 22 as a coil. Rather, the material 88 could be configured in length-wise strips electrically connected end to end to surround and provide heating to the tube. Various other modifications will be readily apparent to those of ordinary skill in the art in this regard.

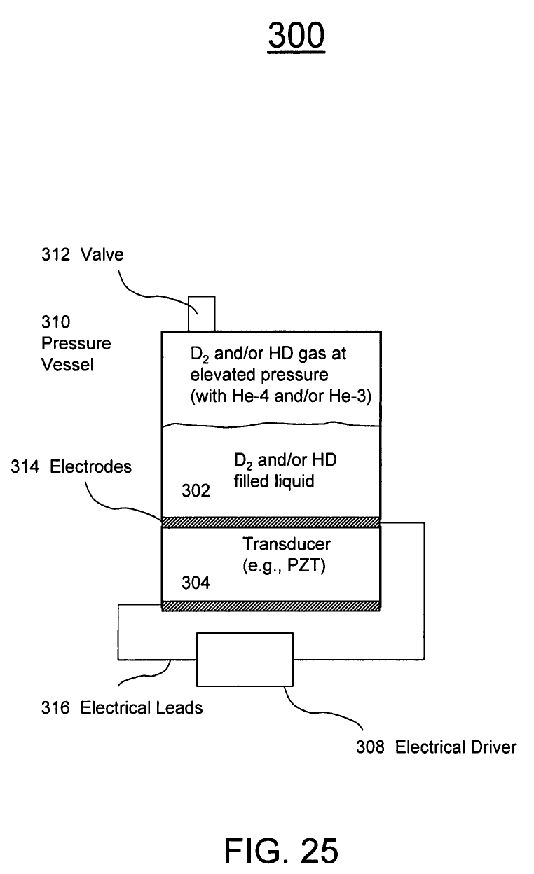

While the excitation source 204 and the load 206 are shown as separate features in the block diagram, it should be understood that those features can share a common device or devices in some instances, e.g., both devices can share the same transducer that generates vibrational motion from applied electrical energy and that generates output energy from vibrational motion generated by reactions, in some examples. In such examples, including those described further below in connection with FIGS. 25-27, a transducer can be initially powered with electrical energy to apply vibrational energy to the material 202 to initiate the nuclear reactions (through phonon coupling to the reactions). Upon initiation of the reactions, the electrical power to the transducer can be turned off, and the transducer can then operate to generate electrical energy from vibrational motion of the material 202 coupled into the transducer, wherein the vibrational motion (e.g., due to highly excited phonon modes) of the material 202 is generated from the nuclear reactions occurring therein. This electrical energy can then be drawn off for use in a suitable electrical load as desired.

In one aspect the material 202 can comprise an isotopic variant of a dihydrogen transition metal complex with a substitution by at least one of D₂ and HD (the presence of HD relates to the case of the proton-deuteron pathway as described elsewhere herein). Measurements by researchers indicate that the separations between protons in H₂ present in transition-metal complexes are close to the separation between protons in free H₂ (e.g., as reported in G. J. Kubas, Metal Dihydrogen and σ-Bond Complexes). Similarly, the separations between deuterons in D₂ present in such transitional metal compounds are expected to be close to the separation between deuterons in free D₂ (the same is expected to be true in the case of HD). Thus, the interaction probability between two deuterons, or between hydrogen and deuterium, is expected to be significant in these materials.

Exemplary materials in this regard include (using the short hand chemical notation conventional for such materials as used in G. J. Kubas, Metal Dihydrogen and σ-Bond Complexes) W(D₂)(CO)₃(PH₃)₂, Cr(CO)₃(P/Pr₃)₂(D₂), Mo(CO)(dppe)₂(D₂), W(CO)₃(P/Pr₃)₂(D₂), FeH(D₂)(PEtPh₂)₃, [RuH(H₂)(dppe)₂]⁺, Cr(CO)₃P₂(D₂), Mo(CO)₃P₂(D₂), trans-[Mo(CO)₂(PCy₃)₂D₂] and trans-[W(CO)₂(PCy₃)₂D₂], as well as corresponding materials in this list wherein “HD” is substituted for “D₂”, as well as complexes that contain both D₂ and HD. Such materials can be fabricated by methods known in the art for fabricating dihydrogen transition-metal complexes, such as disclosed, for example, in Chapter Three (“Synthesis and General Properties of Dihydrogen Complexes”) of G. J. Kubas, Metal Dihydrogen and σ-Bond Complexes, with appropriate processing in the presence of D₂ and HD gas, as discussed below.

For example, it is known that a commercially available zero valence Mo compound, Mo(CO)₃(C₇H₈), where (C₇H₈)=cycloheptatriene, can be reacted with 2PCy₃ (where Cy=cyclohexyl) in benzene or toluene under a hydrogen atmosphere to produce trans-[Mo(CO)₂(PCy₃)₂H₂], which precipitates out as yellow microcrystals with a yield of 60-70%, within 2-3 hours. In this compound, H₂ is readily lost at room temperature, and the material must be stored under a hydrogen atmosphere. Similarly, it is believed that trans-[Mo(CO)₂(PCy₃)₂D₂] can be prepared in similar manner wherein the reaction is carried out in D₂ gas instead of H₂ gas.

As another example, it is known that a commercially available compound, W(CO)₃(C₇H₈) (where (C₇H₈)=cycloheptatriene) can be reacted with 2PCy₃ in bezene or toluene in a hydrogen atmosphere to make trans-[W(CO)₂(PCy₃)₂H₂], which precipitates out also as yellow microcrystals. This compound is reported as being more stable than the above-described molybdenum compound, but its stability may be enhanced by storing it in a hydrogen atmosphere. Similarly, it is believed that trans-[W(CO)₂(PCy₃)₂D₂] can be prepared in similar manner wherein the reaction is carried out in D₂ gas instead of H₂ gas. In a paper by G. J. Kubas et al., J. Am. Chem. Soc., 106, 451 (1984), the authors reported a yield of 85-95% for this synthesis in 1 atmosphere H₂, and further reported observations of spectra from complexes with isotopic substitutions of D₂ and HD for H₂.

Thus, in general, it is believed that synthesis approaches of basic metal dihydrogen metal complexes can be modified by using D₂ and HD gas atmospheres in place of solely H₂ atmospheres to thereby generate suitable dihydrogen transition metal complexes with a substitution by D₂ and/or HD. Such materials can be stable at room temperature. In this regard, those of ordinary skill in the art will understand that a reference to D2 and HD gas refers to a mixture of D₂, HD, and H₂ gases considering the dynamic transformations that normally occur between these forms.

It will be appreciated that preparations of such materials can be facilitated by adjusting (e.g., increasing) the temperature during processing to facilitate the reactions. Also, such materials can be prepared by starting with dihydrogen transition metal complexes at the outset and then heating these at elevated temperature and pressure in D₂ gas, wherein substitutions of H₂ in the complexes by D₂ and HD can occur.

In another aspect, the material 202 can comprise a fullerene-based material. A fullerene-based material as referred to herein includes a material comprising any of various cage-like, hollow molecules that include hexagonal and pentagonal groups of atoms including, e.g., those formed from carbon, and which may include additional species of atoms as part of the cage structures, within the cage structures, or between the cage structures of adjacent molecules. Also included within the scope of such materials are those that also include atomic arrangements other than hexagonal and pentagonal groups. Non-limiting examples include Buckyballs (e.g., C₆₀ or similar molecules with a different number of atoms), carbon nanotubes (either closed-ended or open-ended), and the like.

Other non-limiting examples included with the scope of fullerene-based materials include the above-described materials in solution, incorporated into a solid such as a polymer matrix or incorporated into a solid formed of a compacted mixture of fullerene powder with another suitable powder, which can act as a binder. As discussed below, fullerene materials can be processed to incorporate D₂ and/or HD prior to incorporation in a solid or a liquid. The loading with D₂ and/or HD can be enhanced with appropriate sealing of the material such as described elsewhere herein (such sealing is generally applicable to the materials disclosed herein) and/or by maintaining such materials in an atmosphere of D₂ and HD.

Encapsulation of H₂ and inert gases in fullerenes is known in the art. For example, rare gases have been encapsulated in fullerenes at low yield by heating the fullerenes in the rare gas atmosphere, such as described in R. J. Cross and M. Sanders, Fullerenes—Fullerenes for the New Millennium, Electrochemical Society Proceedings, Volume 2001-11, 298. Rare gases have been encapsulated in fullerenes by acceleration of rare gas atoms into stationary fullerenes. In the latter case, the atom could slip through the cage with sufficient noble gas atom velocity, and be encapsulated with significantly higher yield. The encapsulation of ³He and ⁴He has been reported through this method. Methods to purify fullerenes with encapsulated atoms are discussed, for example, in Chapter 12, “Encapsulation of an atom into C₆₀ cage,” by Y. Kubozono, in Endofullerenes, A New Family of Carbon Clusters, edited by T. Akasaka and S. Nagase, Kluwer Academic Publishers, Dordrecht (2002).

More recently, molecular hydrogen has been inserted into an open-cage fullerene derivative as reported by Y. Murata et al., J. Am. Chem. Soc. 125, p. 7152 (2003), which also reported gas phase generation of H₂ in C₆₀. Synthesis of an open-cage C₆₀ structure (a C₆₀ molecule with an opening therein which facilitates insertion of other species into the molecule) is discussed in G. Schick et al., Angew. Chem., International Edition, 38, 2360 (1999). Briefly, the open cage structure was synthesized by reacting C₆₀ with diazidobutadiene at 55 degrees C. for four days. Murata et al. reported the insertion of H₂ into such an open-cage structure by exposing a powder made of the open-cage fullerene to 800 atmospheres of H₂ at 200 degrees C. in an autoclave for 8 hours, at also at lower pressures of 560 atmospheres, and 180 atmospheres with lower yields. No loss of H₂ from the open-cage structure in a solution was observed at room temperature over 3 months, and the observation of H₂ release was observed at 160 C and above.

In a similar manner, it is believed that D₂ and/or HD can be inserted into an open-cage fullerene structure by preparing an open-cage fullerene as discussed above and by heating such a powder at elevated pressure in an autoclave in the presence of D₂ and HD gas. Further, as noted in Murata et al. referred to above, the open cage structure can then be closed to provide closed encapsulation of the inserted species by using laser irradiation. Moreover, such a powder could also be processed as described above to include small amounts of ⁴He and/or ³He or in order to reduce the time to achieve a significant nuclear reaction rate (the utility of including ⁴He or ³He in conjunction with D₂ or HD to facilitate nuclear reactions is described elsewhere herein). Alternatively, a small amount of fullerene powder containing fullerenes that have been inserted with ⁴He and/or ³He could be mixed with a fullerene powder that has been inserted with D₂ and/or HD, and the resulting mixture could be utilized in a solid or liquid material containing such fullerenes.

Also, for example, fullerenes have been made into solid structures through a variety of methods, such as described in Chapter 14, “Structures of Fullerene-Based Solids,” by K.

Prassides and S. Margadonna, in Fullerenes: Chemistry, Physics, and Technology, edited by K. M. Kadish and R. S. Ruoff, Wiley-Interscience, New York (2000). Crystalline powders of C₆₀ have been found by others based on x-ray diffraction to form random collections of hcp and 30 fcc lattice structures formed of nearly spherical fullerenes with interstitial spaces. Thus, previously encapsulated fullerenes having D₂ and/or HD inserted therein prepared such as described above can be formed into fullerides and other fullerene-based solid materials for use as the material 202 shown in FIG. 24. To the extent that D₂ and/or HD may escape such fullerene cages, this D₂ and/or HD could be replenished by heating such material in the presence of D₂ and HD gas at elevated temperature and pressure. Also, intercalated fullerides are known, in which various atoms are placed into the interstices, which can lead to interesting physical effects such as superconductivity (as has been observed in alkali fullerides). It is believed that such materials can be produced with D₂ and/or HD inserted therein by heating such material in the presence of D₂ and HD gas at elevated temperature and pressure for use as the material 202 in FIG. 24. Polymerized fullerenes/fullerides are also known and have increased stability at elevated temperature. It is believed that such materials can be produced with D₂ and/or HD inserted therein by heating such material in the presence of D₂ and HD gas at elevated temperature and pressure, which would be useful as material 202 in the case of D₂ and/or HD encapsulated materials for excess heat generation and other applications which for one reason or another are advantageously carried out at higher temperatures. Heterofullerenes, in which one or more carbon atoms in a fullerene are substituted with another species of atom, are also known and can be stable at very high pressures, and it is believed that such materials can be produced with D₂ and/or HD inserted therein by heating such material in the presence of D₂ and HD gas at elevated temperature and pressure for use as material 202.

In another aspect, the material 202 can comprise a semiconductor material or an insulator. The use of hydrogen as a passivating material in semiconductors, such as silicon and GaAs, for example, is well known. Theoretical studies indicate that hydrogen in GaAs should form molecular H₂ in tetrahedral sites, which are deep wells for the molecular state (L. Pavesi et al., Phys. Rev. B 46, 4621 (1992)), and that hydrogen in silicon should form molecular H₂ in Si (P. Deak, et al., Phys. Rev. B 37, 6887 (1988); and C. G. Van de Walle, et al., Phys. Rev. B 39, 10791 (1989)). It is believed that such semiconductor materials (e.g., Si and GaAs) can also be produced with D₂ and/or HD therein by heating such material in the presence of D₂ and HD gas at elevated temperature and pressure, which would be useful as material 202. Also, it is believed that insulators (e.g., such as NaCl, CaF₂, CaO, MgF₂, and MgO and other ionic crystals) can be prepared with deuterium therein (as well as with He-3 and/or He-4) by heating those materials in the presence of elevated pressures of D₂ and HD gas in an autoclave as described elsewhere herein.

In another aspect, the material comprising D₂ and/or HD can comprise a liquid. FIG. 24 is applicable to such an embodiment (in which case the material 202 would be contained within a suitable vessel, e.g., made of stainless steel, glass, etc.). For purposes of illustration, a further example of such an apparatus 300 is shown in the block diagram of FIG. 25. As shown in FIG. 25, the apparatus 300 comprises a liquid material 302 comprising D₂ and/or HD. The material 302 is contained within a pressure vessel 310 having a valve 312 to allow adding and maintaining D₂ and HD gas at elevated pressure for the purpose of driving D₂ and/or HD into the liquid material 302. The elevated pressure can be, for example, above atmospheric pressure, such as about 1-5 atm with standard vacuum components and above about 5 atm to 100 atm with special purpose components, or at higher pressures, e.g., up to 1000 atm with specialized high pressure components. The valve 312 is also used to add the liquid material 302. The liquid material 302 is contained below the gas at elevated pressure. The apparatus 300 also comprises a transducer 304 such as described elsewhere herein (e.g., a piezoelectric transducer such as lead-zirconate-titanate-PZT- or a quartz crystal), and an electrical driver 308 to apply electrical energy to the transducer 304 via electrical leads 316 and electrodes 314 to generate vibrational motion of the transducer, which is then coupled to the liquid material 302 via a contacting surface between the vessel 310 and the transducer 304 (e.g., at the top electrode 314). The frequency of the electrical driver 308 can be chosen to drive transducer 304 at a resonant frequency of the combined system, which can be identified through straightforward measurements as known to those of ordinary skill in the art, and which can be tailored as known to those of ordinary skill according to the sizes of the components. As illustrated in FIG. 25, some ⁴He and/or ³He gas can also be introduced into the vessel 310 to cause ⁴He and/or ³He to enter the liquid material 302. Suitable amounts of D₂ and/or HD can be, for example, 1-10 parts per thousand by number, or greater, and suitable amounts of ⁴He and/or ³He in equivalent sites can be, for example, 1-10 parts per million by number. Exemplary liquids that can be used include water, hydrocarbon oils, benzene, toluene, and ethyl alcohol, to name a few.

The apparatus 300 can be operated in a manner such as already described above. In particular, a transducer can be initially powered with electrical energy to apply vibrational energy to the material 302 to initiate the nuclear reactions (through phonon coupling to the reactions). Upon initiation of the reactions, the electrical power to the transducer can be turned off, and the transducer can then operate to generate electrical energy from vibrational motion of the material 302 coupled into the transducer 304, wherein the vibrational motion of the material 302 is generated from the nuclear reactions occurring therein. This electrical energy can then be drawn off the electrodes 314 for use in a suitable electrical load as desired. In this aspect, it will be appreciated that the D₂ and/or HD resides in a condensed matter environment that supports acoustic modes, or more generally acceleration, in which a highly excited system can interact with nuclei. Such modes can include, for example, a highly excited acoustic mode, a hybrid acoustic and electrical oscillation mode associated with the combination of an oscillator circuit coupled to transducer 304 (e.g., piezoelectric material) and material 302, or a rotational mode.

While the transducer 304 carries out dual roles in this example (i.e., stimulating the material 302 initially and serving as a load/converter for withdrawing/generating useful electrical energy), it should be understood that a separate excitation source such as described in connection with FIG. 24 could be used to stimulate the material 302.

In connection with this embodiment, it will be appreciated that molecular hydrogen gas is known to go into many liquids with a significant solubility, and the same is expected for D₂ and/or HD. As noted above, D₂ and/or HD can be driven into the liquid 302 by the pressure of the D₂ and HD gas above the liquid 302. Another approach is to generate the gas, if desired, through electrolysis of species in the liquid and maintain by adjusting the gas pressure to desired levels. Yet another approach is to generate the gas by chemical reactions within the liquid.

In another aspect, the material 202 can comprise at least one of D₂ in condensed form and HD in condensed form at low temperature. In this regard, “D₂ in condensed form” (for example) as used herein refers to D₂ that has been condensed to form a solid or liquid itself, either with or without being combined in a mixture with another species, and similarly for HD. For example, such material could be substantially uniform liquid or solid D₂, substantially uniform liquid or solid HD, a mixture of the same, or any of these possibilities in a mixture with another condensable species such as argon. It is contemplated that that the amount of condensed D₂ and/or HD could be one-half or more of the total mixture by weight in such a mixture. Low temperature in this regard refers to a temperature sufficiently low that such condensation can occur. Those of ordinary skill will appreciate that molecular hydrogen condenses into a liquid at approximately −259 degrees C. at standard pressure and solidifies at approximately −262 degrees C. at standard pressure, and that D₂ and/or HD will similarly condense in approximately the same temperature regime. Thus, this example is primarily applicable to embodiments such as direct coupling of vibrational motion into electrical energy (e.g., electricity) rather than to embodiments for generating heat. In such an example, the apparatus 200, or at least a portion containing the material 202 can be suitably insulated and cooled using conventional approaches (e.g., helium refrigeration of a support member arranged in a vacuum environment provided by a suitable vacuum chamber).

In connection with this embodiment, it will be noted, for example, that argon saturated with hydrogen can be cooled slowly to produce solidified material containing molecular hydrogen (see, e.g., Kriegler et al., Can. J. Phys. 46, 1181 (1968)). It is believed that such mixtures of inert gases with D₂ and/or HD can similarly be condensed and utilized as described above.

As described elsewhere herein, the reactions can comprise at least one of transformations between D₂ and He-4 and transformations between HD and He-3.

### Further Exemplary Embodiments Relating To Direct Conversation of Reaction-Generated Vibrations To Electrical And Electromagnetic Energy

As will be apparent from the discussion above, one way of generating electricity from nuclear reactions in materials is to convert excess heat to electricity using thermoelectric converters, Stirling engines, or other types of engines. Such scenarios contemplate a technology in which heat is produced at elevated temperatures, perhaps between 250 C and 1000 C, and then converted to electricity by whichever conversion technology is most convenient or cost efficient. The requirement for an energy conversion step after the initial energy production can be significant, in the sense that the resulting technology may be complicated, and losses are expected. For example, in the case of electricity production, the efficiency of small scale solid state thermal to electric converters is not high, and unused heat must be dissipated. In what follows, further embodiments for the direct conversion of vibrational motion generated by nuclear reactions in materials to electrical energy are described, which build upon the discussion presented in connection with FIG. 25.

As described herein phonon exchange can occur in association with a nuclear reaction process. It follows directly that when two or more phonons are exchanged in reactions at different sites with a common phonon mode, they can be coupled quantum mechanically, and proceed as a second-order or higher-order process. In this framework, the energy from the nuclear reactions appears initially in the highly excited phonon mode, with the possibility of excitation of other thermal modes as well. Excess heat comes about in this picture in association with loss mechanisms of the highly excited phonon mode. In other words, energy from reactions is expected to be coupled into highly excited phonon modes primarily, and the degradation of the highly-excited mode energy into thermal energy is a subsequent effect.

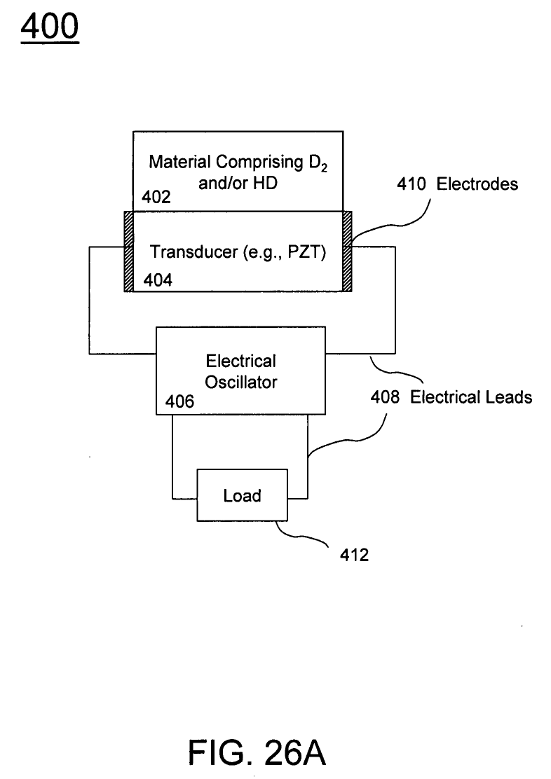

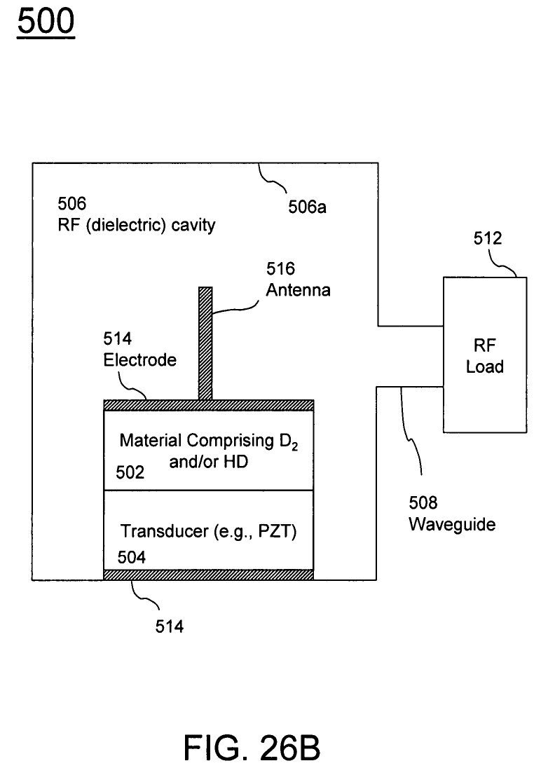

According to one embodiment, an apparatus 400 can be configured as shown in the block diagram of FIG. 26A. The apparatus, comprises a material 402 comprising deuterium and can be any of the materials described elsewhere herein such as, for example, a dihydrogen transition metal complex with a substitution by D₂ and/or HD, a semiconductor material, a metal, a liquid or an insulator. An insulator or a refractory metal such as Ti, Nb or Ta can be useful materials for the material 402 because these materials can have relatively sharp vibrational resonances (high quality factors or “Q” factors), which can aid in reducing losses that would be manifested as heat. In one aspect, the material 402 comprises deuterium in the form molecular deuterium (D₂) and/or molecular hydrogen-deuterium (HD). It is believed that insulators (e.g., such as NaCl, CaF₂, CaO, MgF₂, and MgO and other ionic crystals) can be prepared with deuterium therein (as well as with He-3 and/or He-4) by heating those materials in the presence of elevated pressures of D₂ and HD gas in an autoclave as described elsewhere herein.

The apparatus also comprises an excitation source arranged to stimulate the material 402 to generate reactions in the material 402, wherein the reactions generate vibrational motion of the material 402. In the example of FIG. 26A, the excitation source comprises the combination of an electrical oscillator 406 (e.g., an LC circuit of such as conventionally known to those of ordinary skill in the art) and a transducer 404 which are connected via electrical leads 408, and in this role, the transducer 404 can be viewed as an input transducer (“input” being a convenient label) because it inputs vibrational energy into the material 402 to initiate nuclear reactions when energized by the electrical oscillator and an associated power source (not shown). The transducer 404 can be, for example, a piezoelectric crystal or quartz crystal. Instead of using the transducer 404 to provide “input” energy to initiate reactions, however, the excitation source can alternatively comprise an electromagnetic-radiation source, an electrical power source (e.g., to apply AC or DC current), a particle source, or a heater, such as described earlier. In either case, the transducer 404 can also be viewed as an output transducer (“output” being a convenient label), which is coupled to the material 402 and which generates electrical energy from the vibrational motion of the material 402 caused by the reactions occurring therein. Thus, as with other embodiments disclosed herein, an input transducer and an output transducer, such as a piezoelectric crystal, can be the same device.

Operation of the apparatus involves stimulating the material 402 as discussed above to cause nuclear reactions in the material 402, wherein the reactions generate vibrational motion of the material 402. The vibrational motion is coupled from the material 402 to the transducer 404, which generates electrical energy from the vibrational motion of the material 402. In this regard, the vibrational motion is coupled directly to the transducer 404, which directly generates electrical energy (e.g., electrical current) from the vibrational motion, without the need for an intermediate process, such as conversion of heat to electrical energy as would occur with use of a thermoelectric device, for example. The electrical energy (e.g., electrical current) output from the transducer 404 can be coupled to an electrical device e.g., electrical load 412, via the oscillator 406 and electrical leads 408.

The electrical load can be, for example, an output circuit (e.g., that converts high frequency AC current to a lower frequency current or DC current) in combination with an electrical device to be powered. As with other embodiments herein, it can be desirable to configure the system, e.g., the oscillator 406 and/or a suitable output circuit, to provide electrical power output at 50-60 Hz.

As with other embodiments disclosed herein, preferably, the material 402 contains a significant amount of D₂ and/or HD (for example, 1-10 parts per thousand by number, or greater), and some smaller amount of ⁴He and/or ³He in equivalent sites (1-10 parts per million, or greater, for example). Exemplary frequencies for driving and operating the apparatus 400 (the overall system) are between about 1 Hz and about 1 GHz, with relatively lower frequency operation occurring between about 1 Hz and about 1 kHz and relatively higher frequency operation occurring between about 1 kHz and about 1 GHz. As will be understood by those of ordinary skill in the art, the frequency response of the transducer 404 and the frequency response of the oscillator 406 can be tailored to achieve an overall desired frequency response, e.g., so that operation on or near a resonance can be achieved, if desired, e.g., the response of the transducer 404/material 402 and the response of the oscillator can be substantially matched. In this way, a low order coupled transducer/material mode is driven on resonance. For example, a high-Q quartz crystal can be used as the transducer 404 and can be driven in the MHz range, with the quartz crystal being on the order of a millimeter thick, and with the sample being on the order of 100 microns thick. Lateral dimensions of the quartz crystal and sample can be on the same order, respectively. In the case of a liquid material 402 (e.g., liquid D₂ or liquid mixture containing D₂ suitably cooled in a suitable vessel), exemplary volumes can be on the order of about 1 cm³. Optimization so that operation can occur at about 50 Hz, 60 Hz or in the range of 50-60 Hz can be beneficial.

A highly-excited phonon mode in this case can be a hybrid electrical/phononic mode that is made up of the combination of a low-order phonon mode in the transducer 404 and material 402, and of the resonant electrical oscillator 406. Nuclear energy from the solid state reactions would go initially into this highly excited hybrid mode, which will sustain the mode if the overall Q is sufficiently high. Energy in this hybrid mode will thermalize through mechanical losses into heat in the sample, and through electrical losses into resistive losses in the electrical oscillator 406.

A low-resistance electrical load 412 can be coupled to the hybrid electrical-mechanical oscillator as shown in FIG. 26A, which can be used to extract electrical energy directly from the coupled nuclear and hybrid system. As the resistance of the load 412 is increased, it will dissipate a larger fraction of the total energy produced, and can be made to dominate the energy loss. If the loss is made too large, then it would be expected to drive the excitation level down, and ultimately the reaction would be extinguished. In other variations, the electrical oscillator 406 could be replaced with a conventional output circuit to transform the alternating current output from the transducer 404 into a DC current, for example, which current can then be used to drive a desired load 412.

Another example is illustrated in FIG. 26B, which illustrates an apparatus 500 for conversion of reaction energy to electromagnetic energy. The apparatus 500 comprises a radio frequency (RF) or microwave cavity 506 having a conductive wall 506a and includes a material 502 comprising deuterium (e.g., as D₂ and/or HD) and also an amount of amount of ⁴He and/or ³He as discussed above. The material 502 is coupled (e.g., in contact) with a transducer 504 (e.g., a piezoelectric crystal or quartz crystal). Electrodes 514 are placed at opposing surfaces of the material 502 and the transducer 504. An antenna 516 is connected to one of the electrodes 514. One electrode 514 of the transducer 504 is connected to an inner surface of the wall 506a of the cavity 506, and the antenna 516, which is coupled to another electrode 514, accesses the interior electric field of the cavity 506. The cavity 506 is coupled to an RF or microwave load 512 via a waveguide 508. It will be appreciated that both electrodes 514 could be placed on the transducer 504 instead of placing one electrode 514 on the material 502. In either case, the cavity 506 is coupled to the transducer 504.

In this example, the material 502 can be stimulated by any suitable excitation source such as previously disclosed herein or by an RF or microwave driver circuit (not shown) coupled to the cavity 506 by another waveguide (not shown). In either case, the material 502 is stimulated to promote nuclear reactions therein such as described earlier, and energy from the nuclear reactions is coupled into into a variety of hybrid modes, wherein one component of the mode is mechanical such that it produces acceleration of the deuterium in the material 502. With such an hybrid mode, it is possible to utilize the transducer to couple mechanical and electromagnetic degrees of freedom.

In this example, the cavity 506 can be a high-Q RF or microwave cavity, which is coupled to a resonant high-Q combination of the transducer 504 and material 502. In this regard, the material 502 can be a high-Q solid material such as those mentioned above in connection with FIG. 26A. Excitation of the cavity 506 to power levels high enough to generate sufficient voltage in the piezoelectric for initiation of the reactions is required, and following this, the coupling of the nuclear reaction energy to the hybrid electromagnetic and mechanical mode will produce power that can be coupled out to the load 512. Thus, the generated electromagnetic energy can comprise radio frequency (RF) energy or microwave energy.

### Further Exemplary Embodiments With Modulated Stimulation

As discussed elsewhere herein, one type of coupling of interest in nuclear reactions in materials that comprise deuterium involves coupling the nuclear reaction to acoustic phonon modes of the material (phonon modes with frequencies from near zero to a few THz). To excite such acoustic modes with electromagnetic radiation from a source such as laser having output at visible, infrared (IR) or ultraviolet (UV) wavelengths, for example, the radiation can be modulated so that the modulation has a modulation frequency in the acoustic region. Numerous ways of modulating such light are known, including driving the laser with a driving circuit operating at a modulation frequency or using conventional shuttering devices including mechanical rotating shutters and electro-optical shutters, to name a few. In what follows, some exemplary embodiments using such modulated excitation sources to stimulate materials comprising deuterium to cause nuclear reactions therein are described. As will be appreciated, modulation of excitation sources to deliver modulated energy are not limited to electromagnetic sources, and the modulation frequencies are not limited to acoustic frequencies.

It will be appreciated that modulation as referred to herein includes both periodic and non-periodic dynamic changes in a property of the stimulation being applied, such as intensity, wavelength, heat flux, etc. Modulation is not limited to periodic modulations. Of course, periodic modulations such as regular sinusoidal, triangular or square wave variations, etc., in a property can be used. As noted above, it is believed that modulations of such stimulation can facilitate coupling to acoustic phonons in the materials containing deuterium, thereby facilitating generation of the nuclear reactions.

According to an exemplary embodiment, an apparatus can be configured such as illustrated in the block diagram of FIG. 24, which was previously discussed in the context of other examples, the discussion of which is also applicable here. In the present example, the apparatus 200 comprises a material 202 that comprises deuterium, which can be D₂ and/or HD such as described previously. In other respects the material 202 can comprise any other suitable material such as described elsewhere herein. The apparatus 200 also comprises an excitation source 204 comprising an electromagnetic radiation source, wherein the excitation source 204 is configured to stimulate the material with modulated electromagnetic energy without ablating the material 202. It is known that intense laser radiation can ablate material from a surface (cause damage by removing material from an incident surface), and it can be beneficial to avoid such to prolong the life the material 202. The stimulation causes nuclear reactions of the type described elsewhere herein to occur in the material 202. The electromagnetic radiation source can be any suitable source including a continuous wave laser (in which case an suitable driving circuit or suitable modulation optics can be used to provide the modulation), a mode-locked laser, a mode-locked see laser followed by a power amplifier, a modulated high efficiency incandescent light source, or a modulated arc (light) source, to name a few. Microwave, terahertz, and infrared radiation sources are other examples. As suggested above, the modulation can occur at one or more frequencies in the acoustic range. The excitation source 204 can provide modulated energy to the material with a modulation frequency over the full range of acoustic frequencies, i.e., above zero as to about 5.5 THz. Particular modulation frequencies that can provide good coupling can depend upon the type of material 202 being stimulated as will be appreciated by those of ordinary skill in the art. Determining (e.g., calculating or measuring) advantageous frequency ranges for coupling to acoustic phonons for a given material 202 is within the purview of one of ordinary skill in the art.

With regard to the material 202, it is helpful to absorb the radiation in a way that is useful relative to the modulation frequency. For example, light absorbed in a metal sample penetrates less than 100 nm, which is suitable for coupling to a very wide range of acoustic mode frequencies. Also, it is known that the efficiency of acoustic wave generation in a material can be increased if a tamping layer (e.g., a coating such as a liquid) is present on the material.

The apparatus 200 also comprises a load 206 arranged to remove energy generated by the reactions from the material 202. The load 206 can be, for example, a heat exchanger, a thermoelectric device, a thermionic device, a thermal diode, a radiation absorber (e.g., a photovoltaic such as a photodiode) or an output transducer arranged to remove energy generated by the reactions from the material. In will be appreciated that the components illustrated in FIG. 24 need not be in physical contact depending upon the particular arrangement.

In another example, the apparatus can be modified such that the excitation source 204 includes an input transducer, an electrical power source, or a particle-beam source, such as described elsewhere herein, instead of or in addition to using an electromagnetic radiation source. Other aspects of the apparatus 200 can be the same as already described.

In the context of a particle-beam source, a modulated KeV or MeV electron beam can be used wherein the modulation can be done at the electron source, with magnetic scanning, switching optics, or electrostatic optics, of types known to those of ordinary skill in the art. Alternatively, a modulated KeV or MeV ion beam could be use with a similar modulation scheme. Of course, ion beams are easily degraded, and a suitable environment such as a vacuum chamber, e.g., possibly with a small amount of deuterium gas therein gas, can be provided. Electron beams are considerably more penetrating, but such an embodiment would benefit from vacuum or low-pressure gas environments. It is possible to generate modulated high-power electron beams, ion beams, and laser beams very efficiently. Hence, it should be expected that modulated radiation drivers should be competitive.

In the context of stimulation with a transducer, it can be convenient to generate strong acoustic excitation for stimulation with piezoelectric transducers, in the regimes where they are applicable. Piezoelectric transducers for driving resonances in solids and liquids for excess heat applications can be useful over a wide range of frequencies, including but not limited to, the frequency range between about 1 kHz and about 1 GHz. At higher modulation frequencies, modulated laser sources can be relatively more beneficial compared to piezoelectric transducers considering the relative ease of developing good modulation at high frequency in laser sources and their ability to operate at elevated power and intensity levels. With regard to temperature, the performance of good piezoelectric materials may degrade at elevated temperatures. Thus, in some instances it can be more convenient to couple acoustic energy (both for stimulation and/or for output) above about 300 degrees C. using other approaches described herein other than with piezoelectric devices.

Hydraulically driven transducers can also be used for stimulation. For large systems, e.g., high-power generation systems, acoustic stimulation through hydraulic techniques can be advantageous to stimulate a large quantity of material 202 considering the existence of a mature pumping and plumbing technology.

In applications for heat generation, it can be advantageous to utilize a minimal system that is optimized for collecting and converting the reaction energy. In this case the stimulation required to initiate reactions can advantageously be provided by laser and other radiation sources.

It can also be convenient to generate large amounts of acoustical power mechanically with instabilities in forced fluid flow, e.g., in an instance where the material 202 is a deuterium containing liquid. Thus, for example, modulating the flow of such a liquid with an appropriate transducer such as a pump can be advantageous to generating reactions in the liquid.

It should be emphasized that although illustrative embodiments have been described herein in detail, that the description and drawings have been provided for purposes of illustration only and other variations both in form and detail can be added thereupon with departing from the spirit and scope of the invention. The terms and expressions herein have been used as terms of description and not terms of limitation. There is no limitation to use the terms or expressions to exclude any equivalents of features shown and described or portions thereof.

We claim:

1. A method, comprising:
stimulating a material to cause reactions in the material, wherein the material comprises deuterium, and wherein the reactions generate vibrational motion of the material;
coupling the vibrational motion to a transducer that generates energy from the vibrational motion of the material; and
directing the energy to an electrical device.

2. The method of claim 1, wherein the material comprises deuterium in the form of at least one of molecular deuterium (D₂) and molecular hydrogen-deuterium (HD).

3. The method of claim 1, wherein the material comprises a material selected from the group consisting of a dihydrogen transition metal complex with a substitution by at least one of D₂ and HD, a semiconductor material, a metal, a liquid and an insulator.

4. The method of claim 1, wherein the stimulating comprises applying energy to the material by at least one of irradiating with electromagnetic radiation, applying vibrational energy, applying electrical energy, irradiating with particles, and applying heat.

5. The method of claim 1, wherein the reactions comprise at least one of transformations between D₂ and He-4 and transformations between HD and He-3.

6. The method of claim 1, wherein the stimulating comprises applying electrical energy to the transducer to cause the transducer to vibrate and thereby apply vibrational energy to the material.

7. The method of claim 1, wherein the generated energy includes electrical energy.

8. The method of claim 1, wherein the generated electrical energy includes electromagnetic energy.

9. An apparatus, comprising:
a material comprising deuterium;
an excitation source comprising a device selected from the group consisting of an electromagnetic-radiation source, an input transducer that generates vibrational motion in response to electrical energy, an electrical power source, a particle source, and a heater, wherein the excitation source is arranged to stimulate the material to generate reactions in the material, and wherein the reactions generate vibrational motion of the material; and
an output transducer coupled to the material that generates energy from the vibrational motion of the material.

10. The apparatus of claim 9, wherein the material comprises deuterium in the form of at least one of molecular deuterium (D₂) and molecular hydrogen-deuterium (HD).

11. The apparatus of claim 9, wherein the material comprises a material selected from the group consisting of a dihydrogen transition metal complex with a substitution by at least one of D₂ and HD, a semiconductor material, a metal, liquid and an insulator.

12. The apparatus of claim 9, wherein the stimulating comprises applying energy to the material by at least one of irradiating with electromagnetic radiation, applying vibrational energy, applying electrical energy, irradiating with particles, and applying heat.

13. The apparatus of claim 9, wherein the reactions comprise at least one of transformations between D₂ and He-4 and transformations between HD and He-3.

14. The apparatus of claim 9, wherein the stimulating comprises applying electrical energy to the transducer to cause the transducer to vibrate and thereby apply vibrational energy to the material.

15. The apparatus of claim 9, wherein the generated energy includes electrical energy.

16. The apparatus of claim 9, wherein the generated energy includes electromagnetic radiation.

17. The method of claim 1, wherein the transducer is coupled to an electrical oscillator or an electromagnetic cavity such that an electrical-mechanical system is formed, and wherein energy generated from the reactions is coupled into a hybrid mode of the electrical-mechanical system.

18. The apparatus of claim 9, comprising an electrical oscillator or an electromagnetic cavity coupled to the transducer such that an electrical-mechanical system is formed, wherein energy generated from the reactions is coupled into a hybrid mode of the electrical-mechanical system.

19. An apparatus, comprising:
a material comprising deuterium;
means for stimulating the material to generate reactions in the material, wherein the reactions generate vibrational motion of the material; and
means for generating electrical energy from the vibrational motion of the material.
